(19) United States
(12) Patent Application Publication
(10) Pub. No.: US 2024/0303519 A1
(43) Pub. Date: Sep. 12, 2024

(54) DEVICE AND METHOD FOR SIMULATING AN OPEN QUANTUM SYSTEM

(71) Applicants: ALICE & BOB, Paris (FR); Association pour la Recherche et le Développement des Méthodes et Processus Industriels-ARMINES, Paris Cedex 06 (FR)

(72) Inventors: Pierre ROUCHON, Paris Cedex 06 (FR); François-Marie LE REGENT, Paris (FR)

(21) Appl. No.: 18/597,954

(22) Filed: Mar. 7, 2024

(30) Foreign Application Priority Data
Mar. 8, 2023 (EP) 23305313.1
Oct. 18, 2023 (EP) 23306829.5

(51) Int. Cl. G06N 10/20

(52) U.S. Cl. CPC G06N 10/20

(57) ABSTRACT

A device simulates an open quantum system including one or more quantum entities, each quantum entity being stabilized around a decoherence-free space. The corresponding simulation method is based on an original asymptotic development adapted to the so-called Heisenberg formulation of quantum mechanics and based on invariant operators of the local and nominal dynamics associated with each of the quantum entities. A computer-implemented simulates an open quantum system including a plurality of quantum entities including: one or more first quantum entities each being stabilized around a decoherence-free space, and a one or more second entities wherein each second quantum entity has an unstabilized component during a time period T such that a respective decoherence-free space cannot be defined for each second quantum entity during time 0<t<T.

### CROSS-REFERENCE TO RELATED APPLICATION

This application claims priority from and the benefit of European patent application no. 23305313.1 filed 8 Mar. 2023. The entire contents of this application are incorporated herein by reference. This application also claims priority from and the benefit of European patent application no. 23306829.5 filed 18 Oct. 2023. The entire contents of this application are also incorporated herein by reference.

### TECHNICAL FIELD

The field of the invention relates to the simulation of an open quantum system.

### BACKGROUND

In physics, the Schrödinger picture—also called Schrödinger representation or Schrödinger point of view—is a formulation of quantum mechanics in which state vectors evolve in time, but operators (observables and others) are mostly constant with respect to time. It differs from the Heisenberg picture that is a formulation of quantum mechanics in which the operators incorporate a dependency on time, but the state vectors are time-independent, an arbitrary fixed basis rigidly underlying the theory.

Common Lindblad Master Equation Solvers rely on the Schrodinger picture for which the state of the initial density matrix is known and the density matrix evolves via the application of operators: Hamiltonians and dissipators.

In the case of quantum harmonic oscillators having support on an infinite-dimensional Hilbert space, a Galerkine approximation is applied such that simulation methods require a parameter generally known as truncature: the density matrix is projected on the finite-dimensional Hilbert space composed of the first N basis states. These N basis states are ordered such that, if the initial state is in the subspace generated by these states, it remains in very good approximation in this subspace during the evolution. In the case of quantum harmonic oscillators, the basis vectors are often chosen to be the energy states or Fock states to be simulated. This approximation is well suited when the quantum state remains confined to states with low contribution of high energy states as coherent states for example.

Indeed, for coherent states, the coefficients on the Fock states follow a Poissonian distribution which become exponentially small for large N.

However, in order to capture the physics of the Lindblad master equation in the numerical simulations, one has to take a truncature big enough such that the dynamics on the higher energy states is negligeable.

Even if this condition on the truncature can be achieved for a single quantum entity by taking truncature parameter of N=100 or more, it becomes a dimensional issue for composite systems.

Indeed, simulation methods in the Schrodinger picture are constrained by the size of the density matrix involved because of the exponential dependence of its size with the number of quantum entities. For n quantum entities, where n is an integer greater than or equal to 1, and assuming a truncature N for each, the size of the density matrix is Nⁿ times Nⁿ.

In practice, it is computationally demanding to perform simulations of two quantum entities. For N=40 per quantum entity, the truncature required to catch the typical physics of the interaction between the two modes implies typical simulation times of the order of 10 hours.

Three quantum entities with support on the global infinite-dimensional Hilbert space are beyond what is possible to simulate in a reasonable time in the Schrödinger picture.

The present invention seeks to improve the situation.

### SUMMARY

Thus, in a first aspect, the present invention proposes a device for simulating on a conventional computer an open quantum system including one or more quantum entities, each quantum entity being stabilized around a decoherence-free space. The corresponding simulation method is based on an original asymptotic development adapted to the so-called Heisenberg formulation of quantum mechanics and based on invariant operators of the local and nominal dynamics associated with each of the quantum entities. Here, the nominal and local dynamics of a quantum entity refers to its own time evolution, without any external perturbation. The invariant operator of a quantum entity is a steady-state of the adjoint nominal dynamics according to the Frobenius product.

The simulation method according to the first aspect relies only on local calculations associated with each of the quantum entities. The simulation method avoids calculations on the full Hilbert space of the composite systems, given by the tensor product of the Hilbert spaces of each of the quantum entities, calculations which become impossible in many applications because of the dimension of the system Hilbert space. This simulation method is particularly well suited to composite systems in quantum error correction, such as quantum error correcting codes built by concatenating bosonic qubits into discrete variable (DV) quantum error correcting codes. In this context, the simulation method gives the fidelity and error rates of logic gates between several logical qubits, knowing the errors on each of the quantum entities and the interactions between the quantum entities encoding these logical qubits.

The invention according to the first aspect avoids going through the full Hilbert space of the complete system, tensor product of the local Hilbert spaces associated with each of the quantum entities, the dimension of which is far too large to perform realistic calculations in many applications. The simulation method only exploits local calculations on the Hilbert spaces of each of the quantum entities.

More particularly, according to the first aspect the Applicant proposes a device for simulating an open quantum system including one or more quantum entities, the open quantum system having a Hilbert space H and the one or more quantum entities each having a respective Hilbert space H_{q}, such that H=⊗_{q=1}ⁿ H_{g}, where n is the number of quantum entities and ⊗ denotes the tensor product.

The one or more quantum entities each have a respective decoherence-free space D_{0,q} which are exponential attractors and define together a decoherence-free space D₀ of the open quantum system with D₀=⊗_{q=1}ⁿ D_{0,q}, each decoherence-free space D_{0,q} having a respective orthonormal Hermitian basis {S_{q,d}_{_{q}}⁰, d_{q}∈ [symbol] 1, d_{0,q} [symbol] }, where S_{q,d}_{_{q}}⁰ is the d_{q}-th Hermitian of the orthonormal Hermitian basis of the decoherence-free space D_{0,q} of the q-th quantum entity and d_{0,q} is the dimension of the decoherence-free space D_{0,q} of the q-th quantum entity. K₀K_{0,q}K₀=⊗_{q=1}ⁿ K_{0,q}ρₖ₊₁=K₀(ρₖ)+K₁(ρₖ)k The device comprises: K₀K_{0,q}K₀=⊗_{q=1}ⁿ K_{0,q}ρₖ₊₁=K₀(ρₖ)+K₁(ρₖ)k− a memory arranged to store data representing the time evolution of a Lindblad master equation defining the dynamics of a density operator ρ of the open quantum system, said dynamics including at least a sum of quantum entity specific local nominal dynamics, and K₀K_{0,q}K₀=⊗_{q=1}ⁿ K_{0,q}ρₖ₊₁=K₀(ρₖ)+K₁(ρₖ)k− a processor arranged to apply an explicit method to said data for generating a discrete-time expression of the Lindblad master equation, splitting said discrete-time expression of the Lindblad master equation into a local nominal dynamics portion and a perturbation portion K₁ with an amplitude of said perturbation portion being at least five times smaller than an amplitude of said local nominal dynamics portion, and to further apply a trace-preserving and completely-positive linear Kraus map formulation to said local nominal dynamics portion such that the Kraus map of said local nominal dynamics portion is derived from the respective Kraus maps of said quantum entity specific local nominal dynamics with, such that, where ρₖ is the −th time value of the time-discrete density operator.

The processor is further arranged to determine a finite set of local operators L_{q,μ}¹ and R_{q,μ}¹ on the Hilbert space H_{q} such that, for any operator W on the Hilbert space H verifying W=⊗_{q=1}ⁿ W_{q}, W_{q} being a local operator on the Hilbert space H_{q}:K₁(W)=Σ_{μ}⊗_{q=1}ⁿ L_{q,μ}¹W_{q}R_{q,μ}¹. The processor is further arranged to calculate invariant operators

$${J}_{q , {d}_{q}} = {lim}_{k \to + ∞} {[ {K}_{0 , q}^{*} ]}^{k} ( {S}_{q , {d}_{q}}^{0} )$$

of each quantum entity, where K_{0,q}^{*} is the conjugate transpose of the local nominal dynamics portion K_{0,q} of the q-th quantum entity.

The processor is further arranged to determine a second-order approximation of matrices F(k) modeling the time evolution of the time-discrete density operator of the open quantum system by computing:

$${F}^{0} ( k ) = I$$

$${F}_{( {d}_{1}^{′} , ... , {d}_{n}^{′} ) , ( {d}_{1} , ... , {d}_{n} )}^{1} ( k ) = {\sum }_{μ} {\prod }_{q = 1}^{n} Tr ( {J}_{μ , q , {d}_{q}^{′}}^{1} ( k ) {S}_{q , {d}_{q}}^{0} )$$

$${F}_{( {d}_{1}^{′} , ... , {d}_{n}^{′} ) , ( {d}_{1} , ... , {d}_{n} )}^{2} ( k ) = {\sum }_{i = 0}^{+ ∞} ( {\sum }_{μ , {μ}^{′}} {\prod }_{q = 1}^{n} Tr ( {{J}_{{μ}^{′} , q , {d}_{q}^{′}}^{1} ( k ) [ {K}_{0 , q} ]}^{i} ( {S}_{μ , q , {d}_{q}}^{1} ( k ) ) ) - {\prod }_{q = 1}^{n} {\sum }_{{d}_{q}^{″}} Tr ( {J}_{{μ}^{′} , q , {d}_{q}^{′}}^{1} ( k ) {S}_{q , {d}_{q}^{″}}^{0} ) Tr ( {J}_{μ , q , {d}_{q}^{″}}^{1} ( k ) {S}_{q , {d}_{q}}^{0} ) )$$

$$with :$$

$${J}_{μ , q , {d}_{q}^{′}}^{1} ( k ) = {R}_{q , μ}^{1} ( k ) {J}_{q , {d}_{q}^{′}} {L}_{q , μ}^{1} ( k )$$

$${S}_{μ , q , {d}_{q}}^{1} ( k ) = {L}_{q , μ}^{1} ( k ) {S}_{q , {d}_{q}}^{0} {R}_{q , {d}_{q}}^{1} ( k )$$

where: I is the identity matrix on the Hilbert space H, F⁰(k) is a zero-order part of the matrix F(k), F_{(d}_{₁}_{′, . . . , d}_{ₙ}_{′),(d}_{₁}_{, . . . , d}_{ₙ}₎¹(k) is a coefficient of a first-order part F¹(k) of the matrix F(k), F_{(d}_{₁}_{′, . . . , d}_{ₙ}_{′),(d}_{₁}_{, . . . , d}_{ₙ}₎²(k) is a coefficient of a second-order part F²(k) of the matrix F(k), and F(k)=F⁰(k)+F¹(k)+F²(k).

The processor is further arranged to determine a propagator P as a time product of the matrices F(k) for approximating a final state ρ_{f} of the density operator ρ based on an initial state ρ₀ of said density operator ρ.

The device is arranged to receive as inputs a Lindblad master equation defining the dynamics of the density operator ρ of an open quantum system including one or more quantum entities to be simulated, along with the respective decoherence-free spaces D_{0,q} of said one or more quantum entities and an initial state ρ₀ of said density operator ρ, to execute said processor with said inputs and derive an approximated final state ρ_{f} of the density operator ρ.

According to one or more embodiments, the processor is arranged to apply an explicit Euler scheme as the explicit method.

According to one or more embodiments, the processor is arranged to apply the Kraus map formulation using the following Kraus map:

$${K}_{0} ( ρ ) = U ( \overline{M} U ρ {U}^{†} {\overline{M}}^{†} + Δ t ( {\sum }_{v} {\overline{L}}_{v} U ρ {U}^{†} {\overline{L}}_{v}^{†} ) ) {U}^{†}$$

$$with :$$

$$U = {e}^{- i Δ tH / 2}$$

$$\overline{M} = {MS}^{- \frac{1}{2}}$$

$${\overline{L}}_{v} = {L}_{v} {S}^{- \frac{1}{2}}$$

$$M = I - {\sum }_{v} \frac{Δ t}{2} {L}_{v}^{†} {L}_{v} S = {M}^{†} M + Δ t {\sum }_{v} {L}_{v}^{†} {L}_{v} {L}_{v} vwhere : and ,$$

$$M = I - {\sum }_{v} \frac{Δ t}{2} {L}_{v}^{†} {L}_{v} S = {M}^{†} M + Δ t {\sum }_{v} {L}_{v}^{†} {L}_{v} {L}_{v}$$

υ and where: Δt is the time step of the explicit method, is a-th Lindblad operator and His a Hamiltonian of the Lindblad master equation. According to one or more embodiments, the perturbation K₁ is time independent and the processor is arranged to determine the propagator

$$P = {e}^{T \frac{F}{Δ t}} ,$$

where Δt is the time step of the explicit method and T is a time quantity over which the Lindblad master equation rules the open quantum system.

According to one or more embodiments, the perturbation K₁ is time dependent and the processor is arranged to determine the propagator as a time-ordered product P=Πₖ₌₀^{Λ} F(T−Σⱼ₌₀^{k} Δtⱼ), where Δtₖ is the time step of the explicit method corresponding to the k-th time value of the time-discrete density operator, T is a time quantity over which the Lindblad master equation rules the open quantum system, A is the number of time step Δtₖ over the time quantity T, and Δt₀ is equal to 0 by convention.

According to one or more embodiments, the device is arranged to receive as inputs a Lindblad master equation defining the dynamics of the density operator ρ of an open quantum system including only one quantum entity to be simulated, and the processor is arranged to determine a Q-order approximation of the matrix modeling the time evolution of the time-discrete density operator of the open quantum system, Q being an integer greater than two, by implementing the following recurrence process:

$${F}_{{d}^{′} , d}^{r} = Tr ( {J}_{{d}^{′}} {K}_{1} ( {S}_{d}^{r - 1} ) )$$

$$with :$$

$${S}_{d}^{r} = {lim}_{i \to + ∞} {[ {K}_{0} + {W}_{d}^{r} ]}^{i} ( 0 )$$

$${W}_{d}^{r} = {K}_{1} ( {S}_{d}^{r - 1} ) - {\sum }_{s = 1}^{r} {\sum }_{{d}^{′} = 1}^{{d}_{0}} {F}_{{d}^{′} , d}^{s} {S}_{d ′}^{r - s}$$

where: d₀ is the dimension of the decoherence-free space D₀ of the open quantum system, and F_{d′,d}^{r} is a coefficient of a r-order part F^{r} of the matrix F, and F=Σᵣ₌₀^{Q} F^{r.}

According to one or more embodiments, the device is arranged to receive as inputs a Lindblad master equation defining the dynamics of the density operator ρ of an open quantum system that is a quantum logic gate.

The quantum logic gate is for instance a Z-gate, a ZZ-gate, a ZZZ-gate, a CNOT-gate or a Toffoli-gate.

The present invention according to the first aspect also relates to a method for simulating an open quantum system including one or more quantum entities, the open quantum system having a Hilbert space H and the one or more quantum entities each having a respective Hilbert space H_{q}, such that H=⊗_{q=1}ⁿ H_{q}, where n is the number of quantum entities and ⊗ denotes the tensor product.

The one or more quantum entities each have a respective decoherence-free space D_{0,q} which are exponential attractors and define together a decoherence-free space D₀ of the open quantum system with D₀=⊗_{q=1}ⁿ D_{0,q}, each decoherence-free space D_{0,q} having a respective orthonormal Hermitian basis {S_{q,d}_{_{q}}⁰, d_{q}∈ [symbol] 1, d_{0,q} [symbol] }, where S_{q,d}_{_{q}}⁰ is the d_{q}-th Hermitian of the orthonormal Hermitian basis of the decoherence-free space D_{0,q} of the q-th quantum entity and d_{0,q} is the dimension of the decoherence-free space D_{0,q} of the q-th quantum entity. D_{0,q}ρK₀K_{0,q}K₀=⊗_{q=1}ⁿ K_{0,q}ρₖ₊₁=K₀(ρₖ)+K₁(ρₖ)ρₖ The method is implemented by the device described above and comprises the following operations: D_{0,q}ρK₀K_{0,q}K₀=⊗_{q=1}ⁿ K_{0,q}ρₖ₊₁=K₀(ρₖ)+K₁(ρₖ)ρₖ—receiving as inputs a Lindblad master equation defining the dynamics of a density operator ρ of an open quantum system including one or more quantum entities to be simulated, said dynamics including at least a sum of quantum entity specific local nominal dynamics, along with the respective decoherence-free spaces of said one or more quantum entities and an initial state ρ₀ of said density operator, D_{0,q}ρK₀K_{0,q}K₀=⊗_{q=1}ⁿ K_{0,q}ρₖ₊₁=K₀(ρₖ)+K₁(ρₖ)ρₖ—applying an explicit method to said Lindblad master equation for generating a discrete-time expression thereof, splitting said discrete-time expression of the Lindblad master equation into a local nominal dynamics portion and a perturbation portion K₁ with an amplitude of said perturbation portion being at least five times smaller than an amplitude of said local nominal dynamics portion, D_{0,q}ρK₀K_{0,q}K₀=⊗_{q=1}ⁿ K_{0,q}ρₖ₊₁=K₀(ρₖ)+K₁(ρₖ)ρₖ—applying a trace-preserving and completely-positive linear Kraus map formulation to said local nominal dynamics portion such that the Kraus map of said local nominal dynamics portion is derived from the respective Kraus maps of said quantum entity specific local nominal dynamics with, such that, where is the k-th time value of the time-discrete density operator,

$${L}_{q , μ}^{1} {R}_{q , μ}^{1} W = {⊗}_{q = 1}^{n} {W}_{q} {K}_{1} ( W ) = {\sum }_{μ} {⊗}_{q = 1}^{n} {L}_{q , μ}^{1} {W}_{q} {R}_{q , μ}^{1} {J}_{q , {d}_{q}} = {lim}_{k \to + ∞} {[ {K}_{0 , q}^{*} ]}^{k} ( {S}_{q , {d}_{q}}^{0} ) {K}_{0 , q}^{*} F ( k ) -$$

determining a finite set of local operators and on the Hilbert space H_{q} such that, for any operator W on the Hilbert space H verifying, W_{q} being a local operator on the Hilbert space H_{q}:

$${L}_{q , μ}^{1} {R}_{q , μ}^{1} W = {⊗}_{q = 1}^{n} {W}_{q} {K}_{1} ( W ) = {\sum }_{μ} {⊗}_{q = 1}^{n} {L}_{q , μ}^{1} {W}_{q} {R}_{q , μ}^{1} {J}_{q , {d}_{q}} = {lim}_{k \to + ∞} {[ {K}_{0 , q}^{*} ]}^{k} ( {S}_{q , {d}_{q}}^{0} ) {K}_{0 , q}^{*} F ( k ) -$$

calculating invariant operators of each quantum entity, where is the conjugate transpose of the local nominal dynamics portion K_{0,q} of the q-th quantum entity,

$${L}_{q , μ}^{1} {R}_{q , μ}^{1} W = {⊗}_{q = 1}^{n} {W}_{q} {K}_{1} ( W ) = {\sum }_{μ} {⊗}_{q = 1}^{n} {L}_{q , μ}^{1} {W}_{q} {R}_{q , μ}^{1} {J}_{q , {d}_{q}} = {lim}_{k \to + ∞} {[ {K}_{0 , q}^{*} ]}^{k} ( {S}_{q , {d}_{q}}^{0} ) {K}_{0 , q}^{*} F ( k ) -$$

determining a second-order approximation of matrices modeling the time evolution of the time-discrete density operator of the open quantum system by computing:

$${F}^{0} ( k ) = I \\ {F}_{( {d}_{1}^{′} , … , {d}_{n}^{′} ) , ( {d}_{1} , … , {d}_{n} )}^{1} ( k ) = {\sum }_{μ} {\prod }_{q = 1}^{n} Tr ( {J}_{μ , q , {d}_{q}^{′}}^{1} ( k ) {S}_{q , {d}_{q}}^{0} ) \\ {F}_{( {d}_{1}^{′} , … , {d}_{n}^{′} ) , ( {d}_{1} , … , {d}_{n} )}^{2} ( k ) = {\sum }_{i = 0}^{+ ∞} ( {\sum }_{μ , {μ}^{′}} {\prod }_{q = 1}^{n} Tr ( {{J}_{{μ}^{′} , q , {d}_{q}^{′}}^{1} ( k ) [ {K}_{0 , q} ]}^{k} ( {S}_{μ , q , {d}_{q}}^{1} ( k ) ) ) - {\prod }_{q = 1}^{n} {\sum }_{{d}_{q}^{″}} Tr ( {J}_{{μ}^{′} , q , {d}_{q}^{′}}^{1} ( k ) {S}_{q , {d}_{q}^{″}}^{0} ) Tr ( {J}_{μ , q , {d}_{q}^{″}}^{1} ( k ) {S}_{q , {d}_{q}}^{0} ) ) \\ with : \\ {J}_{μ , q , {d}_{q}^{′}}^{1} ( k ) = {R}_{q , μ}^{1} ( k ) {J}_{q , {d}_{q}^{′}} {L}_{q , μ}^{1} ( k ) \\ {S}_{μ , q , {d}_{q}}^{1} ( k ) = {L}_{q , μ}^{1} ( k ) {S}_{q , {d}_{q}}^{0} {R}_{q , {d}_{q}}^{1} ( k )$$

where: I is the identity matrix on the Hilbert space H, F⁰(k) is a zero-order part of the matrix F(k), F_{(d}_{₁}_{′, . . . , d}_{ₙ}_{′),(d}_{₁}_{, . . . , d}_{ₙ}₎¹(k) is a coefficient of a first-order part F¹(k) of the matrix F(k), F_{(d}_{₁}_{′, . . . , d}_{ₙ}_{′),(d}_{₁}_{, . . . , d}_{ₙ}₎²(k) is a coefficient of a second-order part F²(k) of the matrix F(k), and F(k)=F⁰(k)+F¹(k)+F²(k),
determining a propagator P as a time product of the matrices F (k), and
deriving an approximated final state ρ_{f} of the density operator ρ by applying said propagator P to the initial state ρ₀ of said density operator ρ of the open quantum system.

Furthermore, the present invention according to the first aspect relates to a computer program comprising instructions whose execution, by a processor, results in the implementation of the method described above.

Finally, the present invention according to the first aspect relates to a computer-readable storage medium comprising the computer program stored thereon.

As will be appreciated, in the invention according to the first aspect, the one or more quantum entities each have a respective decoherence-free space D_{0,q}. That is, each quantum entity may be a nominally stabilized quantum entity. However, the present inventors have also recognized that the above method can be extended to the case where the open system includes one or more quantum entities which are not stabilized such that such that a respective decoherence-free space cannot be defined for each of the non-stabilized quantum entities.

Thus, according to a second aspect, there is provided a computer-implemented method carried out by a conventional computer for simulating an open quantum system including a plurality of quantum entities, the plurality of quantum entities including: (i) one or more first quantum entities each having a respective Hilbert space H_{A}_{_{q}}, where A_{q} denotes the q-th first quantum entity, and each being stabilized around a respective decoherence-free space D_{0,A}_{_{q}} which is an exponential attractor, each decoherence-free space D_{0,A}_{_{q}} having a respective orthonormal Hermitian basis

$$\{ {S}_{{A}_{q} , {d}_{{A}_{q}}}^{0} , {d}_{{A}_{q}} ∈ 〚 1 , {d}_{0 , {A}_{q}} 〛 \} , where {S}_{{A}_{q} , {d}_{{A}_{q}}}^{0}$$

is the d_{A}_{_{q}}-th Hermitian operator of the orthonormal Hermitian basis of the decoherence-free space D_{0,A}_{_{q}} of the q-th first quantum entity and d_{0,A}_{_{q}} is the dimension of the decoherence-free space D_{0,A}_{_{q}} of the q-th first quantum entity; and (ii) one or more second quantum entities each having a respective Hilbert space H_{B}_{ₚ}, where Bₚ denotes the p-th second quantum entity, wherein each second quantum entity has an unstabilized component during a time period T such that a respective decoherence-free space cannot be defined for each second quantum entity during time period T. The open quantum system has a Hilbert space H such that H=(⊗_{A}_{_{q}} H_{A}_{_{q}})⊗(⊗_{B}_{ₚ} H_{B}_{ₚ}) where ⊗ denotes the tensor product.

The method according to the second aspect comprises the following operations:
receiving, as inputs: (i) a Lindblad master equation defining the dynamics, at time 0<t<T, of a density operator ρ of the open quantum system to be simulated including one or more first quantum entities and one or more second quantum entities, wherein said dynamics includes first quantum entity specific local nominal dynamics Σ_{A}_{_{q}} [symbol] _{0,A}_{_{q}}(ρ) where [symbol] _{0,A}_{_{q}} is the local nominal dynamics of the q-th first quantum entity; (ii) the respective decoherence-free spaces D_{0,A}_{_{q}} of the one or more first quantum entities; (iii) an initial state ρ(0) of said density operator ρ; and (iv) time period T during which each second quantum entity has an unstabilized component;
applying an explicit method to said Lindblad master equation for generating a discrete-time expression thereof, splitting said discrete-time expression of the Lindblad master equation into a local nominal dynamics portion of the one or more first quantum entities and a perturbation portion K₁ with an amplitude of said perturbation portion being at least five times smaller than an amplitude of said local nominal dynamics portion;
applying a trace-preserving and completely-positive linear Kraus map formulation to said local nominal dynamics portion such that the Kraus map K₀ of said local nominal dynamics portion is derived from the respective Kraus maps K_{0,A}_{_{q}} of said first quantum entity specific local nominal dynamics with K₀=⊗_{A}_{_{q}} K_{0,A}_{_{q}}, such that ρ(k+1)=K₀(ρ(k))+K₁(ρ(k)), where ρ(k) is the k-th time value of the time-discrete density operator;
determining a finite set of local operators L_{m,μ}¹(k) and R_{m,μ}¹(k) on the Hilbert space Hₘ where m=A_{q}, Bₚ such that, for any operator W on the Hilbert space H verifying W=⊗ₘ Wₘ, Wₘ being a local operator on the Hilbert space Hₘ:K₁(W)=Σ_{μ}⊗ₘ L_{m,μ}¹WₘR_{m,μ}¹, where μ is finite,
calculating invariant operators

$${J}_{{A}_{q} , {d}_{{A}_{q}}} = {lim}_{k \to + ∞} {[ {K}_{0 , {A}_{q}}^{*} ]}^{k} ( {S}_{{A}_{q} , {d}_{{A}_{q}}}^{0} )$$

of each first quantum entity, where K_{0,A}_{_{q}}^{*} is the conjugate transpose of the local nominal dynamics portion K_{0,A}_{_{q}} of the q-th first quantum entity,
determining a second-order equation of the time-discrete dynamics of the contributions of the d_{A}_{_{q}}′-th Hermitian operator of the decoherence-free space D_{0,A}_{_{q}}_{′} of the q-th first quantum entity on the p-th second quantum entity ρ_{(B}_{₁}_{, . . . , B}_{ₚ}_{),(d}_{_{A1}}_{′, . . . , d}_{_{Aq}}_{′)}, by computing:

$$\frac{d}{dt} {ρ}_{( {B}_{1} , … , {B}_{p} ) , ( {d}_{{A}_{1}}^{′} , … , {d}_{{A}_{q}}^{′} )} = {\sum }_{μ , {d}_{{A}_{1}} , … , {d}_{{A}_{q}}} {\prod }_{i = 1}^{q} \{ {\overline{F}}_{{d}_{{A}_{i}}^{′} , {d}_{{A}_{i}} , μ}^{1} ( k ) [ {⊗}_{j = 1}^{p} {L}_{{B}_{j} , μ}^{1} ( k ) ]$$

$${ρ}_{( {B}_{1} , … , {B}_{p} ) , ( {d}_{{A}_{1}} , … , {d}_{{A}_{q}} )} [ {⊗}_{l = 1}^{p} {R}_{{B}_{l} , μ}^{1} ( k ) ] \} +$$

$${\sum }_{{d}_{{A}_{1}} , … , {d}_{{A}_{q}} , μ , {μ}^{′}} {\prod }_{i = 1}^{q} \{ {\overline{F}}_{{d}_{{A}_{i}}^{′} , {d}_{{A}_{i}} , μ , {μ}^{′}}^{2} ( k ) [ {⊗}_{j = 1}^{p} {L}_{{B}_{j} , {μ}^{′}}^{1} ( k ) ]$$

$$[ {⊗}_{l = 1}^{p} {L}_{{B}_{l} , μ}^{1} ( k ) ] \\ {ρ}_{( {B}_{1} , … , {B}_{p} ) , ( {d}_{{A}_{1}} , … , {d}_{{A}_{q}} )} [ {⊗}_{j = 1}^{p} {R}_{{B}_{j} , μ}^{1} ( k ) ] [ {⊗}_{l = 1}^{p} {R}_{{B}_{l} , {μ}^{′}}^{1} ( k ) ] \}$$

$$with :$$

$${\overline{F}}_{{d}_{{A}_{i}}^{′} , {d}_{{A}_{i}} , μ}^{1} ( k ) = ( \frac{1}{Δ t} ) Tr ( {J}_{{A}_{i} , {d}_{{A}_{i}}^{′}} {L}_{{A}_{i} , μ}^{1} ( k ) {S}_{{A}_{i} , {d}_{{A}_{i}}}^{0} {R}_{{A}_{i} , μ}^{1} ( k ) ) , and$$

$${\overline{F}}_{{d}_{{A}_{i}}^{′} , {d}_{{A}_{i}} , μ , {μ}^{′}}^{2} ( k ) = ( \frac{1}{Δ t} ) Tr \{ {J}_{{A}_{i} , {dA}_{i}^{′} , {μ}^{′}}^{1} ( k )$$

$${{\sum }_{j = 0} [ {K}_{0 , {A}_{i}} ]}^{j} ( {S}_{{A}_{i} , {dA}_{i} , μ}^{0} ( k ) - {\sum }_{{d}_{{A}_{i}}^{″}} Tr ( {J}_{{A}_{i} , {d}_{{A}_{i}}^{″}} {S}_{{A}_{i} , {d}_{{A}_{i}} , μ}^{0} ( k ) ) {S}_{{A}_{i} , {d}_{{A}_{i}}^{″}}^{0} \} ,$$

$$where$$

$${J}_{{A}_{i} , {d}_{{A}_{i}}^{′} , {μ}^{′}}^{1} ( k ) = {R}_{{A}_{i} , {μ}^{′}}^{1} ( k ) {J}_{{A}_{i} , {d}_{{A}_{i}}^{′}}^{1} {L}_{{A}_{i} , {μ}^{′}}^{1} ( k ) and \\ {S}_{{A}_{i} , {d}_{{A}_{i}} , μ}^{0} ( k ) = {L}_{{A}_{i} , μ}^{1} ( k ) {S}_{{A}_{i} , {d}_{{A}_{i}}}^{0} {R}_{{A}_{i} , {d}_{{A}_{i}}}^{1} ( k ) ,$$

where Δt is the time step of the explicit method, where the sum over index j is truncated at a threshold such that the difference between the penultimate and final summed terms is smaller than 10⁻⁸, and where Tr( ) denotes the trace;
determining a propagator P by numerically integrating

$$\frac{d}{dt} {ρ}_{( {B}_{1} , … , {B}_{p} ) , ( {d}_{{A}_{1}}^{′} , … , {d}_{{A}_{q}}^{′} )}$$

over the time period T; and
deriving an approximated final state of the density operator ρ by applying said propagator P to the initial state ρ(0) of said density operator ρ of the open quantum system.

The simulation method according to the second aspect thus still relies on local calculations associated with each of the first quantum entities, and thus still avoids going through the full Hilbert space of the complete system. The second aspect additionally incorporates the behavior of non-stabilized second quantum entities into the system, which e.g. may enable the simulation of quantum gates between both nominally stabilized and non-stabilized qubits, thus allowing simulation of a wider range of composite systems whilst still maintaining a significant computational efficiency improvement over known simulation methods (e.g. those based only in the Schrödinger picture).

Applying the explicit method to said Lindblad master may comprise applying an explicit Euler scheme.

In one or more embodiments of the second aspect, when t=0 and when t≥T, each second quantum entity is stabilized around a respective decoherence-free space D_{0,B}_{ₚ} which is an exponential attractor, each decoherence-free space D_{0,B}_{ₚ} having a respective orthonormal Hermitian basis

$$\{ {S}_{{B}_{p} , {d}_{{B}_{p}}}^{0} , {d}_{{B}_{p}} ∈ 〚 1 , {d}_{0 , {B}_{p}} 〛 \} , where {S}_{{B}_{p} , {d}_{{B}_{p}}}^{0}$$

is the d_{B}_{ₚ}-th Hermitian operator of the orthonormal Hermitian basis of the decoherence-free space D_{0,B}_{ₚ} of the p-th second quantum entity and d_{0,B}_{ₚ} is the dimension of the decoherence-free space D_{0,B}_{ₚ} of the p-th second quantum entity; the method may further comprise:
receiving, as inputs:
   (v) a second Lindblad master equation defining the dynamics, at time t=0 and t≥T, of the density operator ρ of the open quantum system to be simulated, wherein said dynamics includes quantum entity specific local nominal dynamics Σ_{A}_{_{q}}_{,B}_{ₚ}{ [symbol] _{0,A}_{_{q}}(ρ)+ [symbol] _{0,B}_{ₚ}(ρ)} where [symbol] _{0,B}_{ₚ} is the local nominal dynamics of the p-th second quantum entity; and
   (vi) the respective decoherence-free spaces D_{0,B}_{ₚ} of the one or more second quantum entities;
applying an explicit method to said second Lindblad master equation for generating a second discrete-time expression thereof, splitting said second discrete-time expression of the second Lindblad master equation into a second local nominal dynamics portion of the plurality of quantum entities and a second perturbation portion K₁⁽²⁾ with an amplitude of said second perturbation portion being at least five times than an amplitude of said second local nominal dynamics portion;
applying a trace-preserving and completely-positive linear Kraus map formulation to said second local nominal dynamics portion such that the Kraus map K₀⁽²⁾ of said second local nominal dynamics portion is derived from the respective Kraus maps K_{0,m}⁽²⁾ of said quantum entity specific local nominal dynamics with K₀⁽²)=⊗ₘ K_{0,m}⁽²⁾,where m=A_{q}, Bₚ, such that ρ(k+1)=K₀⁽²⁾(ρ(k))+K₁⁽²⁾(ρ(k)), where ρ(k) is the k-th time value of the time-discrete density operator;
calculating invariant operators

$${J}_{{B}_{p} , {d}_{{B}_{p}}} = {lim}_{k \to + ∞} {[ {K}_{0 , {B}_{p}}^{( 2 ) *} ]}^{k} ( {S}_{{B}_{p} , {d}_{{B}_{p}}}^{0} )$$

of each second quantum entity, where K_{0,B}_{ₚ}^{(2)*} is the conjugate transpose of the local nominal dynamics portion K_{0,B}_{ₚ}⁽²⁾ of the p-th second quantum entity; and
wherein determining propagator P may comprise calculating each propagator coefficient contributing to propagator P, for a particular d_{A}_{₁}, . . . , d_{A}_{_{q}}, d_{B}_{₁}, . . . , d_{B}_{ₚ}, using:

$${P}_{( {d}_{{A}_{1}}^{′} , … , {d}_{{A}_{q}}^{′} , {d}_{{B}_{1}}^{′} , … , {d}_{{B}_{p}}^{′} ) , ( {d}_{{A}_{1}} , … , {d}_{{A}_{q}} , {d}_{{B}_{1}} , … , {d}_{{B}_{p}} )} = Tr ( [ {⊗}_{i = 1}^{p} {J}_{{B}_{i} , {d}_{{B}_{i}}^{′}} ] {ρ}_{( {B}_{1} , … , {B}_{p} ) , ( {d}_{{A}_{1}}^{′} , … , {d}_{{A}_{q}}^{′} )}^{( {d}_{{A}_{1}} , … , {d}_{{A}_{q}} , {d}_{{B}_{1}} , … , {d}_{{B}_{p}} )} ( T ) ) wherein \\ {ρ}_{( {B}_{1} , … , {B}_{p} ) , ( {d}_{{A}_{1}}^{′} , … , {d}_{{A}_{q}}^{′} )}^{( {d}_{{A}_{1}} , … , {d}_{{A}_{q}} , {d}_{{B}_{1}} , … , {d}_{{B}_{p}} )} ( T )$$

is computed by numerically integrating

$$\frac{d}{dt} {ρ}_{( {B}_{1} , … , {B}_{p} ) , ( {d}_{{A}_{1}}^{′} , … , {d}_{{A}_{q}}^{′} )}$$

from an initial state ρ_{(B}_{₁}_{, . . . , B}_{ₚ}_{),(d}_{_{A1}}_{′, . . . , d}_{_{Aq}}_{′)}(0)=⊗ₘ S_{m,d}_{ₘ}⁰ where m=A_{q}, Bₚ for the particular d_{A}_{₁}, . . . , d_{A}_{_{q}}, d_{B}_{₁}, . . . , d_{B}_{ₚ}.

Applying the explicit method to said second Lindblad master may comprise applying an explicit Euler scheme.

The Kraus map formulation may be applied by using the following Kraus map:

$${K}_{0} ( ρ ) = U ( \overline{M} U ρ {U}^{†} {\overline{M}}^{†} + Δ t ( {\sum }_{v} {\overline{L}}_{v} U ρ {U}^{†} {\overline{L}}_{v}^{†} ) ) {U}^{†} \\ with : \\ U = {e}^{- i Δ tH / 2} \\ \overline{M} = {MS}^{- \frac{1}{2}} \\ {\overline{L}}_{v} = {L}_{v} {S}^{- \frac{1}{2}} \\ where : M = I - {\sum }_{v} \frac{Δ t}{2} {L}_{v}^{†} {L}_{v} , S = {M}^{†} M + Δ t {\sum }_{v} {L}_{v}^{†} {L}_{v} ,$$

I is the identity matrix, L_{υ} is a ν-th Lindblad operator of the Lindblad master equation and H is a Hamiltonian of the Lindblad master equation. Here, Δt is still the time step of the explicit method.

Each of the one or more first quantum entities may be a cat qubit stabilized by two-photon driven dissipation.

Each of the one or more second quantum entities may be a cat qubit which: (i) is stabilized by two-photon driven dissipation when t=0 and when t≥T, and (ii) is not stabilized by two-photon driven dissipation during time 0<t<T.

The method of the second aspect may comprise receiving, as inputs, a Lindblad master equation defining the dynamics of the density operator ρ of an open quantum system that is a quantum logic gate.

The method of the second aspect may comprise receiving, as inputs a Lindblad master equation defining the dynamics of the density operator ρ of an open quantum system that is: (i) a CNOT-gate between a control qubit and a target qubit, wherein the control qubit is one of said one or more first quantum entities and the target qubit is one of said one or more second quantum entities; and/or (ii) a Toffoli-gate between two control qubits and a target qubit, wherein the control qubits are of said one or more first quantum entities and the target qubit is one of said one or more second quantum entities.

The index j may be truncated at a threshold such that the difference between the between the penultimate and final summed terms is at machine precision of the conventional computer. There is also provided a conventional computing device comprising a processor configured to perform the method according to the second aspect.

There is also provided a computer program or computer-readable data carrier comprising instructions which, when executed by a conventional computer, causes the conventional computer to carry of the according to the second aspect.

As will be appreciated, the method or device of the second aspect may be further used to determine: (i) the choice of experimental parameters to be used in an operation on an open quantum system formed from quantum states; and/or (ii) the choice of design parameters for the one or more quantum entities of an open quantum system.

Thus, there is also provided a method of physically performing an operation on an open quantum system including a plurality of quantum entities, the plurality of quantum entities including: (I) one or more first quantum entities each being stabilized around a respective decoherence-free space; and (II) one or more second quantum entities, wherein each second quantum entity has an unstabilized component during a time period T of the operation such that a respective decoherence-free space cannot be defined for each second quantum entity during time period T.

The method of physically performing an operation on an open quantum system comprises providing a desired final state of a density operator ρ of the open quantum system after an operation to be performed on a known initial state of the open quantum system. The method further comprises: (i) using the method or device of the second aspect to provide an approximated final state of the density operator, wherein said initial state of said density operator ρ models the known initial state of the open quantum system and wherein said Lindblad master equation defining the dynamics models the evolution of the system under the operation; (ii) calculating a fidelity between the approximated final state and desired final state; (iii) comparing the calculated fidelity to a threshold value; (iv) performing: (a) if the fidelity is above the threshold value, extraction of the parameters of said Lindblad master equation corresponding to physically controllable parameters of the operation; or (b) if the fidelity is below the threshold value, repetition of steps (i)-(iii) with a modified Lindblad master equation with modified parameters corresponding to physically controllable parameters of the operation until the calculated fidelity is above the threshold value, and extracting the modified parameters of the modified Lindblad master equation resulting in the calculated fidelity being above the threshold value, and extracting the parameters corresponding to physically controllable parameters of the operation of the modified Lindblad master equation corresponding to the calculated fidelity being above the threshold value; and (v) physically performing the operation on the open quantum system using the extracted parameters.

There is also provided a method of designing an open quantum system including a plurality of quantum entities, the plurality of quantum entities including: (I) one or more first quantum entities each being stabilized around a respective decoherence-free space; and (II) one or more second quantum entities, wherein each second quantum entity has an unstabilized component during a time period T such that a respective decoherence-free space cannot be defined for each second quantum entity during time period T.

The method of designing an open quantum system comprises providing a desired final state of a density operator ρ of the open quantum system after a known operation is to be performed on a known initial state of the open quantum system for time period T. The method further comprises: (i) using the method of the method of the second aspect to provide an approximated final state of the density operator, wherein said initial state of said density operator ρ models the known initial state of the open quantum system and wherein said Lindblad master equation defining the dynamics models the evolution of the system under the known operation; (ii) calculating a fidelity between the approximated final state and desired final state; (iii) comparing the calculated fidelity to a threshold value; (iv) performing: (a) if the fidelity is above the threshold value, extraction of the parameters of said Lindblad master equation corresponding to physically controllable parameters of plurality of quantum entities; or (b) if the fidelity is below the threshold value, repetition of steps (i)-(iii) with a modified Lindblad master equation with modified parameters corresponding to physically controllable parameters of the plurality of quantum entities until the calculated fidelity is above the threshold value, and extracting the modified parameters of the plurality of quantum entities of the modified Lindblad master equation resulting the calculated fidelity being above the threshold value; and (v) designing the plurality quantum entities so as to have the extracted parameters.

The computational efficiency improvement of the new simulation method over known simulation methods in turn results in a computational efficiency improvement in extracting parameters to be used when: (i) physically performing an operation on an open quantum system; or (ii) designing an open quantum system. As such, the present Inventors have discovered a significant speed up in finding optimized parameters for performing an operation on an open quantum system as well as for designing an open quantum system.

### LIST OF FIGURES

Other features and advantages of the invention will become apparent from the following description provided for indicative and non-limiting purposes, with reference to the accompanying drawings, wherein:

FIG. 1 schematically illustrates a device for simulating an open quantum system according to the invention,

FIG. 2 illustrates a method for simulating an open quantum system according to the invention,

FIG. 3 illustrates the modulus of a χ matrix obtained by using the well-known Schrödinger picture for simulating for a ZZ-gate,

FIG. 4 illustrates the modulus of a χ matrix obtained by using the proposed simulation for a ZZ-gate,

FIG. 5 illustrates the comparison of the evolution of coefficients of a χ matrix obtained by using the proposed simulation for a ZZ-gate and by using the well-known Schrödinger picture for simulating the same,

FIG. 6 illustrates the comparison of the evolution of the sum of coefficients of a χ matrix that include bitflips by using the proposed simulation for a ZZ-gate and by using the well-known Schrödinger picture for simulating the same,

FIG. 7 illustrates the modulus of a χ matrix obtained by using the proposed simulation for a ZZZ-gate,

FIG. 8 illustrates the evolution of coefficients of a χ matrix obtained by using the proposed simulation for a ZZZ-gate,

FIG. 9 illustrates the comparison of the evolution of the sum of coefficients of a χ matrix that include bitflips by using the proposed simulation for a ZZ-gate and by using the well-known Schrodinger picture for simulating the same,

FIG. 10 illustrates an operation of the method represented in FIG. 2 in the case in which the open quantum system includes a single quantum entity,

FIG. 11 illustrates the respective moduli of the real part and the imaginary part of a χ matrix obtained by using the well-known Schrödinger picture for simulating for a Z-gate,

FIG. 12 illustrates the respective moduli of the real part and the imaginary part of a χ matrix obtained by using the proposed simulation for a Z-gate,

FIG. 13 illustrates the comparison of the evolution of coefficients of a χ matrix responsible of Z errors obtained by using the proposed simulation for a Z-gate and by using the well-known Schrödinger picture for simulating the same,

FIG. 14 illustrates the comparison of the evolution of coefficients of a χ matrix responsible of X errors obtained by using the proposed simulation for a Z-gate and by using the well-known Schrödinger picture for simulating the same,

FIG. 15 illustrates the comparison of the evolution of coefficients of a χ matrix responsible of Y errors obtained by using the proposed simulation for a Z-gate and by using the well-known Schrodinger picture for simulating the same

FIG. 16 illustrates a method for simulating an open quantum system according to the invention,

FIG. 17 illustrates, for comparison with the evolution of coefficients of a χ matrix for the CNOT-gate shown in FIG. 18, the modulus of the corresponding χ matrix obtained by using the well-known Schrödinger picture for simulating the same,

FIG. 18 illustrates the modulus of a χ matrix obtained by using a simulation method according to the invention for a CNOT-gate,

FIG. 19 illustrates the comparison of the evolution of coefficients of a χ matrix obtained by using a simulation method according to the invention for a CNOT-gate and by using the well-known Schrödinger picture for simulating the same,

FIG. 20 illustrates the comparison of the evolution of the sum of coefficients of a χ matrix that include bitflips by using a simulation method according to the invention for a CNOT-gate and by using the well-known Schrödinger picture for simulating the same,

FIG. 21 illustrates the final leakage for a CNOT gate bitflips by using a simulation method according to the invention,

FIG. 22 illustrates the modulus of a χ matrix obtained by using a simulation method according to the invention for a Toffoli-gate,

FIG. 23 illustrates the comparison of the evolution of coefficients of a χ matrix obtained by using a simulation method according to the invention for a Toffoli-gate,

FIG. 24 illustrates the comparison of the evolution of the sum of coefficients of a χ matrix that include bitflips by using a simulation method according to the invention for a Toffoli-gate,

FIG. 25 illustrates the final leakage for a Toffoli-gate bitflips by using a simulation method according to the invention, and

FIG. 26 illustrates a method of using the simulation method, according to the invention.

The drawings and the following description are comprised for the most part of positive and well-defined features. As a result, they are not only useful in understanding the invention, but they can also be used to contribute to its definition, should the need arise.

### DETAILED DESCRIPTION

An open quantum system is a quantum system that interacts with its external environment—also called bath. The interaction with the external environment significantly modifies the dynamics of a quantum system, i.e. its time evolution, and results in a loss of information.

Since a perfect isolation of quantum systems is impossible, the theory of open quantum system is an indispensable tool in practice to treat any quantum system.

Several mathematical models have been developed to describe the dynamics of an open quantum system, such as the wavefunction approach based on the well-known Schrödinger equation. This approach has several advantages such as linearity, which allows the superposition of quantum states, and unitarity, but does not allow to access to the relevant information of the open quantum system. Moreover, wavefunctions—generally expressed as ψ—can only represent pure states and not mixed states.

To overcome these drawbacks, an alternative solution consists in describing the state of an open quantum system by a density operator—also called density matrix—generally noted ρ. The approach using the density operator ρ allows to access the relevant information of the open quantum system and to represent both pure and mixed states.

Under appropriate assumptions—for instance the Born-Oppenheimer and Markov approximations—that are typically valid in the systems considered below, the time evolution of the density operator of an open quantum system can be expressed as a Lindblad master equation (also known as GKSL equation for “Gorini-Kossakowski-Sudarshan-Lindblad equation”). The Lindblad master equation conserves the interpretation of the density matrix as a valid quantum state since it preserves the trace and complete positivity of the density matrix. Such an equation can be written in the following form—or diagonal form:

$$\frac{d}{dt} ρ = - i [ H , ρ ] + {\sum }_{v} ( {L}_{v} ρ {L}_{v}^{†} - \frac{1}{2} ( {L}_{v}^{†} {L}_{v} ρ + ρ {L}_{v}^{†} {L}_{v} ) )$$

ii²=−1[H,ρ]=Hρ−ρHL_{υ}υL_{υ}^{†} where: —is the imaginary unit, with
ii²=−1[H,ρ]=Hρ−ρHL_{υ}υL_{υ}^{†}—H is the Hamiltonian of the open quantum system, with,
ii²=−1[H,ρ]=Hρ−ρHL_{υ}υL_{υ}^{†}—is the −th Lindblad operator—or jump operator, and
ii²=−1[H,ρ]=Hρ−ρHL_{υ}υL_{υ}^{†}—is the conjugate transpose of the υ-th Lindblad operator.

The right-hand side of the Lindblad master equation can first be seen as a sum of a Hamiltonian part, which models the unitary part of the dynamics, corresponding to a closed evolution, and a dissipative part, which corresponds to the finite sum expressed with the Lindblad operators and models the interaction of the quantum system with its environment.

It is often the case that the dynamics of the system can be divided into two or more timescales, with a fast dynamics called the nominal dynamics and slower dynamics corresponding to perturbations of the nominal dynamics. The Lindblad master equation can then be written as follows:

$$\frac{d}{dt} ρ = {ℒ}_{0} ( ρ ) + {ℒ}_{1} ( ρ ) ,$$

where: [symbol] ₀ is the nominal dynamics of the density operator ρ and [symbol] ₁ is the perturbation. The perturbation can be identified within the Lindblad master equation by the fact that it is negligible compared to the nominal dynamics.

The term “negligible” should be understood here as meaning that an amplitude of the perturbation is significantly smaller than an amplitude of the nominal dynamics. Typically, and for the sake of providing a reasonable order of magnitude, one can generally consider that the perturbation is negligible compared to the nominal dynamics when the amplitude of the perturbation is five times smaller than the amplitude of the nominal dynamics:

5*∥ [symbol] ₁∥<∥ [symbol] ₀∥

where: ∥·∥ is a norm.

Moreover, to further illustrate this order of magnitude difference between the nominal dynamics and the perturbation, it is known in the literature to re-formulate the Lindblad master equation with a parameter & quantifying this difference:

$$\frac{d}{dt} ρ = {ℒ}_{0} ( ρ ) + {εℒ}_{1} ( ρ )$$

with: 0≤ε<<1. Typically, to give an order of magnitude as indication, one generally has: 0≤ε≤0.2. In such a case, the nominal dynamics and the perturbation per se have respective amplitudes of the order of magnitude.

The nominal dynamics is embedded in both the Hamiltonian part and the dissipative part, as well as the perturbations. In other words:

$${ℒ}_{0} ( ρ ) = - i [ {H}_{0} , ρ ] + {\sum }_{{v}_{0}} ( {L}_{{v}_{0}} ρ {L}_{{v}_{0}}^{†} - \frac{1}{2} ( {L}_{{v}_{0}}^{†} {L}_{{v}_{0}} ρ + ρ {L}_{{v}_{0}}^{†} {L}_{{v}_{0}} ) ) \\ {ℒ}_{1} ( ρ ) = - i [ {H}_{1} , ρ ] + {\sum }_{{v}_{1}} ( {L}_{{v}_{1}} ρ {L}_{{v}_{1}}^{†} - \frac{1}{2} ( {L}_{{v}_{1}}^{†} {L}_{{v}_{1}} ρ + ρ {L}_{{v}_{1}}^{†} {L}_{{v}_{1}} ) )$$

where: H₀ and H₁ are respectively the nominal and the perturbative Hamiltonians, with H=H₀+H₁, and L_{υ}_{₀} and L_{υ}_{₁} are the respective Lindblad operators of the nominal dynamics and the perturbations.

As an example, the particular case of a cat-qubit, i.e. a qubit able to correct at least a part of its errors autonomously without requiring redundancy, is considered hereinafter. The possibility of realizing such a qubit has been demonstrated by R. Lescanne et al. in “Exponential suppression of bit-flips in a qubit encoded in an oscillator” (Nature Physics, 2020). In particular, the cat-qubit relies on a mechanism that dissipates photons in pairs. This process pins down two computational states to separate locations in phase space. By increasing this separation, an exponential decrease of the bit-flip rate while only linearly increasing the phase-flip rate can be measured.

A cat-qubit is defined as a specifically selected two-dimensional sub-manifold of a main manifold spanned by several coherent states. As an example, the two-component cat-qubit main manifold is the span of two coherent states with equal amplitude and opposite phase; the main manifold being two-dimensional, in that case the sub-manifold is equal to the main manifold. To generalize, the 2N-component cat-qubit main manifold is the span of 2N coherent states with equal amplitudes and phase shifted by n/N from one another.

The nominal dynamics of the cat-qubit can be expressed as follows:

$${ℒ}_{0} ( ρ ) = - i [ {H}_{0} , ρ ] + L ρ {L}^{†} - \frac{1}{2} ( {L}^{†} L ρ + ρ {L}^{†} L ) \\ L = \sqrt{{κ}_{2}} ( {a}^{2} - {α}^{2} ) α > 0 {H}_{0} = 0 L = \sqrt{{κ}_{2}} {a}^{2} {H}_{0} = {ϵ}_{2 ph} {a}^{2} + {ϵ}_{2 ph} * {a}^{{†}^{2}} {αϵ}_{2 ph} α = \sqrt{2 {ϵ}_{2 ph} / {κ}_{2}}$$

with: with and

$$L = \sqrt{{κ}_{2}} ( {a}^{2} - {α}^{2} ) α > 0 {H}_{0} = 0 L = \sqrt{{κ}_{2}} {a}^{2} {H}_{0} = {ϵ}_{2 ph} {a}^{2} + {ϵ}_{2 ph}^{*} {a}^{{†}^{2}} {αϵ}_{2 ph} α = \sqrt{2 {ϵ}_{2 ph} / {κ}_{2}} or ,$$

equivalently: and.

$$L = \sqrt{{κ}_{2}} ( {a}^{2} - {α}^{2} ) α > 0 {H}_{0} = 0 L = \sqrt{{κ}_{2}} {a}^{2} {H}_{0} = {ϵ}_{2 ph} {a}^{2} + {ϵ}_{2 ph} * {a}^{{†}^{2}} {αϵ}_{2 ph} α = \sqrt{2 {ϵ}_{2 ph} / {κ}_{2}}$$

where, in the last case: is a complex number fixed by the ratio of the amplitude of the drive to the two-photon dissipation rate: and
κ₂ is the two-photon dissipation rate, a is the photon annihilation operator and α is a complex number defining the cat qubit.

It is known to the skilled person that the dissipative stabilization of two coherent states requires to engineer a non-linear conversion between two photons of a first mode a—also called the cat-qubit mode—that hosts the stabilized quantum manifold, and one photon of a second mode b known as buffer mode, and conversely. Such a stabilization scheme allows to suppress bit-flips exponentially with the number of photons in said two coherent states.

The jump operator L can be realized by coupling the buffer mode b to the cat-qubit and by engineering the Hamiltonian a²b^{†}, where b is the photon annihilation operator of mode b with a pump at frequency 2ωₐ−ω_{b} and a drive on the buffer mode at frequency ω_{b}.

In cat-qubit architectures, the quality of the hardware is measured by the ratio of two time scales:time 1/κ₂, where κ₂ is the two-photon dissipation rate that stabilizes the qubit; and time 1/κ₁, where κ₁ is the one-photon loss rate. There are other sources of errors such as the phase shift at the rate κ_{Φ}, thermal excitations, self-Kerr and cross-Kerr interactions, or other undesirable couplings with other quantum systems present in the vicinity of the memory, etc. Nevertheless, the one-photon loss is the dominant error mechanism and for the sake of clarity, only this physical error mechanism is considered in what follows. In general, all that follows is valid by replacing the ratio κ₁/κ₂ by the sum of the rates of the error mechanisms divided by κ₂.

As an example, a perturbation of the nominal dynamics of the cat-qubit can be related to a Z-gate. The Z-gate is one of the Pauli gates and corresponds to a rotation by π radians around the Z axis of the Bloch sphere. The Z-gate leaves the basis state |0 [symbol] unchanged and converts the basis state |1 [symbol] to −|1 [symbol] .

Such a perturbation can be written as follows:

$${ℒ}_{1} ( ρ ) = - i [ H , ρ ] + {{\sum }^{2}}_{v = 1} ( {L}_{v} ρ {L}_{v}^{†} - \frac{1}{2} ( {L}_{v}^{†} {L}_{v} ρ + ρ {L}_{v}^{†} {L}_{v} ) )$$

$$with : H = ω ( a + {a}^{†} ) , {L}_{1} = \sqrt{{κ}_{1}} a , {L}_{2} = \sqrt{{κ}_{ϕ}} {a}^{†} a$$

where: ω is the complex amplitude of the Hamiltonian, and |ω|, κ₁, κ_{Φ} are smaller than κ₂. By denoting L₃=L, which corresponds to the two-photon dissipation term, the Lindblad master equation of the cat-qubit can be written as follows:

$$\frac{d}{dt} ρ = - i [ H , ρ ] + {{\sum }^{3}}_{v = 1} ( {L}_{v} ρ {L}_{v}^{†} - \frac{1}{2} ( {L}_{v}^{†} {L}_{v} ρ + ρ {L}_{v}^{†} {L}_{v} ) )$$

In the context of the present invention, the open quantum system may be a composite system and thus comprise a plurality of quantum entities and not just a single quantum entity as in the previous case of a single cat-qubit. The quantum entities may be cat qubits, or other entities such as, qutrits, or bosonic code entities in general, for instance GKP qubits.

### Adiabatic Elimination in the Heisenberg Picture for Composite Open Quantum System of One or More Nominally Stabilized Quantum Entities

When the open quantum system includes n nominally stabilized quantum entities, where n is an integer greater than or equal to 1, the nominal dynamics of the density operator ρ can be written as a sum of the nominally stabilized quantum entity specific local nominal dynamics. In other words, the nominal dynamics admit the following structure:

$${ℒ}_{0} ( ρ ) = {{\sum }^{n}}_{q = 1} {ℒ}_{0 , q} ( ρ )$$

where: [symbol] _{0,q} is the local nominal dynamics of the q-th quantum entity of the open quantum system.

The Lindblad master equation of an open quantum system including one or more quantum entities is thus:

$$\frac{d}{dt} ρ = {{\sum }^{n}}_{q = 1} {ℒ}_{0 , q} ( ρ ) + {ℒ}_{1} ( ρ )$$

That is, the present inventors have thus recognized that for nominally stabilized quantum entities, such as dissipative stabilized cat qubits as described above, due to the specific local nominal dynamics of the nominally stabilized quantum entities, each nominally stabilized quantum entity of the open quantum system has a decoherence-free space D_{0,q}. The decoherence-free space D_{0,q} of the q-th nominally stabilized quantum entity is a set of Hermitian operators with support in a finite dimensional sub-space H_{0,q} of the Hilbert space H of the open quantum system and which form the steady-states of the local nominal dynamics [symbol] _{0,q} of the q-th nominally stabilized quantum entity.

It must be noted that the open quantum system has a Hilbert space H. The Hilbert space is well known to the skilled person in the field of quantum mechanics as it makes it possible to represent, with an infinite dimensional space, the set of quantum states of a quantum system. The Hilbert space can therefore be qualified as a state-space. Similarly, each quantum entity of the open quantum system has a respective Hilbert space H_{q}, such that:

H=⊗_{q=1}ⁿH_{q}

where: ⊗ denotes the tensor product.

In order to implement numerical simulations, a Galerkin dimension reduction is used: from the infinite-dimensional Hilbert space of the quantum entity, a subspace of finite dimension including the first N Fock states from the ground state to the (N−1)-th excited state and the problem is projected on this subspace to be solved.

Moreover, due to the specific local nominal dynamics of the quantum entities, each quantum entity of the open quantum system has a decoherence-free space D_{0,q}. The decoherence-free space D_{0,q} of the q-th quantum entity is a set of Hermitian operators with support in a finite dimensional sub-space H_{0,q} of the Hilbert space H and which form the steady-states of the local nominal dynamics [symbol] _{0,q} of the q-th quantum entity.

In the context of the invention, the respective decoherence-free spaces D_{0,q} are all exponential attractors and define together a decoherence-free space Do of the open quantum system:

D₀=⊗_{q=1}ⁿD_{0,q}

As a consequence, the decoherence-free space Do is also an exponential attractor.

In other words, any state p of the Hilbert space converges exponentially toward a steady-state of the open quantum system, which is a solution of the nominal dynamics, with a rate exceeding a positive one independent of the initial state.

The decoherence-free space D_{0,q} of the q-th quantum entity is a vector space of dimension d_{0,q} with:

d_{0,q}=2dim(H_{0,q})

Thus, there exists an orthonormal Hermitian basis of the decoherence-free space D_{0,q}:

D_{0,q}=span{S_{q,d}_{_{q}}⁰,d_{q}∈ [symbol] 1,d_{0,q} [symbol] }

where: S_{q,d}_{_{q}}⁰ is the d_{q}-th Hermitian operator of the orthonormal Hermitian basis of the decoherence-free space D_{0,q} of the q-th quantum entity. Such an orthonormal Hermitian basis verifies:

Tr(S_{q,d}_{_{q}}⁰S_{q,d}_{_{q}}_{′}⁰)=δ_{d}_{_{q}}_{,d}_{_{q}}_{′}

where: —Tr(·) is the trace, and
δ_{d}_{_{q}}_{,d}_{_{q}}_{′} is the Kronecker delta equal to 1 if d_{q} and d_{q}′ are equal, and 0 otherwise.

For any local Hermitian operator ρ_{q} on the Hilbert space H_{q} in the decoherence-free space D_{0,q}, there exists a vector X=(x_{d}_{_{q}}_{, d}_{_{q}}∈ [symbol] 1, d_{0,q} [symbol] ) such that:

$${ρ}_{q} = {{\sum }^{{d}_{0 , q}}}_{{d}_{q} = 1} {x}_{{d}_{q}} {S}_{q , {d}_{q}}^{0}$$

### Adapted Time-Discretization

After these local considerations, reference is made again to the general formulation of the Lindblad master equation of the density operator ρ of an open quantum system.

A classical approach in numerical analysis for obtaining an approximation of the solution of a time-dependent differential equation of a system is to use explicit methods. An explicit method allows to obtain a time-discrete expression of the differential equation in which the state of the system at a given time is expressed as a function of the state of the system at the previous time. For this purpose, a time step Δt is chosen for separating two consecutive instants.

Here, an explicit method may be applied to the Lindblad master equation of the density operator ρ of an open quantum system, which allows to obtain an equation of the following form:

ρₖ₊₁=EM(ρₖ)

where: ρₖ is the k-th time value of the time-discrete density operator and EM is the function depending on the selected explicit method and the chose time step Δt.

Among the known explicit methods, it is for example possible to use an explicit Euler scheme. The relation between the state of the density operator ρ at an instant tₖ₊₁ and the state of the density operator ρ at the previous instant tₖ is then the following:

$$\frac{d ρ}{dt} ( {t}_{k} ) = \dot{ρ} ( {t}_{k} ) = \frac{ρ ( {t}_{k + 1} ) - ρ ( {t}_{k} )}{{t}_{k + 1} - {t}_{k}} = \frac{{ρ}_{k + 1} - {ρ}_{k}}{{t}_{k + 1} - {t}_{k}}$$

Thus:

$${ρ}_{k + 1} = \dot{ρ} ( {t}_{k} ) ( {t}_{k + 1} - {t}_{k} ) + {ρ}_{k}$$

The skilled person understands here that it is possible to use other explicit methods than the explicit Euler scheme, for example explicit Runge-Kutta methods.

As explained above, the dynamics of the Lindblad master equation of the density operator ρ includes at least a sum of quantum entity specific local nominal dynamics and, generally, a perturbation. The application of the explicit method to the Lindblad master equation preserves this separation in the sense that the expression of ρₖ₊₁ as a function of ρk can also be split into a local nominal dynamics portion and a perturbation portion. As previously explained, the local nominal dynamics portion and the perturbation portion can be distinguished since the perturbation portion has a negligible norm compared to the local nominal dynamics portion. In other words:

$${ρ}_{k + 1} = {EM}_{0} ( {ρ}_{k} ) + {K}_{1} ( {ρ}_{k} )$$

with:

∥K₁∥<<∥EM₀−I∥

where: EM₀ is the local nominal dynamics portion, while K₁ is the perturbation portion.

The term “negligible” should be interpreted in the same way as above. Here again, one can generally consider that the perturbation portion is negligible compared to the nominal local dynamics portion when the amplitude of the perturbation portion is five times smaller than the amplitude of the local nominal dynamics portion:

$$5 * ‖ {K}_{1} ‖ < ‖ {EM}_{0} - I ‖$$

Concerning more specifically the local nominal dynamics portion EM₀, a Kraus map formulation can be applied thereto.

Kraus' theorem characterizes completely positive and trace-preserving maps that model quantum operations between quantum states. Informally, the theorem ensures that the action of any such quantum operation O on a state ρ can always be written as follows:

$$O ( ρ ) = {\sum }_{k} {B}_{k} ρ {B}_{k}^{†}$$

for some set of operators Bₖ satisfying Σₖ Bₖ^{†}Bₖ=1, where 1 is the identity operator here.

The used Kraus map is a quantum channel, i.e. a trace-preserving and completely-positive linear map. Indeed, a quantum channel makes it possible to preserve fundamental properties of the density operator ρ of the open quantum system, namely a trace equal to 1 and positivity.

To this end, the Applicant has found some Kraus maps, such as the Kraus map below:

$${K}_{0} ( ρ ) = U ( \overline{M} U ρ {U}^{†} {\overline{M}}^{†} + Δ t ( {\sum }_{v} {\overline{L}}_{v} U ρ {U}^{†} {\overline{L}}_{v}^{†} ) ) {U}^{†}$$

$$with :$$

$$U = {e}^{- i Δ tH / 2}$$

$$\overline{M} = {MS}^{- \frac{1}{2}}$$

$${\overline{L}}_{v} = {L}_{v} {S}^{- \frac{1}{2}}$$

$$where : M = I - {\sum }_{v} \frac{Δ t}{2} {L}_{v}^{†} {L}_{v} and S = {M}^{†} M + Δ t {\sum }_{v} {L}_{v}^{†} {L}_{v} ,$$

The application of an explicit method to the Lindblad master equation of the density operator ρ of the open quantum system, then the Kraus map formulation of the local nominal dynamics portion finally allows to obtain an equation of the following form:

$${ρ}_{k + 1} = {K}_{0} ( {ρ}_{k} ) + {K}_{1} ( {ρ}_{k} )$$

Furthermore, as previously explained above, embodiments of the invention deals with an open quantum system including one or more quantum entities, so that the nominal dynamics of the density operator ρ is a sum of quantum entity specific local nominal dynamics. This property of the nominal dynamics results, after application of the Kraus map formulation, in that the Kraus map K₀ of the local nominal dynamics portion derives from the respective Kraus maps K_{0,q} of the quantum entity specific local nominal dynamics. This relation is written as follows:

K₀=⊗_{q=1}ⁿK_{0,q}

Strictly speaking, it should be understood here that the Kraus map K_{0,q} of the q-th quantum entity of the open quantum system is more exactly the Kraus map formulation of the local nominal dynamics of the q-th quantum entity after applying the explicit method to this local nominal dynamics.

On the other hand, concerning the perturbation portion K₁, the latter can be expressed as follows:

$${K}_{1} ( ρ ) = - i Δ t [ H , ρ ] + Δ t ( {\sum }_{v} ( {L}_{v} ρ {L}_{v}^{†} - \frac{1}{2} ( {L}_{v}^{†} {L}_{v} ρ + ρ {L}_{v}^{†} {L}_{v} ) ) )$$

Moreover, embodiments of the invention fall within a particular context in which the perturbation of the open quantum system presents a specific property for the operators which are separable.

As mentioned above, the open quantum system has a Hilbert space H and each quantum entity of the open quantum system has a respective Hilbert space H_{q}.

A separable operator W on the Hilbert space H can be written as a tensor product of respective local operators W_{q} of Hilbert spaces H_{q}:

W=⊗_{q=1}ⁿW_{q}

The perturbation portion K₁ is such that, for any separable operator W on the Hilbert space H, there exists a finite set of local operator pairs L_{q,μ}¹ and R_{q,μ}¹ on H_{q} such that:

$${K}_{1} ( W ) = {\sum }_{μ} {⊗}_{q = 1}^{n} {L}_{q , μ}^{1} {W}_{q} {R}_{q , μ}^{1}$$

As detailed in the following description, the core of embodiments of the invention relies on the synergy between, on the one hand, the intrinsically local character of the nominal dynamics of the open quantum system and, on the other hand, the fact that the perturbation, although not local, can be expressed as a finite sum of tensor products with a finite number of pairs of local operators.

Such a synergy allows to have a sufficiently accurate approximation of the evolution of the density operator ρ and thus of the state of the open quantum system without requiring too high computational resources.

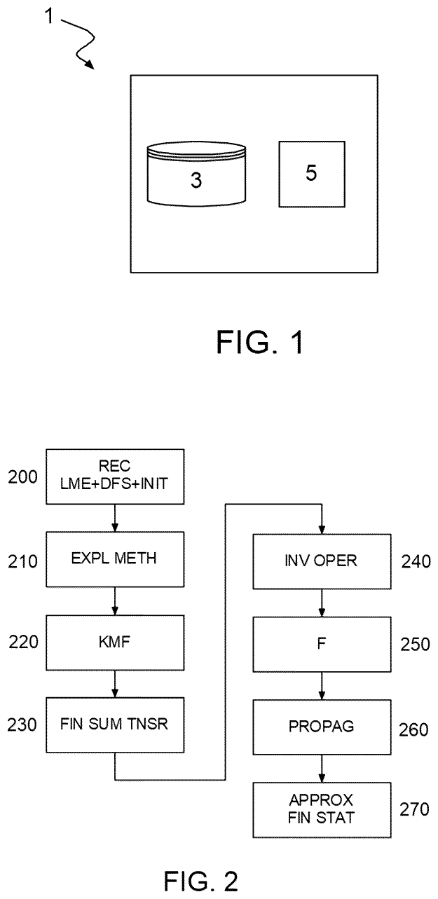

To this end, FIG. 1 illustrates a device 1 for simulating an open quantum system including one or more quantum entities. More generally, such an open quantum system includes a number n of quantum entities, where n is an integer which may be greater than or equal to one. In addition, the simulation of the open quantum system is performed by simulating the time evolution of its density operator ρ whose Lindblad master equation has been previously mentioned and discussed. In embodiments, the open quantum system includes one or more nominally stabilized quantum entities (i.e. each is stabilized around a respective decoherence-free space D_{0,q}). In embodiments, all of the quantum entities of the open system are nominally stabilized quantum entities such that the respective decoherence-free spaces define together a decoherence-free space D₀ of the open quantum system with D₀=⊗_{q=1}ⁿ D_{0,q}.

The device 1 is arranged to receive as inputs a Lindblad master equation defining the dynamics of the density operator ρ of an open quantum system including one or more quantum entities to be simulated, along with the respective decoherence-free spaces D_{0,q} of the quantum entities and an initial state ρ₀ of the density operator ρ and to derive an approximated final state ρ_{f} of the density operator ρ. More particularly, the device 1 receives the operators of the Lindblad master equation, i.e. the Lindblad operators of the dissipative part and, if applicable, the Hamiltonian part.

As illustrated in FIG. 1, the device 1 comprises a memory 3 and a processor 5.

The memory 3 is arranged to store data representing the time evolution of a Lindblad master equation defining the dynamics of the density operator ρ of the open quantum system. As mentioned above, the dynamics includes at least a sum of quantum entity specific local nominal dynamics.

More generally, the memory 3 is arranged to store instructions whose execution, by the processor 5, results in the simulation of the open quantum system.

The memory 3 can be any data storage medium arranged to receive and store digital data, for instance a hard disk, a semiconductor disk or more generally any computer component dedicated to the storage of data on flash memory. The memory 3 can also be a random access memory (RAM) or a magneto-optical disk. A combination of several types of data storage can also be envisaged.

The processor 5 is arranged to generate a propagator of the open quantum system dynamics. Such a propagator allows, from the initial state ρ₀ of the open quantum system, to derive the final state ρ_{f}. The wording “final state” is to be understood here as the state of the open quantum system after a period of time over which the Lindblad master equation rules the open quantum system. The processor 5 is further arranged to apply the propagator to the initial state ρ₀ of the open quantum system to simulate the same and determine the final state ρ_{f} thereof.

The propagator is a function that specifies the probability amplitude for a particle to travel from one place to another in a given period of time, or to travel with a certain energy and momentum. For example, for a time independent Hamiltonian H, the time evolution operator or propagator is the unitary operator U:t→exp(−iHt/h) where h is the reduced Planck constant.

The processor 5 can be a microprocessor, a programmable logic device (PLD) or a dedicated chip of field programmable gate array (FPGA) or system on chip (SoC) type, a grid of computer resources, a microcontroller or any other specific form that has the necessary computing power to implement the method for simulating the open quantum system. One or more of these elements can also be implemented in the form of specialized electronic circuits such as an application-specific integrated circuit (ASIC). A combination of processors and electronic circuits can also be envisaged.

The functioning of the processor 5 according to the first aspect will be described hereinafter with reference to FIG. 2 which represents the simulation of the open quantum system.

A method for simulating an open quantum system including one or more quantum entities is now described with reference to FIG. 2.

In an operation 200, the device 1 receives as inputs the Lindblad master equation defining the dynamics of the density operator ρ of the open quantum system including one or more quantum entities to be simulated, along with the respective decoherence-free spaces D_{0,q} of the quantum entities and the initial state ρ₀ of the density operator ρ.

As previously mentioned, the open quantum system typically comprises a plurality of quantum entities, in which case it is a composite open quantum system.

However, it is also possible to simulate an open quantum system with a single quantum entity, in which case the system coincides with the single quantum entity it contains. This case will be discussed more particularly with reference to FIG. 10.

The inputs can be stored in the memory 3 of the device 1.

In an operation 210, the processor 5 applies an explicit method to the Lindblad master equation for generating a discrete-time expression thereof.

As explained above, the discrete-time expression of the Lindblad master equation is split into a local nominal dynamics portion EM, and a perturbation portion K₁. The amplitude of the perturbation portion is negligible compared to the amplitude of the local nominal dynamics portion EM₀−I.

The explicit method is for instance an explicit Euler scheme.

In an operation 220, the processor 5 applies a trace-preserving and completely-positive linear Kraus map formulation to the local nominal dynamics portion EM₀. The Kraus map K₀ of the local nominal dynamics portion is derived from the respective Kraus maps K_{0,q} of the quantum entity specific local nominal dynamics with K₀=⊗_{q=1}ⁿ K_{0,q}.

The time-discretization via Kraus map of the Lindblad master equation is written as follows:

$${ρ}_{k + 1} = {K}_{0} ( {ρ}_{k} ) + {K}_{1} ( {ρ}_{k} )$$

In an operation 230, the processor determines a finite set of pairs of local operators L_{q,μ}¹ and R_{q,μ}¹, each pair of local operators (L_{q,μ}¹, R_{q,μ}¹) being on the corresponding Hilbert space H_{q}. As previously explained, this finite set of pairs of local operators is such that K₁ (⊗_{q=1}ⁿ W_{q})=Σ_{μ}⊗_{q=1}ⁿ L_{q,μ}W_{q}R_{q,μ}¹ for all local operators W_{q} each on the corresponding Hilbert space H_{q}.

In an operation 240, the processor 5 calculates the invariant operators of each quantum entity:

$${J}_{q , {d}_{q}} = {lim}_{i \to + ∞} {[ {K}_{0 , q}^{*} ]}^{i} ( {S}_{q , {d}_{q}}^{0} )$$

$$with :$$

$$Tr ( {J}_{{d}_{q}} {S}_{{d}_{q}^{′}}^{0} ) = {δ}_{{d}_{q} , {d}_{q}^{′}}$$

where: K_{0,q}^{*} is the conjugate transpose of the local nominal dynamics portion K_{0,q} of the q-th quantum entity.

For a given quantum entity, the processor 5 calculates a number d_{0,q} of invariant operators.

It can be noticed that, for any local Hermitian operators ρ_{q} and Wₖ on the Hilbert space H_{q}:

$${lim}_{i \to + ∞} {[ {K}_{0 , q} ]}^{i} ( {ρ}_{q} ) = {{\sum }^{{d}_{0 , q}}}_{{d}_{q} = 1} Tr ( {J}_{{d}_{q}} {ρ}_{q} ) {S}_{q , {d}_{q}}^{0}$$

$$and :$$

$${lim}_{i \to + ∞} {[ {K}_{0 , q}^{*} ]}^{i} ( {W}_{q} ) = {{\sum }^{{d}_{0 , q}}}_{{d}_{q} = 1} Tr ( {S}_{q , {d}_{q}}^{0} {W}_{q} ) {J}_{{d}_{q}}$$

The invariant operators of the q-th quantum entity allow to retrieve the coordinates of any local Hermitian operator ρ_{q} in the Hermitian orthonormal basis (for the Frobenius product) of D_{0,q}{S_{q,d}_{_{q}}⁰, d_{q}∈ [symbol] 1, d_{0,q} [symbol] } and Tr(J_{d}_{_{q}}ρ_{q}) can thus be seen as a scalar product:

$${ρ}_{q} = {{\sum }^{{d}_{0 , q}}}_{{d}_{q} = 1} {x}_{{d}_{q}} {S}_{q , {d}_{q}}^{0}$$

Then:

$${J}_{{d}_{q}^{′}} {ρ}_{q} = {{\sum }^{{d}_{0 , q}}}_{{d}_{q} = 1} {x}_{{d}_{q}} {J}_{{d}_{q}^{′}} {S}_{q , {d}_{q}}^{0}$$

Then:

$$Tr ( {J}_{{d}_{q}^{′}} {ρ}_{q} ) = {{\sum }^{{d}_{0 , q}}}_{{d}_{q} = 1} {x}_{{d}_{q}} Tr ( {J}_{{d}_{q}^{′}} {S}_{q , {d}_{q}}^{0} )$$

Thus:

$$Tr ( {J}_{{d}_{q}^{′}} {ρ}_{q} ) = {{\sum }^{{d}_{0 , q}}}_{{d}_{q} = 1} {x}_{{d}_{q}} {δ}_{{d}_{q} , {d}_{q}^{′}} = {x}_{{d}_{q}^{′}}$$

In an operation 250, the processor 5 determines a second-order approximation of a matrix F modeling the time evolution of the time-discrete density operator of the open quantum system. The matrix F is written as follows:

$$F = {F}^{0} + {F}^{1} + {F}^{2}$$

where: F⁰ is the zero-order part of the matrix F, F¹ is the first-order part of the matrix F and F² is the second-order part of the matrix F. Here, F⁰, F¹ and F² relate to the perturbative expansion and are not powers of F.

It can be noted that the matrix F is a (d_{0,1}× . . . ×d_{0,n})(d_{0,1}× . . . ×d_{0,n}). The same applies for the matrices F⁰, F¹ and F².

As detailed below, the matrix F is used by the processor 5 to build a propagator for determining the final state of the open quantum system based on the initial state.

The zero-order part F⁰ of the matrix F is the identity matrix:

F⁰=I

The respective coefficients of the first-order part F¹ and the second-order part F² of the matrix F are calculated as follows:

$${F}_{( {d}_{1}^{′} , … , {d}_{n}^{′} ) , ( {d}_{1} , … , {d}_{n} )}^{1} = {\sum }_{μ} {{\prod }^{n}}_{q = 1} Tr ( {J}_{μ , q , {d}_{q}^{′}}^{1} {S}_{q , {d}_{q}}^{0} )$$

$${F}_{( {d}_{1}^{′} , … , {d}_{n}^{′} ) , ( {d}_{1} , … , {d}_{n} )}^{2} = {{\sum }^{+ ∞}}_{i = 0} ( {\sum }_{μ , {μ}^{′}} {{\prod }^{n}}_{q = 1} Tr ( {{J}_{{μ}^{′} , q , {d}_{q}^{′}}^{1} [ {K}_{0 , q} ]}^{i} ( {S}_{μ , q , {d}_{q}}^{1} ) ) - {{\prod }^{n}}_{q = 1} {\sum }_{{d}_{q}^{″}} Tr ( {J}_{{μ}^{′} , q , {d}_{q}^{′}}^{1} {S}_{q , {d}_{q}^{″}}^{0} ) Tr ( {J}_{μ , q , {d}_{q}^{″}}^{1} {S}_{q , {d}_{q}}^{0} ) )$$

$$with :$$

$${J}_{μ , q , {d}_{q}^{′}}^{1} = {R}_{q , μ}^{1} {J}_{q , {d}_{q}^{′}} {L}_{q , μ}^{1}$$

$${S}_{ μ , q , {d}_{q}}^{1} = {L}_{q , μ}^{1} {S}_{q , {d}_{q}}^{0} {R}_{q , {d}_{q}}^{1}$$

where: I is the identity matrix on the Hilbert space H, F_{(d}_{₁}_{′, . . . , d}_{ₙ}_{′),(d}_{₁}_{, . . . , d}_{ₙ}₎¹ is a coefficient of a first-order part F¹ of the matrix F and F_{(d}_{₁}_{′, . . . , d}_{ₙ}_{′),(d}_{₁}_{, . . . , d}_{ₙ₎}² is a coefficient of a second-order part F² of the matrix F.

The previous expression of the matrix F is time independent, which is the case when the perturbation portion K₁ is itself time independent. However, this is not always the case and it is possible to have a time-discrete expression of the perturbation portion K₁:

K₁⊗K₁(k)

which induces time-discrete expressions for the pairs of local operators L_{q,μ}¹ and R_{q,μ}¹:

L_{q,μ}¹⊗L_{q,μ}¹(k)

R_{q,μ}¹⊗R_{q,μ}¹(k)

As a consequence, the zero-order part, the first-order part and the second-order part are time-dependent:

$${F}^{0} ( k ) = I$$

$${F}_{( {d}_{1}^{′} , … , {d}_{n}^{′} ) , ( {d}_{1} , … , {d}_{n} )}^{1} ( k ) = {\sum }_{μ} {{\prod }^{n}}_{q = 1} Tr ( {J}_{μ , q , {d}_{q}^{′}}^{1} ( k ) {S}_{q , {d}_{q}}^{0} )$$

$${F}_{( {d}_{1}^{′} , … , {d}_{n}^{′} ) , ( {d}_{1} , … , {d}_{n} )}^{2} ( k ) = {{\sum }^{+ ∞}}_{i = 0} ( {\sum }_{μ , {μ}^{′}} {{\prod }^{n}}_{q = 1} Tr ( {{J}_{{μ}^{′} , q , {d}_{q}^{′}}^{1} ( k ) [ {K}_{0 , q} ]}^{k} ( {S}_{μ , q , {d}_{q}}^{1} ( k ) ) ) - {{\prod }^{n}}_{q = 1} {\sum }_{{d}_{q}^{″}} Tr ( {J}_{{μ}^{′} , q , {d}_{q}^{′}}^{1} ( k ) {S}_{q , {d}_{q}^{″}}^{0} ) Tr ( {J}_{μ , q , {d}_{q}^{″}}^{1} ( k ) {S}_{q , {d}_{q}}^{0} ) )$$

$$with :$$

$${J}_{μ , q , {d}_{q}^{′}}^{1} ( k ) = {R}_{q , μ}^{1} ( k ) {J}_{q , {d}_{q}^{′}} {L}_{q , μ}^{1} ( k )$$

$${S}_{ μ , q , {d}_{q}}^{1} ( k ) = {L}_{q , μ}^{1} ( k ) {S}_{q , {d}_{q}}^{0} {R}_{q , {d}_{q}}^{1} ( k )$$

In an operation 260, the processor 5 determines a propagator P as a time product of the matrix F.

The perturbation portion K₁ can be time independent—or more exactly constant over time—in which case the matrix F is also time independent. Conversely, the perturbation portion K₁ can be time dependent, in which case the matrix F is also time dependent. These two cases result in different expressions for the propagator P.

Thus, if the perturbation portion K₁ is time independent, the propagator P is the following:

$$P = {e}^{T \frac{F}{Δ t}}$$

where: T is a time quantity over which the Lindblad master equation rules the open quantum system.

If the perturbation portion K₁ is time dependent, the processor 5 determines the propagator P as a time-ordered product:

$$P = {{\prod }^{T / Δ t}}_{k = 0} F ( T - k Δ t ) = {F}_{T} \times {F}_{T - Δ t} \times … \times {F}_{Δ t} \times {F}_{0}$$

In the previous equation, the time step Δt is time independent and is thus constant over the time. However, the explicit method used in the operation 210 can also be applied to the Lindblad master equation such that the time step Δt varies from one iteration to the next. In such a case, the time step corresponding to the k-th time value of the time-discrete density operator is noted Δtₖ. In such a case, the propagator P determined by the processor 5, when the perturbation portion K₁ is time independent, can be expressed as the following time-ordered product:

$$P = {{\prod }^{Λ}}_{k = 0} F ( T - {{\sum }^{k}}_{j = 0} Δ {t}_{j} ) = {F}_{T} \times {F}_{T - Δ {t}_{1}} \times … \times {F}_{0}$$

where: Λ is the number of time steps Δtₖ over the time quantity T, and Δt₀ is equal to 0 by convention.

Finally, in an operation 270, the processor 5 derives an approximated final state ρs of the density operator ρ by applying the propagator P to the initial state ρ₀ of the density operator ρ of the open quantum system. In other words:

$${ρ}_{f} = P \cdot {ρ}_{0}$$

For an open quantum system including one or more entities, it is thus possible to determine a propagator P as a function of the matrix F, a second-order approximation of which can be computed with limited computational resources. This computation takes advantage of both the local character of the nominal dynamics and the fact that the perturbation is decomposable into a finite sum of tensor products of local operators.

The simulation of an open quantum system including a plurality of quantum entities is particularly appropriate to simulate a quantum logic gate involving two or more qubits. As an example, the results obtained for a ZZ-gate as well as for a ZZZ-gate are discussed below.

For the sake of reducing the number of notations, it is assumed here that the same a is used of each cat-qubit, whatever the gate. However, the following specifications can be straightforwardly adapted to cat-qubit of different sizes; in such a case, each of the n cat-qubits has a respective size aq.

The ZZ-gate and the ZZZ-gate are implemented through the quantum Zeno effect, by using a weak Hamiltonian that triggers the accumulation of the desired “dynamical phase” in the cat-qubit subspace. Here, the bias-preserving property is ensured by the fact that phase-flips commutes with the continuous process implementing the gate, and by the fact that the two-photon dissipation is always turned on.

The ZZ(θ)-gate and the ZZZ(θ)-gate are both the rotation of an arbitrary angle θ about the Z axis of the Bloch sphere of the cat-qubits involved in the gate. In order to describe those gates, a rotation about the Z axis of a single cat-qubit is firstly studied. A rotation about the Z axis of a cat-qubit can be written as:

$$Z ( θ ) = {e}^{- i \frac{θ}{2} {Z}_{α}} = cos \frac{θ}{2} {I}_{α} - isin \frac{θ}{2} {Z}_{α}$$

where: I_{α} and Z_{α} are the Pauli operators which act on the cat-qubit defined by α. Those Pauli operators can be expressed as:

$$\\ \begin{matrix}{{I}_{α} = \vert {C}_{{α}^{+}} 〉 〈 {C}_{{α}^{+}} \vert + \vert {C}_{{α}^{-}} 〉 〈 {C}_{{α}^{-}} \vert}_{} \\ {Z}_{α} = \vert {C}_{{α}^{+}} 〉 〈 {C}_{{α}^{-}} \vert + \vert {C}_{{α}^{-}} 〉 〈 {C}_{{α}^{+}} \vert\end{matrix}$$

In the following, the subscript a is dropped and the operators applied to the cat-qubits are simply written using the usual qubit notations. The Z(θ)-gate is implemented by applying a weak resonant drive described by the following Hamiltonian in the rotating frame of the cavity mode:

where: ε_{Z} is the amplitude of the drive Hamiltonian.

In the following, ε_{Z} is considered as real even if it can be complex. In such case, the Hamiltonian writes:

$$\\ {H}_{Z} = {ϵ}_{Z} a + {ϵ}_{Z}^{{}_{} *} {a}^{†}$$

where: ε_{Z}^{*} is the complex conjugate of ε_{Z}.

This Hamiltonian is applied on the quantum entities in the presence of the nominal dynamics. In such a case, the two-photon driven dissipation modelled by the Lindblad super-operator κ₂D_{α}_{²}_{-α}_{²}, with |ε_{Z}| small with respect to κ₂. The combination of these two dynamics implements the gate as follows. The fast two-photon driven-dissipative part of the dynamics confines the state in the cat-qubit manifold, while the one-photon drive induces a change of the photon number parity. If the cat-qubit is initialized in the state |C_{α}_{⁺} [symbol] —having an even photon number parity—the effect of the weak drive is to induce Rabi oscillations between the even cat |C_{α}⁺ [symbol] and the odd cat |C_{α}⁻ [symbol] . The rate of these Rabi oscillations is set by the first order perturbation induced by the Hamiltonian, given by the projection of the Hamiltonian on the cat-qubit subspace:

$$\\ {I}_{α} {H}_{z} {I}_{α} = 2 Re ( α {ϵ}_{Z} ) {Z}_{α} + O ( {e}^{{}_{} - 2 {\vert α \vert}^{2}} )$$

where: Re(·) denotes the real part.

For α and ε_{Z} real:

$$\\ {I}_{α} {H}_{z} {I}_{α} = 2 {αϵ}_{Z} {Z}_{α} + O ( {e}^{{}_{} - 2 {\vert α \vert}^{2}} )$$

The fact that the effective dynamics, up to the first order in the small parameter ε_{Z}/κ₂, is given by the projection of the perturbative Hamiltonian is the well-known quantum Zeno effect.

In the context of the Z-gate, the rotation of an angle θ is obtained by applying the weak drive during a time:

$$\\ T = \frac{θ}{4 α {ϵ}_{Z}}$$

The same recipe can be readily applied to construct the two-qubit entangling gate ZZ(θ).

The Pauli operators I_{α} and Z_{α} acting on the first cat-qubit (respectively second cat-qubit) are denoted I₁ and Z₁ (respectively I₂ and Z₂) hereinafter.

$$\\ {Z}_{1} {Z}_{2} ( θ ) = {e}^{{}_{} - i \frac{θ}{2} {Z}_{1} {Z}_{2}} = cos \frac{θ}{2} {I}_{1} {I}_{2} - i sin \frac{θ}{2} {Z}_{1} {Z}_{2}$$

As for the Z-gate described above, the ZZ-gate is realized by applying a weak beam-splitter Hamiltonian H_{Zz} written as follows:

$$\\ {H}_{ZZ} = {ϵ}_{{Z}_{1} {Z}_{2}} {a}_{1} {a}_{2}^{†} + {ϵ}_{{Z}_{1} {Z}_{2}}^{{}_{} *} {a}_{1}^{†} {a}_{2}$$

where: ε_{Z}_{₁}_{Z}_{₂} is the amplitude of the Hamiltonian, a₁ (respectively a₂) is the annihilation operator of the first (respectively second) cat-qubit.

This weak beam-splitter Hamiltonian is applied in the presence of the two-photon driven dissipation on both of the cat qubits.

Taking ε_{Z}_{₁}_{Z}_{₂} to be real, the projection of H_{Zz} on the two cat-qubit subspaces gives the oscillation rate Ω_{Z}_{₁}_{Z}_{₂}=2|α|²ε_{Z}_{₁}_{Z}_{₂}, such that the rotation Z₁Z₂(θ) is obtained upon the application of the weak Hamiltonian during the following time T:

$$\\ T = \frac{θ}{4 {\vert α \vert}^{2} {ϵ}_{{Z}_{1} {Z}_{2}}}$$

We will show the agreement of this new simulation technique in the Heisenberg picture with the previous one in the Schrodinger picture by producing quantum process tomographies via the χ matrix representation, which is a complete characterisation of a quantum channel.

The χ matrix of the ZZ-gate are obtained by applying the propagator on a set of 16 initial density matrices {ρᵢ}_{1≤i≤16}. The processor 5 thus computes their final states {ρ_{f,i}}_{1≤i≤16} and builds the χ matrix from them according to the following formula:

$$\\ ε ( ρ ) = {\sum }_{m , n} {χ}_{m , n} {S}_{m} ρ {S}_{n}$$

where: the operators Sₘ denote the Pauli matrices {I, X, Y, Z}² which form a basis of the two two-level qubits density matrices.

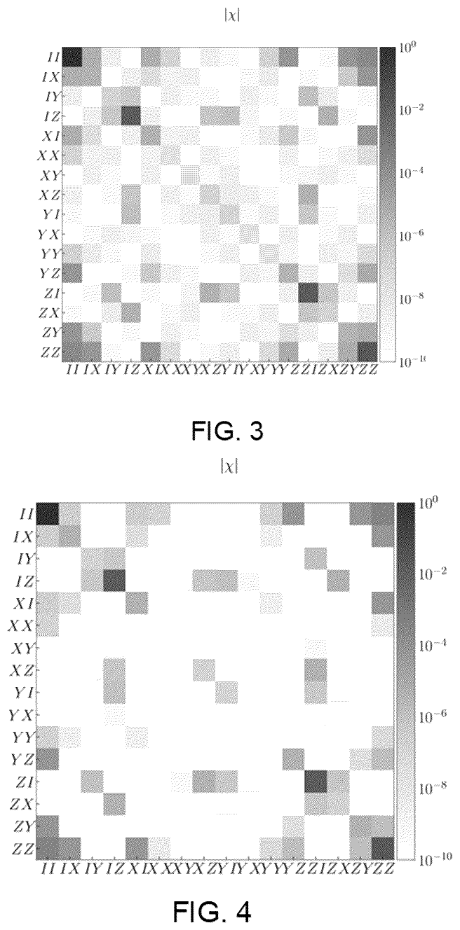

FIG. 3 shows the modulus of the χ matrix obtained after simulating the {ρᵢ}_{1≤i≤16} using the Schrödinger picture for |α|²=4, a one-photon loss amplitude of κ₁=10⁻³, a Hamiltonian amplitude of ε_{ZZ}=5×10⁻², θ=π and a truncature of 41, meaning that the first 41 Fock states were used in the simulation per cat-qubit to described the infinite-dimensional Hilbert space, as described above.

FIG. 4 shows the modulus of the χ matrix obtained after simulating the {ρᵢ}_{1≤i≤16} using the proposed simulation method in the Heisenberg picture for the same parameters |α|²=4, a one-photon loss amplitude of κ₁=10⁻³ and a Hamiltonian amplitude of ε_{ZZ}=5×10⁻², but a truncature of 100 per cat-qubit.

The comparison of both figures shows that the proposed simulation method succeeds in computing correctly the final states of density matrices for this set of experimental parameters.

The simulation takes about 160 hours with the Schrödinger picture versus only 5 minutes with the proposed simulation method in the Heisenberg picture.

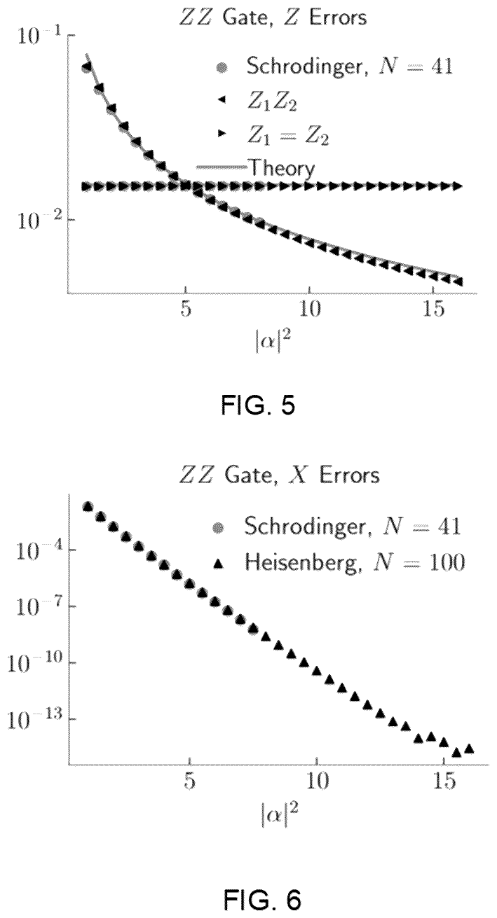

To make the comparison more thorough, the same comparison is carried out for a mean photon number |α|² ranging from 1 to 16 and the particular coefficients of the χ matrix are displayed. FIG. 5 shows the different phase-flip error probabilities: the evolution of the coefficient χ_{(z}_{₁}_{Z}_{₂}_{,z}_{₁}_{Z}_{₂}₎ represented by black triangles pointing to the left and decreasing with the mean photon number |α|², and χ_{(z}_{₁}_{,z}_{₁}₎ and χ_{(z}_{₂}_{,z}_{₂}₎ represented by black triangles pointing to the right and constant with the mean photon number |α|² using the proposed simulation method.

The same coefficients computed with the Schrödinger picture are shown as grey circles slightly below the black triangles.

The analytical formula for the Z₁, Z₂ and Z₁Z₂ errors obtained via second-order adiabatic elimination are shown as grey lines.

$$\\ \begin{matrix}{{p}_{{Z}_{1}} = {p}_{{Z}_{2}} = {\vert α \vert}^{2} {κ}_{1} T}_{} \\ {p}_{{Z}_{1} {Z}_{2}} = \frac{{π}^{{}_{} 2}}{8 {\vert α \vert}^{2} {κ}_{2} T}\end{matrix}$$

The Schrödinger picture would require higher truncatures to go above 8 photons and is thus not simulated here.

FIG. 6 shows the evolution of the sum of the coefficients of χ that include bitflips: one or more of the errors X₁, Y₁, X₂ and Y₂. Those errors are represented as black triangles pointing upward and exponentially decreasing with the mean photon number |α|². The same coefficients computed with the Schrödinger picture are shown as grey circles below the black triangles.

In this figure, one verifies the exponential suppression of bitflips which is known to be hard in numerical simulations.

Finally, one considers the ZZZ-gate hereinafter. From a theoretical point of view, the above Zeno mechanism can be generalized to construct arbitrary rotations on n qubits. For instance, the three-qubit entangling gate ZZZ(0) can be generated, for instance by using the weak Hamiltonian between three cat-qubits:

$$\\ {H}_{zzz} = {ϵ}_{{Z}_{1} {Z}_{2} {Z}_{3}} {a}_{1} {a}_{2} {a}_{{3}^{†}} + hc$$

where: ε_{Z}_{₁}_{Z}_{₂}_{Z}_{₃} is the amplitude of the Hamiltonian, a₁ (respectively a₂ and a₃) is the annihilation operator of the first (respectively second and third) cat-qubit.

This weak beam-splitter Hamiltonian is applied in the presence of the two-photon driven dissipation on both of the cat-qubits.

The rotation Z₁Z₂Z₃(θ) is obtained upon the application of the weak Hamiltonian during the following time:

$$\\ T = \frac{θ}{4 {\vert α \vert}^{3} {ϵ}_{{Z}_{1} {Z}_{2} {Z}_{3}}}$$

The χ matrices of the ZZZ-gate are obtained by applying the propagator on a set of 64 initial density matrices {ρᵢ}_{1≤i≤64}. The processor 5 thus computes their final states {ρ_{f,i}}_{1≤i≤64} and builds the χ matrix from them according to the following formula:

$$\\ ε ( ρ ) = {\sum }_{m , n} {χ}_{m , n} {S}_{m} ρ {S}_{n}$$

where: the operators Sₘ denote the Pauli matrices {I, X, Y, Z}³ which form a basis of the three two-level qubits density matrices.

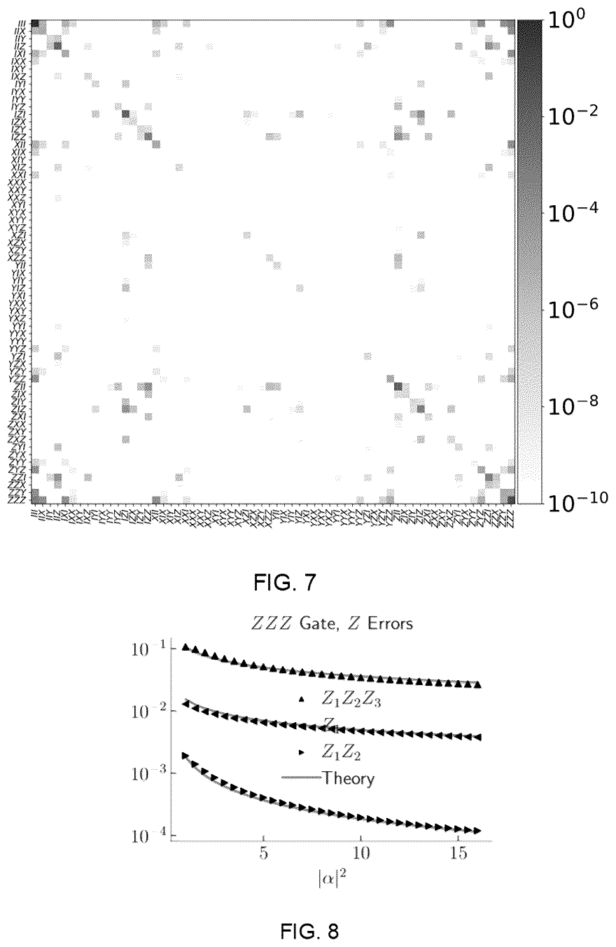

FIG. 7 shows the modulus of the χ matrix obtained after simulating the {ρᵢ} using the proposed simulation method in the Heisenberg picture for the same parameters |α|²=4, a one-photon loss of κ₁=10⁻³, a Hamiltonian amplitude of ε_{ZZZ}=5×10⁻² and θ=π, but a truncature of 100 per cat-qubit.

Here the size of the full Hilbert space composed of the three cat-qubits is too big to allow for a simulation in the Schrödinger picture.

FIG. 8 shows the evolution of the coefficient χ_{(Z}_{₁}_{Z}_{₂}_{Z}_{₃}_{,Z}_{₁}_{Z}_{₂}_{Z}_{₃}₎ represented by black triangles pointing upward, χ_{(Z}_{₁}_{Z}_{₂}_{,Z}_{₁}_{Z}_{₂}₎ and χ_{(Z}_{₁}_{Z}_{₃}_{,Z}_{₁}_{Z}_{₃}₎ and X_{(Z}_{₂}_{Z}_{₃}_{,Z}_{₂}_{Z}_{₃}₎ represented by black triangles pointing to the right, and χ_{(Z}_{₁}_{,Z}_{₁}₎ and χ_{(Z}_{₂}_{,Z}_{₂}₎ and χ_{(Z}_{₃}_{,Z}_{₃}₎ represented by black triangles pointing to the left for the proposed simulation method.

The same coefficients with the Schrödinger picture cannot be computed in a reasonable time.

The analytical formula for the Z₁, Z₂, Z₃ and Z₁Z₂, Z₁Z₃, Z₂Z₃ and Z₁Z₂Z₃ errors obtained via second-order adiabatic elimination are shown as grey lines and show very good agreement.

$$\\ {p}_{{Z}_{1}} = {p}_{{Z}_{2}} = {p}_{{Z}_{3}} = {α}^{{}_{} 2} {κ}_{1} T$$

$$\\ {p}_{{Z}_{1} {Z}_{2} {Z}_{3}} = \frac{3 π {ϵ}_{{Z}_{1} {Z}_{2} {Z}_{3}}}{4 α {κ}_{2}}$$

$$\\ {p}_{{Z}_{1} {Z}_{2}} = {p}_{{Z}_{2} {Z}_{3}} = {p}_{{Z}_{1}} {p}_{{Z}_{1} {Z}_{2} {Z}_{3}} = {p}_{{Z}_{2}} {p}_{{Z}_{1} {Z}_{2} {Z}_{3}} = {p}_{{Z}_{3}} {p}_{{Z}_{1} {Z}_{2} {Z}_{3}} = \frac{3 {π}^{{}_{} 2} {κ}_{1}}{16 {α}^{{}_{} 2} {κ}_{2}}$$

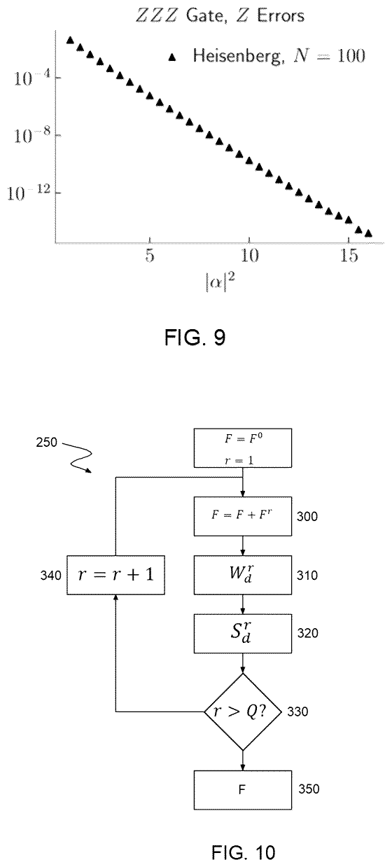

FIG. 9 shows the evolution of the sum of the coefficients of χ that include bitflips: one or more of the errors X₁, Y₁, X₂, Y₂, X₃, Y₃. Those errors are represented as black triangles pointing upward and exponentially decreasing with the mean photon number |α|².

In this figure, one verifies the exponential suppression of bitflips which is known to be hard in numerical simulations up to 16 photons, which correspond to a total bitflip error probability of 10⁻¹⁶.

Referring to FIG. 10, the case in which the open quantum system comprises a single quantum entity is now considered. This case allows both to understand the mechanisms of the previous formulas and to highlight that it is possible to push the approximation of the function F to an arbitrary order to simulate an open quantum system including a single quantum entity.

In the following equations and demonstrations, the notation q, which previously allowed to indicate the quantum entities of the open quantum system, are absent since only one quantum entity is present.

We are looking for a time-discrete expression of the density operator ρ satisfying the following equation:

$$\\ {ρ}_{k + 1} = {K}_{0} ( {ρ}_{k} ) + {K}_{1} ( {ρ}_{k} )$$

To do this, a solution in the following asymptotic form is sought:

$$\\ {ρ}_{k} = {\sum }_{d = 1}^{{d}_{0}} {x}_{d , k} ( {\sum }_{r = 0}^{Q} {S}_{d}^{{}_{} r} ) with : {X}_{k + 1} = ( {\sum }_{r = 0}^{Q} {F}^{{}_{} r} ) {X}_{k}$$

S_{d}^{r}Σᵣ₌₀^{Q} F^{r} Xₖ₊₁=(x_{1,k}, . . . , x_{d}_{₀}_{,k})^{T} where: —d₀ is the dimension of the decoherence-free space D₀ of the open quantum system,
S_{d}^{r}Σᵣ₌₀^{Q} F^{r} Xₖ₊₁=(x_{1,k}, . . . , x_{d}_{₀}_{,k})^{T}—are Hermitian trace-class operators,
S_{d}^{r}Σᵣ₌₀^{Q} F^{r} Xₖ₊₁=(x_{1,k}, . . . , x_{d}_{₀}_{,k})^{T}—is a Q-order approximation of the matrix F, Q being an integer greater than or equal to two, and
S_{d}^{r}Σᵣ₌₀^{Q} F^{r} Xₖ₊₁=(x_{1,k}, . . . , x_{d}_{₀}_{,k})^{T}—is the coordinate vector of the quantum entity in the decoherence-free space.

The r-order parts F^{r} as well as the Hermitian trace-class operators are determined by a recurrence process on r, recalling that the zero-order part F⁰ is already known and corresponds to the identity matrix and that the Hermitian trace-class operators S_{d}⁰ are also known since they form the orthonormal Hermitian basis of the decoherence-free space D₀.

More specifically, the recurrence process is implemented by identifying terms of the same order in an invariance equation characterizing the slow dynamics close to D₀ induced by the perturbation portion K₁.

$$\\ {ρ}_{k + 1} = {\sum }_{d = 1}^{{d}_{0}} {x}_{d , k + 1} ( {\sum }_{r = 0}^{Q} {S}_{d}^{{}_{} r} )$$

$$\\ {x}_{d , k + 1} = {\sum }_{{d}^{{}_{} ′} = 1}^{{d}_{0}} ( {\sum }_{r = 0}^{Q} {F}_{d , d ′}^{{}_{} r} ) {x}_{{d}^{{}_{} ′} , k}$$

Thus:

$$\\ {ρ}_{k + 1} = {\sum }_{d = 1}^{{d}_{0}} {\sum }_{{d}^{{}_{} ′} = 1}^{{d}_{0}} ( {\sum }_{r = 0}^{Q} {F}_{d , d ′}^{{}_{} r} ) {x}_{{d}^{{}_{} ′} , k} ( {\sum }_{r = 0}^{Q} {S}_{d}^{{}_{} r} )$$

$$\\ {ρ}_{k + 1} = {\sum }_{d = 1}^{{d}_{0}} {\sum }_{{d}^{{}_{} ′} = 1}^{{d}_{0}} ( ( {F}_{{d}^{{}_{} ′} , d}^{{}_{} 0} + {F}_{{d}^{{}_{} ′} , d}^{{}_{} 1} + … + {F}_{{d}^{{}_{} ′} , d}^{{}_{} Q} ) {x}_{{d}^{{}_{} ′} , k} ( {S}_{d}^{{}_{} 0} + {S}_{d}^{{}_{} 1} + … + {S}_{d}^{{}_{} Q} )$$

The k+1-th time value ρₖ₊₁ of the time-discrete density operator can also be written as follows:

$$\\ {ρ}_{k + 1} = ( {K}_{0} + {K}_{1} ) ( {ρ}_{k} )$$

Thus:

$$\\ {ρ}_{k + 1} = ( {K}_{0} + {K}_{1} ) ( {\sum }_{d = 1}^{{d}_{0}} {x}_{d , k} ( {\sum }_{r = 0}^{Q} {S}_{d}^{{}_{} r} )$$

$$\\ {ρ}_{k + 1} = ( {K}_{0} + {K}_{1} ) ( {\sum }_{d = 1}^{{d}_{0}} {x}_{d , k} ( {S}_{d}^{{}_{} 0} + {S}_{d}^{{}_{} 1} + … + {S}_{d}^{{}_{} Q} ) )$$

Since the variable x_{d,k} are arbitrary, it follows that:

$$\\ {\sum }_{{d}^{{}_{} ′} = 1}^{{d}_{0}} ( ( {F}_{{d}^{{}_{} ′} , d}^{{}_{} 0} + {F}_{{d}^{{}_{} ′} , d}^{{}_{} 1} + … + {F}_{{d}^{{}_{} ′} , d}^{{}_{} Q} ) ( {S}_{d}^{{}_{} 0} + {S}_{d}^{{}_{} 1} + … + {S}_{d}^{{}_{} Q} ) = ( {K}_{0} + {K}_{1} ) ( {S}_{d}^{{}_{} 0} + {S}_{d}^{{}_{} 1} + … + {S}_{d}^{{}_{} Q} )$$

The 0-order equations are satisfied since: K₀(S_{d}⁰)=S_{d}⁰ and F_{d′,d}⁰=δ_{d′,d}

The r-order equations are:

$$\\ {\sum }_{s = 0}^{r} {\sum }_{{d}^{{}_{} ′} = 1}^{{d}_{0}} {F}_{{d}^{{}_{} ′} , d}^{{}_{} s} {}_{} {S}_{{d}^{{}_{} ′}}^{{}_{} r - s} = {K}_{0} ( {S}_{d}^{{}_{} r} ) + {K}_{1} ( {S}_{d}^{{}_{} r - 1} )$$

We then apply the invariant operator J_{d″} and the trace:

$$\\ {\sum }_{s = 0}^{r} {\sum }_{{d}^{{}_{} ′} = 1}^{{d}_{0}} {F}_{{d}^{{}_{} ′} , d}^{{}_{} s} Tr ( {J}_{{d}^{{}_{} ″}} {S}_{{d}^{{}_{} ′}}^{{}_{} r - s} ) = Tr ( {J}_{{d}^{{}_{} ″}} {K}_{0} ( {S}_{d}^{{}_{} r} ) ) + Tr ( {J}_{{d}^{{}_{} ″}} {K}_{1} ( {S}_{d}^{{}_{} r - 1} ) )$$

Thus, by bringing out the sums for s=0 and s=r:

$$\\ {\sum }_{{d}^{{}_{} ′} = 1}^{{d}_{0}} {F}_{{d}^{{}_{} ′} , d}^{{}_{} 0} Tr ( {J}_{{d}^{{}_{} ″}} {S}_{{d}^{{}_{} ′}}^{{}_{} r} ) + {\sum }_{{d}^{{}_{} ′} = 1}^{{d}_{0}} {F}_{{d}^{{}_{} ′} , d}^{{}_{} r} Tr ( {J}_{{d}^{{}_{} ″}} {S}_{{d}^{{}_{} ′}}^{{}_{} 0} ) + {\sum }_{s = 1}^{r - 1} {\sum }_{{d}^{{}_{} ′} = 1}^{{d}_{0}} {F}_{{d}^{{}_{} ′} , d}^{{}_{} s} Tr ( {J}_{{d}^{{}_{} ″}} {S}_{{d}^{{}_{} ′}}^{{}_{} r - s} ) = Tr ( {J}_{{d}^{{}_{} ″}} {K}_{0} ( {S}_{d}^{{}_{} r} ) ) + Tr ( {J}_{{d}^{{}_{} ″}} {K}_{1} ( {S}_{d}^{{}_{} r - 1} ) )$$

We have: F_{d′,d}⁰=δ_{d′,d} and Tr(J_{d″}S_{d′}⁰)=δ_{d″,d′}.

### Thus:

$$\\ {\sum }_{{d}^{{}_{} ′} = 1}^{{d}_{0}} {F}_{{d}^{{}_{} ′} , d}^{{}_{} 0} Tr ( {J}_{{d}^{{}_{} ″}} {S}_{{d}^{{}_{} ′}}^{{}_{} r} ) + {\sum }_{{d}^{{}_{} ′} = 1}^{{d}_{0}} {F}_{{d}^{{}_{} ′} , d}^{{}_{} r} Tr ( {J}_{{d}^{{}_{} ″}} {S}_{{d}^{{}_{} ′}}^{{}_{} 0} ) = Tr ( {J}_{{d}^{{}_{} ″}} {S}_{d}^{{}_{} r} ) + {F}_{{d}^{{}_{} ″} , d}^{{}_{} r}$$

### In Addition:

Tr(J_{d″}K₀(S_{d}^{r}))=Tr(J_{d″}S_{d}^{r})

### Thus:

$$\\ {F}_{{d}^{{}_{} ″} , d}^{{}_{} r} + {\sum }_{s = 1}^{r - 1} {\sum }_{{d}^{{}_{} ′} = 1}^{{d}_{0}} {F}_{{d}^{{}_{} ′} , d}^{{}_{} s} Tr ( {J}_{{d}^{{}_{} ″}} {S}_{{d}^{{}_{} ′}}^{{}_{} r - s} ) = Tr ( {J}_{{d}^{{}_{} ″}} {K}_{1} ( {S}_{d}^{{}_{} r - 1} ) )$$

Consequently, each Hermitian trace-class operator S_{d}^{r} is the solution of the following equation with unknown Hermitian operator S:

$$\\ S = {K}_{0} ( S ) + {W}_{d}^{{}_{} r} with : {W}_{d}^{{}_{} r} = {K}_{1} ( {S}_{d}^{{}_{} r - 1} ) - {\sum }_{s = 1}^{r} {\sum }_{{d}^{{}_{} ′} = 1}^{{d}_{0}} {F}_{{d}^{{}_{} ′} , d}^{{}_{} s} {S}_{d ′}^{{}_{} r - s}$$

Here, W_{d}^{r} is orthogonal to the kernel of K₀^{*}−I spanned by {J_{d}, d∈ [symbol] 1,d₀ [symbol] } and thus belongs to the range of K₀−I. Here I stands for the identity map: I(S)≡S. A particular solution S_{d}^{r} is given by the following limit:

$$\\ {S}_{d}^{{}_{} r} = {lim}_{i \to + ∞} {[ {K}_{0} + {W}_{d}^{{}_{} r} ]}^{i} ( 0 )$$

All other solutions S differ from S_{d}^{r} via operators in the decoherence-free space Do. Moreover, S_{d}^{r} is the unique solution satisfying Tr(J_{d′}S_{d}^{r})=0 for all d′. As a consequence:

F_{d′,d}^{r}=Tr(J_{d′}K₁(S_{d}^{r-1}))

In view of the foregoing, the simulation method previously described with reference to FIG. 2 can be improved in the case of an open quantum system including a single quantum entity. Specifically, the operation 250 can be extended to a desired Q order to obtain a more accurate matrix F and thus a more accurate propagator P as well. In FIG. 10, the recurrence process starts at order r and the matrix F is initialized with the zero-order part since F⁰ corresponds to the identity matrix I. Moreover, the device 1 can further receive a desired Q order for the approximation of the matrix F.

In an operation 300, the processor 5 calculates the coefficients F_{d′,d}^{r} for each couple (d′, d)∈ [symbol] 1, d₀ [symbol] ² based on the preceding formula. The r-order part F^{r} of the matrix F is then determined and the matrix F can be updated.

In an operation 310, the processor 5 calculates W_{d}^{r}.

In an operation 320, the processor 5 calculates the Hermitian trace-class operator S_{d}^{r}.

In an operation 330, The processor 5 determines if the Q order has been reached, i.e. whether the Q-order part of the matrix F has already been determined. If not, the value of r is incremented in an operation 340 and the previous operations 300, 310 and 320 are implemented again for the next order. If the order Q has been reached, the process of FIG. 10 stops and the matrix F is outputted.

The previous reasoning can be applied in the case of an open quantum system comprising a plurality of quantum entities and allows to demonstrate the formulas of operation 250 to compute the zero-order part F⁰ and the first-order part F¹ of the matrix F.

Proof elements are provided hereinafter. To avoid cumbersome notations, we simply consider here the case of an open quantum system including two quantum entities A and B.

For the first-order part F¹, i.e. r=1, the formula F_{d′,d}^{r}=Tr(J_{d′}K₁(S_{d}^{r-1})) provides:

$$\\ {F}_{( {d}_{A}^{{}_{} ′} , {d}_{B}^{{}_{} ′} ) , ( {d}_{A} , {d}_{B} )}^{{}_{} 1} = Tr ( {J}_{{d}_{A}^{{}_{} ′}} ⊗ {J}_{{d}_{B}^{{}_{} ′}} {K}_{1} ( {S}_{A , {d}_{A}}^{{}_{} 0} ⊗ {S}_{B , {d}_{B}}^{{}_{} 0} ) )$$

Thus:

$$\\ {F}_{( {d}_{A}^{{}_{} ′} , {d}_{B}^{{}_{} ′} ) , ( {d}_{A} , {d}_{B} )}^{{}_{} 1} = {\sum }_{μ} Tr ( {R}_{A , μ}^{{}_{} 1} {}_{} {J}_{{d}_{A}^{{}_{} ′}} {L}_{A , μ}^{{}_{} 1} {}_{} {S}_{A , {d}_{A}}^{{}_{} 0} ) Tr ( {R}_{B , μ}^{{}_{} 1} {}_{} {J}_{{d}_{B}^{{}_{} ′}} {L}_{B , μ}^{{}_{} 1} {}_{} {S}_{B , {d}_{B}}^{{}_{} 0} )$$

$$\\ {F}_{( {d}_{A}^{{}_{} ′} , {d}_{B}^{{}_{} ′} ) , ( {d}_{A} , {d}_{B} )}^{{}_{} 1} = Tr ( {K}_{1}^{{}_{} *} ( {J}_{{d}_{A}^{{}_{} ′}} ⊗ {J}_{{d}_{B}^{{}_{} ′}} ) {S}_{A , {d}_{A}}^{{}_{} 0} ⊗ {S}_{B , {d}_{B}}^{{}_{} 0} )$$

We can denote:

J_{μ,A,d}_{_{A}}_{′}¹=R_{A,μ}¹J_{d}_{_{A}}_{′}L_{A,μ}¹

J_{μ,B,d}_{_{B}}_{′}¹=R_{B,μ}¹J_{d}_{_{B}}_{′}L_{B,μ}¹

### Consequently:

$${K}_{1}^{*} ( {J}_{{d}_{A}^{′}} ⊗ {J}_{{d}_{B}^{′}} ) = {\sum }_{μ} {J}_{μ , A , {d}_{A}^{′}}^{1} ⊗ {J}_{μ , B , {d}_{B}^{′}}^{1}$$

### Thus:

$${F}_{( {d}_{A}^{′} , {d}_{B}^{′} ) , ( {d}_{A} , {d}_{B} )}^{1} = {\sum }_{μ} Tr ( {J}_{μ , A , {d}_{A}^{′}}^{1} {S}_{A , {d}_{A}}^{0} ) Tr ( {J}_{μ , B , {d}_{B}^{′}}^{1} , {S}_{B , {d}_{B}}^{0} ) \\ {F}_{( {d}_{A}^{′} , {d}_{B}^{′} ) , ( {d}_{A} , {d}_{B} )}^{1} = {\sum }_{μ} {F}_{μ , A , ( {d}_{A}^{′} , {d}_{A} )}^{1} {F}_{μ , B , ( {d}_{B}^{′} , {d}_{B} )}^{1} \\ with : {F}_{μ , A , ( {d}_{A}^{′} , {d}_{A} )}^{1} = Tr ( {J}_{μ , A , {d}_{A}^{′}}^{1} , {S}_{A , {d}_{A}}^{0} ) and {F}_{μ , B , ( {d}_{B}^{′} , {d}_{B} )}^{1} = Tr ( {J}_{μ , B , {d}_{B}^{′}}^{1} , {S}_{B , {d}_{B}}^{0} )$$

For the second-order part F², i.e. r=2, the formula F_{d′,d}^{r}=Tr(J_{d′}K₁(S_{d}^{r-1}) provides:

$${F}_{( {d}_{A}^{′} , {d}_{B}^{′} ) , ( {d}_{A} , {d}_{B} )}^{2} = Tr ( {J}_{{d}_{A}^{′}} ⊗ {J}_{{d}_{B}^{′}} {K}_{1} ( {S}_{( {d}_{A} , {d}_{B} )}^{1} ) )$$

where: S_{(d}_{_{A}}_{,d}_{_{B}}₎¹ is the solution of the equivalent of the above-mentioned equation S=K₀(S)+W_{d}^{r} and is in general an infinite converging sum of tensor products:

$${S}_{( {d}_{A} , {d}_{B} )}^{1} = {\sum }_{i = 0}^{+ ∞} {[ {K}_{0} ]}^{i} ( {W}_{( {d}_{A} , {d}_{B} )}^{1} )$$

where: W_{(d}_{_{A}}_{,d}_{_{B}}₎¹=K₁(S_{A,d}_{_{A}}⁰⊗S_{B,d}_{_{B}}⁰)−Σ_{d′}_{_{A}}_{,d′}_{_{B}} F_{(d′}_{_{A}}_{,d′}_{_{B}}_{),(d}_{_{A}}_{,d}_{_{B}}₎¹ S_{A,d}_{_{A}}⁰⊗S_{B,d}_{_{B}}⁰ is a finite sum of tensor products:

$${W}_{( {d}_{A} , {d}_{B} )}^{1} = {\sum }_{μ} {L}_{A , μ}^{1} {S}_{A , {d}_{A}}^{0} {R}_{A , μ}^{1} ⊗ {L}_{B , μ}^{1} {S}_{B , {d}_{B}}^{0} {R}_{B , μ}^{1} - {\sum }_{{d}_{A}^{′} , {d}_{B}^{′}} {F}_{( {d}_{A}^{′} , {d}_{B}^{′} ) , ( {d}_{A} , {d}_{B} )}^{1} {S}_{A , {d}_{A}^{′}}^{0} ⊗ {S}_{B , {d}_{B}^{′}}^{0}$$

Since Tr(J_{A,d}_{_{A}}⊗J_{B,d}_{_{B}}W_{(d}_{_{A}}_{,d}_{_{B}}₎¹)=0 for any invariant J_{A,d}_{_{A}}⊗J_{B,d}_{_{B}}, the iterates [K₀]ⁱ(W_{(d}_{_{A}}_{,d}_{_{B}}₎¹) converges exponentially to 0. The above series of operators is absolutely convergent and we have:

$${F}_{( {d}_{A}^{′} , {d}_{B}^{′} ) , ( {d}_{A} , {d}_{B} )}^{2} = {\sum }_{i = 0}^{+ ∞} Tr ( ( {{K}_{1}^{*} ( {J}_{A , {d}_{A}^{′}} ⊗ {J}_{B , {d}_{B}^{′}} ) [ {K}_{0} ]}^{i} ( {W}_{( {d}_{A} , {d}_{B} )}^{1} ) ) )$$

We can denote:

$${S}_{μ , A , {d}_{A}}^{1} = {L}_{A , μ}^{1} {S}_{A , {d}_{A}}^{0} {R}_{A , μ}^{1} \\ {S}_{μ , A , {d}_{A}}^{1 , 0} = {\sum }_{{d}_{A}^{′}} {F}_{μ , A , ( {d}_{A}^{′} , {d}_{A} )}^{1} {S}_{A , {d}_{A}^{′}}^{0} \\ {S}_{μ , B , {d}_{B}}^{1} = {L}_{B , μ}^{1} {S}_{B , {d}_{B}}^{0} {R}_{B , μ}^{1} \\ {S}_{μ , B , {d}_{B}}^{1 , 0} = {\sum }_{{d}_{B}^{′}} {F}_{μ , B , ( {d}_{B}^{′} , {d}_{B} )}^{1} {S}_{B , {d}_{B}^{′}}^{0}$$

Thus, one gets:

$${W}_{( {d}_{A} , {d}_{B} )}^{1} = {\sum }_{μ} {S}_{μ , A , {d}_{A}}^{1} ⊗ {S}_{μ , B , {d}_{B}}^{1} - {S}_{μ , A , {d}_{A}}^{1 , 0} ⊗ {S}_{μ , B , {d}_{B}}^{1 , 0}$$

Finally, some computations give then:

$${F}_{( {d}_{A}^{′} , {d}_{B}^{′} ) , ( {d}_{A} , {d}_{B} )}^{2} = {\sum }_{i = 0}^{+ ∞} ( {\sum }_{μ , {μ}^{′}} Tr ( {{J}_{{μ}^{′} , A , {d}_{A}^{′}}^{1} [ {K}_{0 , A} ]}^{i} ( {S}_{μ , A , {d}_{A}}^{1} ) ) Tr ( {{J}_{{μ}^{′} , B , {d}_{B}^{′}}^{1} [ {K}_{0 , B} ]}^{i} ( {S}_{μ , B , {d}_{B}}^{1} ) ) - ( {\sum }_{{d}_{A}^{″}} {F}_{{μ}^{′} , A , {d}_{A}^{′} , {d}_{A}^{″}}^{1} {F}_{μ , A , {d}_{A}^{″} , {d}_{A}}^{1} ) ( {\sum }_{{d}_{B}^{″}} {F}_{{μ}^{′} , B , {d}_{B}^{′} , {d}_{B}^{″}}^{1} {F}_{μ , B , {d}_{B}^{″} , {d}_{B}}^{1} ) )$$

Just as it is possible, as previously discussed, to simulate a quantum logic gate for two or more qubits, it is also possible to simulate a quantum logic gate for a single qubit, for instance a Z-gate.

As previously mentioned, the Z-gate is one of the Pauli gates and corresponds to a rotation by TT radians around the Z axis of the Bloch sphere. The Z-gate leaves the basis state |0 [symbol] unchanged and converts the basis state |1 [symbol] to −|1 [symbol] . The Z-gate is usually represented by the following square matrix Z:

$$Z = [ \begin{matrix}1 & 0 \\ 0 & - 1\end{matrix} ]$$

As previously explained, a rotation about the Z axis of a cat-qubit can be written as:

$$Z ( θ ) = {e}^{- i \frac{θ}{2} {Z}_{α}} = cos \frac{θ}{2} {I}_{α} - i sin \frac{θ}{2} {Z}_{α}$$

In addition, in the context of the Z-gate, the rotation of an angle θ is obtained by applying the weak drive during a time:

$$T = \frac{θ}{4 {αϵ}_{Z}}$$

The χ matrix of the Z-gate are obtained by applying the propagator on a set of 4 initial density matrices {ρᵢ}_{1≤i≤4}. The processor 5 thus computes their final states {ρ_{f,i}}_{1≤i≤4} and builds the χ matrix from them according to the following formula:

$$ε ( ρ ) = {\sum }_{m , n} {χ}_{m , n} {S}_{m} ρ {S}_{n}$$

where: the operators Sₘ denote the Pauli matrices {I, X, Y, Z} which form a basis of the two-level qubit density matrices.

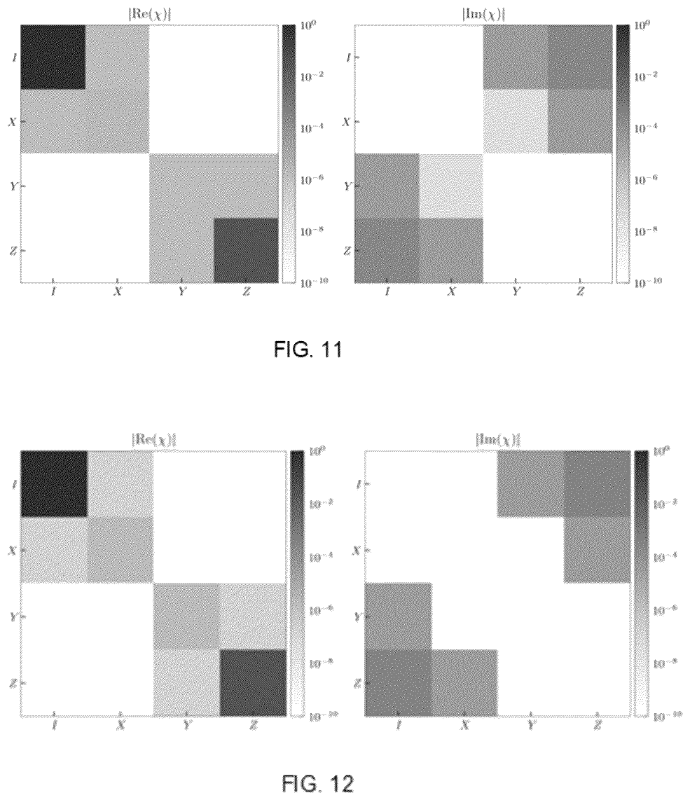

FIG. 11 shows on the left the modulus of the real part of the χ matrix and shows on the right the modulus of the imaginary part of the χ matrix obtained after simulating the {ρᵢ} using the Schrödinger picture for |α|²=4, a one-photon loss amplitude of κ₁=10⁻³, a Hamiltonian amplitude of ε_{Z}=5×10⁻² and a truncature of 100, which means that the first 100 Fock states are used in the simulation per cat-qubit to described the infinite-dimensional Hilbert space, as described above.

FIG. 12 shows on the left the modulus of the real part of the χ matrix and shows on the right the modulus of the imaginary part of the χ matrix obtained after simulating the {ρᵢ} using the proposed simulation method in the Heisenberg picture, for the same parameters |α|²=4, a one-photon loss amplitude of κ₁=10⁻³ and a Hamiltonian amplitude of ε_{Z}=5×10⁻², but a truncature of 100 per cat-qubit.

The comparison of the both figures shows that the proposed simulation method succeeds in computing correctly the final states of density matrices for this set of experimental parameters.

To make the comparison more thorough, the same comparison is carried out for a mean photon number |α|² ranging from 1 to 8 and the particular coefficients of the χ matrix are displayed.

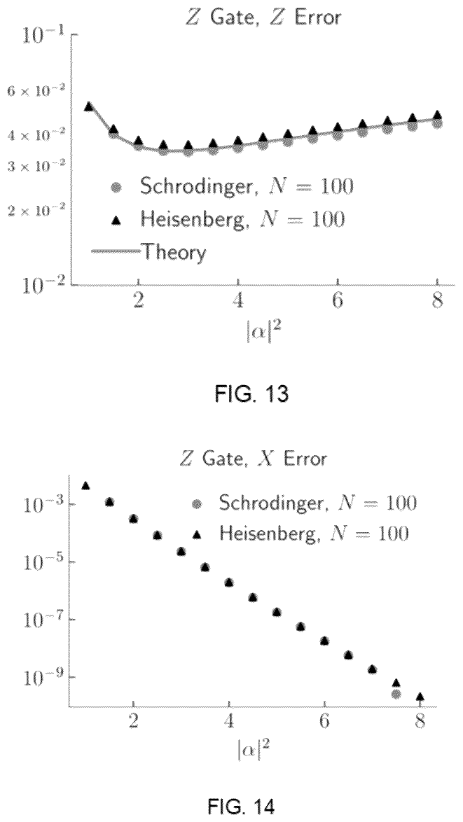

FIG. 13 shows the evolution of the coefficient χ_{(Z,Z)} represented by black triangles pointing upward with the mean photon number |α|² using the proposed simulation method.

The same coefficients computed with the Schrödinger picture are show as grey circles below the black triangles.

The analytical formula for the Z errors obtained via second-order adiabatic elimination are shown as a grey line.

$${p}_{Z} = \frac{{ϵ}_{Z}^{2} T}{{\vert α \vert}^{2} {κ}_{2}} + {\vert α \vert}^{2} {κ}_{1} T$$

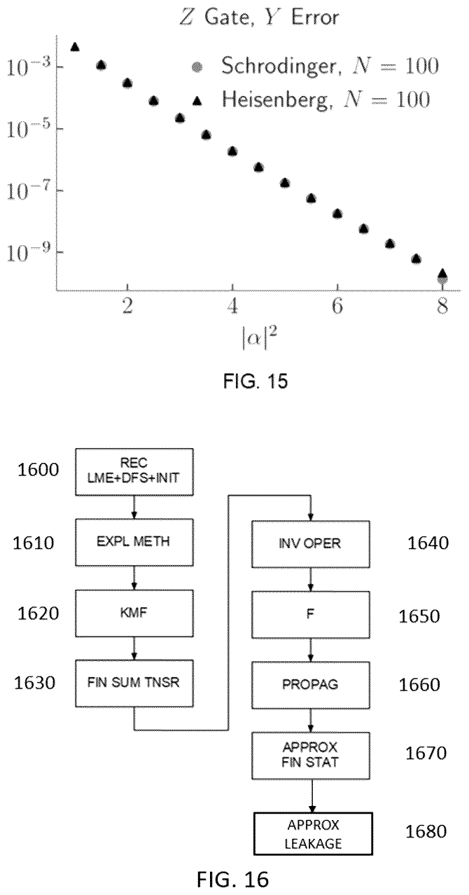

FIG. 14 and FIG. 15 show respectively the evolution of the coefficient χ_{(X,X)} responsible of X errors and the evolution of the coefficient χ_{(Y,Y)} responsible of Y errors. Those errors are represented as black triangles pointing upward and exponentially decreasing with the mean photon number |α|². The same coefficients computed with the Schrödinger picture are show as grey circles below the black triangles.

In this figure, one verifies the exponential suppression of bitflips which is known to be hard in numerical simulations.

Hybrid Schrödinger-Heisenberg Formulation for Composite Open Quantum System Including at least one non-stabilized quantum entity

The inventors have recognized that the above method extends to simulating an open quantum system including one or more first quantum entities and one or more second quantum entities, wherein the first entities are stabilized (i.e. entities stabilized by two-photon dissipation as per cat qubits) and wherein the second quantum entities are entities which have an unstabilized component at least over the time period over which the system evolves. That is, for a period of time, the one or more second quantum entities each has no stabilization dynamics applied thereto, e.g. no two-photon dissipation applied to the system for hosting cat qubits. Thus, no decoherence-free space can be defined for the second quantum entity during the time frame over which the unstabilized component is applied to the second quantum entity.

In the following, for simplicity we initially consider only a bipartite system made of subsystems A and B with Hilbert spaces H_{A} and H_{B} such that the full Hilbert space of the open quantum system is H=H_{A}⊗H_{B}. As will be appreciated, the following can be readily expanded to larger systems than the described bipartite system. The nominal dynamics thus admit:

[symbol]

₀(ρ)= [symbol] _{0,A}(ρ)+ [symbol] _{0,B}(ρ).

The first entity A has a nominally stabilized subspace whereas the second entity B has an unstabilized component applied thereto during the evolution of the system. Said another way, the second quantum entity B does not have a subspace which is actively stabilized over the time frame of interest (i.e. the time frame to be simulated), and as such [symbol] _{0,B}(ρ)=0. Then, S_{B,d}_{_{B}}⁰ spans all Hermitian operators on H_{B} and the invariant operators J_{B,d}_{ₚ}=S_{B,d}_{_{B}}⁰ during the time frame that the unstabilized component is applied to the second entity B. During this time frame, all operators belonging to the decoherence-free space D_{0,A} of the nominally stabilized first quantum entity A read Σ_{d}_{_{A}} S_{A,d}_{_{A}}⁰⊗ρ_{B,d}_{_{A}}, where S_{A,d}_{_{A}}⁰ still forms an orthonormal basis of the steady-state sub-space of [symbol] _{0,A}. Here, ρ_{B,d}_{_{A}} denotes the Hermitian operators on H_{B}, ρ_{B,d}_{_{A}}=Σ_{d}_{_{B}} X_{d}_{_{A}}_{,d}_{_{B}}S_{B,d}_{_{B}}⁰ and x_{d}_{_{A}}_{,d}_{_{B}}=Tr(S_{B,d}_{_{B}}⁰ρ_{B,d}_{_{A}}) real numbers.

We look for the dynamics at first and second orders of ρ_{B,d}_{_{A}}=Σ_{d}_{_{B}}x_{d}_{_{A}}_{,d}_{_{B}}S_{B,d}_{_{B}}⁰ according to:

$$\frac{d}{dt} {ρ}_{B , {d}_{A}} = \frac{1}{Δ t} {\sum }_{{d}_{B}} {\sum }_{{d}_{A}^{′} , {d}_{B}^{′}} ( {F}_{( {d}_{A} , {d}_{B} ) ( {d}_{A}^{′} , {d}_{B}^{′} )}^{1} + {F}_{( {d}_{A} , {d}_{B} ) , ( {d}_{A}^{′} , {d}_{B}^{′} )}^{2} ) {x}_{{d}_{A}^{′} , {d}_{B}^{′}} {S}_{B , {d}_{B}}^{0}$$

where Δt is the time-step used in the explicit method (which can be chosen to be constant in time i.e. from one iteration to the next, or to vary from one iteration to the next). The 1/Δt pre-factor has been introduced to account for transitioning from continuous-time description to discrete-time.

The first order time evolution of the coordinate vector

$$X = {( {x}_{{d}_{A}^{′} , {d}_{B}^{′}} )}_{{d}_{A}^{′} , {d}_{B}^{′}}$$

described by

$$\frac{d}{dt} {x}_{{d}_{A}^{′} , {d}_{B}^{′}} = \frac{1}{Δ t} {\sum }_{{d}_{A} , {d}_{B}} {F}_{( {d}_{A}^{′} , {d}_{B}^{′} ) , ( {d}_{A} , {d}_{B} )}^{1} {x}_{{d}_{A} , {d}_{B}}$$

using the coefficients of the first-order part F¹ as described above gives

$$\frac{d}{dt} {x}_{{d}_{A}^{′} , {d}_{B}^{′}} = \frac{1}{Δ t} {\sum }_{μ , {d}_{A} , {d}_{B}} Tr ( {J}_{A , {d}_{A}^{′}} {L}_{A , μ}^{1} {S}_{A , {d}_{A}}^{0} {R}_{A , μ}^{1} ) Tr ( {S}_{B , {d}_{B}^{′}} {L}_{B , μ}^{1} {S}_{B , {d}_{B}}^{0} {R}_{B , μ}^{1} ) {x}_{{d}_{A} , {d}_{B}}$$

where the various terms take the same meanings as descried above for the first aspect, and μ corresponds to number of perturbations. By using ρ_{B,d}_{_{A}}=Σ_{d}_{_{B}}x_{d}_{_{A}}_{,d}_{_{B}}S_{B,d}_{_{b}}⁰, we get

$$\frac{d}{dt} {ρ}_{B , {d}_{A}^{′}} = \frac{1}{Δ t} {\sum }_{μ , {d}_{A}} Tr ( {J}_{A , {d}_{A}^{′}} {L}_{A , μ}^{1} {S}_{A , {d}_{A}}^{0} {R}_{A , μ}^{1} ) {L}_{B , μ}^{1} {ρ}_{B , {d}_{A}} {R}_{B , μ}^{1}$$

where the subscript d_{A}′ means that it corresponds to a state on the decoherence subspace of the stabilized quantum entity A.

Recalling from above that the first-order expansion of the matrix F is generally F_{(d}_{₁}_{′, . . . , d}_{ₙ}_{′),(d}_{₁}_{, . . . , d}_{ₙ})=Σ_{μ}Π_{q=1}ⁿ Tr(J_{μ,q,d}_{_{q}}_{′}¹S_{q,d}_{_{q}}⁰), the coefficient for single subsystem A is F_{d}_{_{A}}_{′,d}_{_{A}}¹=Σ_{μ}Tr(J_{A,d}_{_{A}}_{′}L_{A,μ}¹S_{A,d}_{_{A}}⁰R_{A,μ}¹), then the first-order approximation of the asymptotic expansion is

$$\frac{d}{dt} {ρ}_{B , {d}_{A}^{′}} = {\sum }_{μ , {d}_{A}} {\overline{F}}_{{d}_{A}^{′} , {d}_{A} , μ}^{1} {L}_{B , μ}^{1} {ρ}_{B , {d}_{A}} {R}_{B , μ}^{1} \\ with \\ {\overline{F}}_{{d}_{A}^{′} , {d}_{A} , μ}^{1} = ( \frac{1}{Δ t} ) Tr ( {J}_{A , {d}_{A}^{′}} {L}_{A , μ}^{1} {S}_{A , {d}_{A}}^{0} {R}_{A , μ}^{1} ) .$$

In a similar manner, the second order approximation of the asymptotic expansion is given by

$$\frac{d}{dt} {ρ}_{B , {d}_{A}^{′}} = {\sum }_{{d}_{B}^{′}} {\sum }_{{d}_{A} , {d}_{B} , μ , {μ}^{′}} {\overline{F}}_{{d}_{A}^{′} , {d}_{A} , μ , {μ}^{′}}^{2} Tr ( {S}_{B , {d}_{B}^{′}} {L}_{B , {μ}^{′}} {L}_{B , μ} {S}_{B , {d}_{B}}^{0} {R}_{B , μ} {R}_{B , {μ}^{′}} ) {x}_{{d}_{A} , {d}_{B}} {S}_{B , {d}_{B}^{′}}^{0}$$

Using Σ_{d}_{_{N}}_{′}Tr(S_{B,d}_{_{B}}_{′}⁰L_{B,μ′}L_{B,μ}S_{B,d}_{_{B}}⁰R_{B,μ}R_{B,μ′}) S_{B,d}_{_{B}}_{′}⁰=L_{B,μ′}L_{B,μ}S_{B,d}_{_{B}}⁰R_{B,μ}R_{B,μ′} and recalling ρ_{B,d}_{_{A}}=Σ_{d}_{_{B}} x_{d}_{_{A}}_{,d}_{_{B}}S_{B,d}_{_{B}}⁰, then the second-order approximation of the asymptotic expansion is now

$$\frac{d}{dt} {ρ}_{B , {d}_{A}^{′}} = {\sum }_{{d}_{A} , μ , {μ}^{′}} {\overline{F}}_{{d}_{A}^{′} , {d}_{A} , μ , {μ}^{′}}^{2} {L}_{B , {μ}^{′}} {L}_{B , μ} {ρ}_{B , {d}_{A}} {R}_{B , μ} {R}_{B , {μ}^{′}} \\ where \\ {\overline{F}}_{{d}_{A}^{′} , {d}_{A} , μ , {μ}^{′}}^{2} = ( \frac{1}{Δ t} ) Tr \{ {J}_{A , {d}_{A}^{′} , {μ}^{′}}^{1} {{\sum }_{j = 0}^{∞} [ {K}_{0 , A} ]}^{j} ( {S}_{A , {d}_{A} , μ}^{0} - {\sum }_{{d}_{A}^{″}} Tr ( {J}_{A , {d}_{A}^{″}} {S}_{A , {d}_{A} , μ}^{0} ) {S}_{A , {d}_{A}^{″}}^{0} \} ,$$

where

J_{A,d}_{_{A}}_{′,μ′}¹=R_{A,μ′}¹J_{A,d}_{_{d}}_{′}¹L_{A,μ′}¹ and S_{A,d}_{_{A,μ}}⁰=L_{A,μ}¹S_{A,d}_{_{A}}⁰R_{A,d}_{_{A}}¹, and comes from the second-order coefficient from the expansion of the matrix F for single subsystem A as described above. The sum over index j is in practice truncated at a finite number such that the difference between two successive iterations (i.e. difference between the penultimate and final summed terms) is smaller than a chosen threshold. For instance, the threshold may be on the order of machine precision of the conventional computer performing the simulation, e.g., such as between 10⁻⁸ and 10⁻¹⁶. For instance, the threshold may be 10⁻¹².

Accordingly, taking the above together, the second-order equation on the dynamics of ρ_{B,d}_{_{A}}_{′} is thus

$$\frac{d}{dt} {ρ}_{B , {d}_{A}^{′}} = {\sum }_{μ , {d}_{A}} {\overline{F}}_{{d}_{A}^{′} , {d}_{A} , μ}^{1} {L}_{B , μ}^{1} {ρ}_{B , {d}_{A}} {R}_{B , μ}^{1} + {\sum }_{{d}_{A} , μ , {μ}^{′}} {\overline{F}}_{{d}_{A}^{′} , {d}_{A} , μ , {μ}^{′}}^{2} {L}_{B , μ}^{1} , \\ {L}_{B , μ}^{1} {ρ}_{B , {d}_{A}} {R}_{B , μ}^{1} {R}_{B , {μ}^{′}}^{1}$$

This is therefore a second-order approximation using parametrization based on the d_{0,A} (dimension of the decoherence free space of the first quantum entity) set of Hermitian operators (ρ_{B,d}_{_{A}}_{′}) on H_{B}.

Generally,

$$\frac{d}{dt} {ρ}_{B , {d}_{A}^{′}}$$

can be integrated in time via any appropriate numerical scheme to give the contribution of the d′_{A}-th Hermitian operator of the decoherence free sub-space of the stabilized quantum entity A on the non-stabilized quantum entity B. The full density matrix may then be given by recalling ρ=Σ_{d}_{_{A}} S_{A,d}_{_{A}}⁰ ρ_{B,d}_{_{A}}.

As will be appreciated, the above can be generalized to an open quantum system comprising q stabilized quantum entities generally denoted by A_{q} and p non-stabilized quantum entities generally denoted by Bₚ:

$$\frac{d}{dt} {ρ}_{( {B}_{1} , … , {B}_{p} ) , ( {d}_{{A}_{1}}^{′} , … , {d}_{{A}_{q}}^{′} )} =$$

$${\sum }_{μ , {d}_{{A}_{1}} , … , {d}_{{A}_{q}}} {\prod }_{i = 1}^{q} {\overline{F}}_{{d}_{{A}_{i}}^{′} , {d}_{{A}_{i}} , μ}^{1} [ {⊗}_{j = 1}^{p} {L}_{{B}_{j} , μ}^{1} ] {ρ}_{( {B}_{1} , … , {B}_{p} ) , ( {{d}_{A}}_{1} , … , {d}_{{A}_{q}} )} [ {⊗}_{l = 1}^{p} {R}_{{B}_{l} , μ}^{1} ] +$$

$${\sum }_{{d}_{{A}_{1}} , … , {d}_{{A}_{q}} , μ , {μ}^{′}} {\prod }_{i = 1}^{q} {\overline{F}}_{{d}_{{A}_{i}}^{′} , {d}_{{A}_{i}} , μ , {μ}^{′}}^{2} [ {⊗}_{j = 1}^{p} {L}_{{B}_{j} , {μ}^{′}}^{1} ] [ {⊗}_{l = 1}^{p} {L}_{{B}_{l} , μ}^{1} ]$$

$${ρ}_{( {B}_{1} , … , {B}_{p} ) , ( {d}_{{A}_{1}} , … , {d}_{{A}_{q}} )} [ {⊗}_{j = 1}^{p} {R}_{{B}_{j} , μ}^{1} ] [ {⊗}_{l = 1}^{p} {R}_{{B}_{l} , {μ}^{′}}^{1} ] wherein$$

$${\overline{F}}_{{d}_{{A}_{i}}^{′} , {d}_{{A}_{i}} , μ}^{1} = ( \frac{1}{Δ t} ) Tr ( {J}_{{A}_{i} , {d}_{{A}_{i}}^{′}} {L}_{{A}_{i} , μ}^{1} {S}_{{A}_{i} , {d}_{{A}_{i}}}^{0} {R}_{{A}_{i} , μ}^{1} ) and$$

$${\overline{F}}_{{d}_{{A}_{i}}^{′} , {d}_{{A}_{i}} , μ , {μ}^{′}}^{2} = ( \frac{1}{Δ t} ) Tr \{ {J}_{{A}_{i} , {d}_{{A}_{i}}^{′} , {μ}^{′}}^{1} {{\sum }_{j = 0}^{∞} [ {K}_{0 , {A}_{i}} ]}^{j} ( {S}_{{A}_{i} , {dA}_{i} , μ}^{0} -$$

$${\sum }_{{d}_{{A}_{i}}^{″}} Tr ( {J}_{{A}_{i} , {d}_{{A}_{i}}^{″}} {S}_{{A}_{i} , {d}_{{A}_{i}} , μ}^{0} ) {S}_{{A}_{i} , {d}_{{A}_{i}}^{″}}^{0} \} , where$$

$${J}_{{A}_{i} , {d}_{{A}_{i}}^{′} , {μ}^{′}}^{1} = {R}_{{A}_{i} , {μ}^{′}}^{1} {J}_{{A}_{i} , {d}_{{A}_{i}}^{′}}^{1} {L}_{{A}_{i} , {μ}^{′}}^{1} and {S}_{{A}_{i} , {d}_{{A}_{i}} , μ}^{0} = {L}_{{A}_{i} , μ}^{1} {S}_{{A}_{i} , {d}_{{A}_{i}}}^{0} {R}_{{A}_{i} , {d}_{{A}_{i}}}^{1} .$$

Again, as above, the sum over index j is truncated at a finite number such that the difference between two successive iterations (i.e. difference between the penultimate and final summed terms) is smaller than a chosen threshold. For instance, the threshold may be on the order of machine precision of the conventional computer performing the simulation, e.g., such as between 10⁻⁸ and 10⁻¹⁶. For instance, the threshold may be 10⁻¹².

As above, the index d_{A}_{_{q}} simply indicates the d_{A}_{_{q}}-th Hermitian operator of the orthonormal Hermitian basis of the decoherence-free space D_{0,A}_{_{q}} of the q-th stabilized quantum entity A_{q}. Similarly, the local nominal dynamics is simply a sum of the local nominal dynamics of the stabilized quantum entities [symbol] ₀(ρ)=Σ_{A}_{_{q}} [symbol] _{0,A}_{_{q}}(ρ) (which of course reduces to [symbol] ₀(ρ)= [symbol] _{0,A}(ρ) when there is only a single stabilized quantum entity q=1, A₁≡A). For instance, when there is only a single stabilized quantum entity (q=1) and a single non-stabilized quantum entity (p=1), the above generalized expressions reduce to the above-described bipartite system with A₁≡A and B₁≡B.

As will be appreciated, the device 1 of FIG. 1 may similarly be arranged to perform the simulation of an open quantum system according to the second aspect. That is, according to embodiments of the second aspect, the device 1 is arranged to receive as inputs: a Lindblad master equation defining the dynamics, at time 0<t<T, of the density operator ρ of an open quantum system including one or more first quantum entities to be simulated which are nominally stabilized and one or more second quantum entities to be simulated which are not stabilized, along with the respective decoherence-free spaces D_{0,q} of the nominally stabilized quantum entities; and an initial state ρ(0) of the density operator ρ. The device is arranged to derive an approximated final state of the density operator ρ. More particularly, the device 1 receives the operators of the Lindblad master equation, i.e. the Lindblad operators of the dissipative part and, if applicable, the Hamiltonian part.

The memory 3 is arranged as described above in relation to the first aspect.

The processor 5 is arranged as described above in relation to the first aspect to generate a propagator of the open quantum system dynamics, wherein the propagator is generated as described below.

The functioning of the processor 5 will be described hereinafter with reference to FIG. 16 which represents an embodiment of the simulation method of the open quantum system including a first set of one or more first quantum entities A_{q} each being stabilized around a respective decoherence-free space D_{0,A}_{_{q}} where A_{q} denotes the q-th first quantum entity; and a second set of one or more second quantum entities Bₚ, wherein each second quantum entity has an unstabilized component during a time period T such that a respective decoherence-free space cannot be defined for each second quantum entity during time 0<t<T. Each second quantum entity is described by a full density matrix

$${ρ}_{{B}_{p} , {d}_{{A}_{q}}^{′}}$$

where Bₚ denotes the p-th quantum entity of the second set and

$${ρ}_{{B}_{p} , {d}_{{A}_{q}}^{′}}$$

is the contribution of the d_{A}_{_{q}}′-th Hermitian operator of the decoherence-free space D_{0,A}_{_{q}}_{′} of the q-th stabilized quantum entity A_{q} on the p-th non-stabilized quantum entity Bₚ.

In an operation 1600, the device 1 receives as inputs the Lindblad master equation defining the dynamics, at time 0<t<T, of a density operator ρ of the open quantum system to be simulated including one or more first quantum entities and one or more second quantum entities, wherein said dynamics includes first quantum entity specific local nominal dynamics Σ_{A}_{_{q}} [symbol] _{0,A}_{_{q}}(ρ) where [symbol] _{0,A}_{_{q}} is the local nominal dynamics of the q-th first quantum entity. The device 1 also receives the respective decoherence-free spaces D_{0,A}_{_{q}} of the one or more first quantum entities, an initial state ρ(0) of said density operator ρ, and time period T during which each second quantum entity has an unstabilized component.

The inputs can be stored in the memory 3 of the device 1.

In an operation 1610, the processor 5 applies an explicit method to the Lindblad master equation for generating a discrete-time expression thereof, as in the same manner as described above in relation to the first aspect. Thus, the explicit method may be an explicit Euler scheme. The discrete-time expression of the Lindblad master equation is split into a local nominal dynamics portion of the one or more first quantum entities and a perturbation portion K₁ with an amplitude of said perturbation portion being at least five times smaller than an amplitude of said local nominal dynamics portion.

In an operation 1620, the processor 5 applies a trace-preserving and completely-positive linear Kraus map formulation to the local nominal dynamics portion EM₀. The Kraus map K₀ of the local nominal dynamics portion is derived from the respective Kraus maps K_{0,A}_{_{q}} of the first quantum entity specific local nominal dynamics with K₀=⊗_{A}_{_{q}} K_{0,A}_{_{q}}. K₀ is thus given as described above in relation to the first aspect, wherein the Kraus map K₀ of the local nominal dynamics portion derives from the respective Kraus maps K_{0,A}_{_{q}} of the local nominal dynamics of the q-th quantum entity of the first set A_{q} after applying the explicit method to this local nominal dynamics.

The time-discretization via Kraus map of the Lindblad master equation is written as follows:

$${ρ}_{k + 1} = {K}_{0} ( {ρ}_{k} ) + {K}_{1} ( {ρ}_{k} )$$

where ρₖ is the k-th time value of the time-discrete density operator. As will be appreciated, the notation ρ(k) may be used interchangeably herein to also denote the k-th time value of the time-discrete density operator, and thus may be used for clarity to distinguish over using a plurality of subscripts such as ρ_{B,d}_{_{A}} which instead indicates contributions of density basis states to a particular density matrix for an entity. Thus, the time-discretization via Kraus map of the Lindblad master equation may equally be written as follows: ρ(k+1)=K₀(ρ(k))+K₁(ρ(k)).

In an operation 1630, the processor determines a finite set of pairs of local operators L_{r,μ}¹ and R_{r,μ}¹ for each quantum entity of the first and second sets, each pair of local operators (L_{m,μ}¹, R_{m,μ}¹) being on the corresponding Hilbert space Hₘ where m∈ [symbol] A_{q}, Bₚ [symbol] . In a similar manner as previously explained above, this finite set of pairs of local operators is such that K₁(⊗ₘ Wₘ)=Σ_{μ}⊗ₘ L_{m,μ}¹WₘR_{m,μ}¹ for all local operators Wₘ each on the corresponding Hilbert space Hₘ.

In an operation 1640, the processor 5 calculates the invariant operators of each first quantum entity of the first set:

$${J}_{{A}_{q} , {d}_{{A}_{q}}} = {lim}_{i \to + ∞} {[ {K}_{0 , {A}_{q}}^{*} ]}^{i} ( {S}_{{A}_{q} , {d}_{{A}_{q}}}^{0} ) \\ with : \\ Tr ( {J}_{{d}_{{A}_{q}}} {S}_{{d}_{{A}_{q}}^{′}}^{0} ) = {δ}_{{d}_{{A}_{q}} , {d}_{{A}_{q}}^{′}}$$

where: K_{0,A}_{_{q}}^{*} is the conjugate transpose of the local nominal dynamics portion K_{0,A}_{_{q}} of the q-th first quantum entity of the first set.

For a given first quantum entity of the first set, the processor 5 calculates a number d_{0,A}_{_{q}} of invariant operators.

As described above for the first aspect, the invariant operators of the q-th quantum entity of the first set allow to retrieve the coordinates of any local Hermitian operator ρ_{A}_{_{q}} in the Hermitian orthonormal basis (for the Frobenius product) of the respective decoherence-free subspace

$${D}_{0 , {A}_{q}} \{ {S}_{{A}_{q} , {d}_{{A}_{q}}}^{0} , {d}_{{A}_{q}} ∈ 〚 1 , {d}_{0 , {A}_{q}} 〛 \} via Tr ( {J}_{{d}_{{A}_{q}}^{′}} {ρ}_{{A}_{q}} ) = {\sum }_{{d}_{{A}_{q}} = 1}^{{d}_{0 , {A}_{q}}} {x}_{{d}_{{A}_{q}}} {δ}_{{d}_{{A}_{q}} , {d}_{{A}_{q}}^{′}} = {x}_{{d}_{{A}_{q}}^{′}} .$$

In an operation 1650, the processor 5 determines a second-order approximation using the F coefficients which are calculated as described above for the second aspect. That is, a second-order equation of the time-discrete dynamics of the contributions of the d_{A}_{_{q}}′-th Hermitian operator of the decoherence-free space D_{0,A}_{_{q}}_{′} of the q-th stabilized quantum entity on the p-th second quantum entity ρ_{(B}_{₁}_{, . . . , B}_{ₚ}_{),(d}_{_{A1}}_{′, . . . , d}_{_{Aq}}_{′)} is calculated using the above equations for

$$\frac{d}{dt} {ρ}_{( {B}_{1} , … , {B}_{p} ) , ( {d}_{{A}_{1}}^{′} , … , {d}_{{A}_{q}}^{′} ) ,}$$

$${\overline{F}}_{{d}_{{A}_{i}}^{′} , {d}_{{A}_{i}} , μ}^{1} ,$$

$$and$$

$${\overline{F}}_{{d}_{{A}_{i}}^{′} , {d}_{{A}_{i}} , μ , {μ}^{′} .}^{2}$$

As will be appreciated, the perturbation portion K₁ can be time independent—or more exactly constant over time—in which case the F coefficients are also time independent. Conversely, the perturbation portion K₁ can be time dependent, in which case the F coefficients are also time dependent.

Thus, in a similar manner as for the first aspect, the expression of the matrix F can also be formally given as a time-discrete expression of the perturbation portion K₁(W)⇒K₁(W,k) via

L_{r,μ}¹⇒L_{r,μ}¹(k)

R_{r,μ}¹⇒R_{r,μ}¹(k)

such that the time-dependent expressions can be given as:

$$\frac{d}{dt} {ρ}_{( {B}_{1} , … , {B}_{p} ) , ( {d}_{{A}_{1}}^{′} , … , {d}_{{A}_{q}}^{′} )} ( k ) = {\sum }_{μ , {d}_{{A}_{1}} , … , {d}_{{A}_{q}}} {\prod }_{i = 1}^{q} {\overline{F}}_{{d}_{{A}_{i}}^{′} , {d}_{{A}_{i}} , μ}^{1} ( k ) [ {⊗}_{j = 1}^{p} {L}_{{B}_{j , μ}}^{1} ( k ) ] {ρ}_{( {B}_{1} , … , {B}_{p} ) , ( {d}_{{A}_{1}} , … , {d}_{{A}_{q}} )} ( k ) [ {⊗}_{l = 1}^{p} {R}_{{B}_{l , μ}}^{1} ( k ) ] + {\sum }_{μ , {d}_{{A}_{1}} , … , {d}_{{A}_{q}} , μ , {μ}^{′}} {\prod }_{i = 1}^{q} \{ {\overline{F}}_{{d}_{{A}_{i}}^{′} , {d}_{{A}_{i}} , μ , {μ}^{′}}^{2} ( k ) [ {⊗}_{j = 1}^{p} {L}_{{B}_{j , {μ}^{′}}}^{1} ( k ) ] [ {⊗}_{l = 1}^{p} {L}_{{B}_{l , μ}}^{1} ( k ) ] {ρ}_{( {B}_{1} , … , {B}_{p} ) , ( {d}_{{A}_{1}} , … , {d}_{{A}_{q}} )} ( k ) * [ {⊗}_{j = 1}^{p} {R}_{{B}_{j , μ}}^{1} ( k ) ] [ {⊗}_{l = 1}^{p} {R}_{{B}_{l , {μ}^{′}}}^{1} ( k ) ] \}$$

$$wherein$$

$${\overline{F}}_{{d}_{{A}_{i}}^{′} , {d}_{{A}_{i}} , μ}^{1} ( k ) = ( \frac{1}{Δ t} ) Tr ( {J}_{{A}_{i} , {d}_{{A}_{i}}^{′}} {L}_{{A}_{i} , μ}^{1} ( k ) {S}_{{A}_{i} , {d}_{{A}_{i}}}^{0} {R}_{{A}_{i} , μ}^{1} ( k ) )$$

$$and$$

$${\overline{F}}_{{d}_{{A}_{i}}^{′} , {d}_{{A}_{i}} , μ , {μ}^{′}}^{2} ( k ) = ( \frac{1}{Δ t} ) Tr \{ {J}_{{A}_{i} , {d}_{{A}_{i}}^{′} , {μ}^{′}}^{1} ( k ) {\sum }_{j = 0} {[ {K}_{0 , {A}_{i}} ]}^{j} ( {S}_{{A}_{i} , {d}_{{A}_{i}} , μ}^{0} ( k ) - {\sum }_{{d}_{{A}_{i}}^{″}} Tr ( {J}_{{A}_{i} , {d}_{{A}_{i}}^{″}} ( k ) {S}_{{A}_{i} , {d}_{{A}_{i}} , μ}^{0} ( k ) ) {S}_{{A}_{i} , {d}_{{A}_{i}}^{″}}^{0} \} ,$$

$$where$$

$${J}_{{A}_{i} , {d}_{{A}_{i}}^{′} , {μ}^{′}}^{1} ( k ) = {R}_{{A}_{i} , {μ}^{′}}^{1} ( k ) {J}_{{A}_{i} , {d}_{{A}_{i}}^{′}}^{1} {L}_{{A}_{i} , {μ}^{′}}^{1} ( k )$$

$$and$$

$${S}_{{A}_{i} , {d}_{{A}_{i}} , μ}^{0} ( k ) = {L}_{{A}_{i} , μ}^{1} ( k ) {S}_{{A}_{i} , {d}_{{A}_{i}}}^{0} {R}_{{A}_{i} , {d}_{{A}_{i}}}^{1} ( k ) .$$

Again, as above, the sum over index j is truncated at a finite number such that the difference between the final two successive iterations (i.e. difference between the penultimate and final summed terms) is smaller than a chosen threshold. For instance, the threshold may be on the order of machine precision of the conventional computer performing the simulation, e.g., such as between 10⁻⁸ and 10⁻¹⁶. For instance, the threshold may be 10⁻¹².

Herein, the above expressions including k in parentheses, such as K₁(W,k), L_{r,μ}¹(k), and R_{r,μ}¹(k), can be taken to generally encompass both the case when the perturbation portion K₁ is time dependent and also the case when it is time-independent (wherein K₁ merely remains constant with respect to k).

In an operation 1660, the processor 5 determines a propagator P by numerically integrating

$$\frac{d}{dt} {ρ}_{( {B}_{1} , … , {B}_{p} ) , ( {d}_{{A}_{1}}^{′} , … , {d}_{{A}_{q}}^{′} )}$$

over tie time period T (i.e. during which each second quantum entity has an unstabilized component such that a respective decoherence-free space cannot be defined for each second quantum entity during the time period T) and e.g. using ρ=Σ_{d}_{_{A}}_{′}S_{A,d}_{_{A}}_{′}⁰ρ_{B,d}_{_{A}}_{′}.

For instance, the p non-stabilized quantum entities Bₚ may initially be stabilized (e.g., at t=0) such that decoherence-free spaces D_{0,B}_{ₚ} can initially be defined. Thus, initially (at t=0) each of the non-stabilized quantum entities Bₚ are stabilized around a respective decoherence-free space D_{0,B}_{ₚ} which is an exponential attractor, each decoherence-free space D_{0,B}_{ₚ} thus having a respective orthonormal Hermitian basis

$$\{ {S}_{{B}_{p} , {d}_{{B}_{P}}}^{0} , {d}_{{B}_{p}} ∈ 〚 1 , {d}_{0 , {B}_{p}} 〛 \} ,$$

$$where$$

$${S}_{{B}_{p} , {d}_{{B}_{p}}}^{0}$$

is the d_{B}_{ₚ}-th Hermitian operator of the orthonormal Hermitian basis of the decoherence-free space D_{0,B}_{ₚ} of the p-th non-stabilized quantum entity and d_{0,B}_{ₚ} is the dimension of the decoherence-free space D_{0,B}_{ₚ}. Then, between t=0 and at t=T, each non-stabilized quantum entity gains an unstabilized component (e.g., by turning off the stabilization mechanism) and the total state evolves according to the dynamics described above

$$\frac{d}{dt} {ρ}_{( {B}_{1} , … , {B}_{p} ) , ( {d}_{{A}_{1}}^{′} , … , {d}_{{A}_{q}}^{′} )} .$$

After evolution, the p non-stabilized quantum entities Bₚ may once again be stabilized (e.g., at t=T) such that decoherence-free spaces D_{0,B}_{ₚ} can once more be defined. A practical implementation of this could be initially stabilized cat-qubits which then have the two-to-one photon exchange temporarily turned off. This may be convenient for particular operations, such as implementing CNOT or Toffoli gates.

Thus, at the beginning of simulation, we may start from the initially stabilized code space of the Bₚ quantum entities.

For instance, considering the bi-partite system for simplicity, the initial states can be written for the bi-partite system as tensor products S_{A,d}_{_{A}}⁰⊗S_{B,d}_{_{B}}⁰ (one state of A tensored with one state of B), with a number d_{0,A}*d_{0,B} of such states. Between t=0 and at t=T, the state of the system can be decomposed only on the decoherence free subspace of the stabilized entities (e.g. as ρ(t)=Σ_{d}_{_{A}} S_{A,d}_{_{A}}⁰ ρ_{B,d}_{_{A}}(t) for the bipartite system).

The propagator P may be constructed from coefficients P_{d}_{_{A}}_{′,d}_{_{B}}_{′,d}A_{,d}_{_{B}}, which is given by the trace of the invariants for the d_{A}′ and d_{B}′ states on the image of d_{A} and d_{B} states after evolution over time T. Thus, to calculate a particular P coefficient for a particular d_{A}, d_{B}, we start with state ρ(t=0)=S_{A,d}_{_{A}}⁰⊗S_{B,d}_{_{B}}⁰. This state then evolves according to

$$\frac{d}{dt} {ρ}_{B , {d}_{A}}$$

as above, such that ρ_{B,d}_{_{A}}(t=T) is computed by: (i) calculating or recalling the corresponding F coefficients and (ii) numerically integrating the above equation for

$$\frac{d}{dt} {ρ}_{B , {d}_{A}} .$$

This gives the image of the initial state ρ(t=0)=S_{A,d}_{_{A}}⁰⊗S_{B,d}_{_{B}}⁰ evolved via the time differential equation.

Δt final time t=T, stabilization is then once again applied to the B entity, such that the final state is decomposed as a linear combination of the basis states of the decoherence-free space D_{0,A} of the stabilized entity ρ(t=T)=Σ_{d}_{_{A}}_{″}S_{A,d}_{_{A}}_{″}⁰ρ_{B,d}_{_{A}}_{″}(t=T). Knowing that J_{A,d}_{_{A}}_{′}S_{A,d}_{_{A}}_{″}⁰=δ_{d}_{_{A}}_{′,d}_{_{A}}_{″} (Kronecker delta), we thus have

$${P}_{{d}_{A}^{′} , {d}_{B}^{′} , {d}_{A} , {d}_{B}} = Tr ( {J}_{B , {d}_{B}^{′}} {ρ}_{B , {d}_{A}^{′}}^{( {d}_{A} , {d}_{B} )} ( T ) )$$

where the superscript (d_{A}, d_{B}) in ρ_{B,d}_{_{A}}_{′}^{(d}^{_{A}}^{,d}^{_{B}}⁾(T)) denotes that the initial state used for calculating this coefficient is ρ(t=0)=S_{A,d}_{_{A}}⁰⊗S_{B,d}_{_{B}}⁰. I.e., this allows us to commute one particular P coefficient. By changing the selection of d_{A}′ and d_{B}′, we get an entire column of the propagator P. Then repeating this process for all the states in the initial basis (i.e., different initial states ρ(t=0)), we get the final propagator.

This can be readily generalized to an open quantum system having more than one stabilized state and/or more than one unstabilized state. For instance, extending to a pair of stabilized entities and a single non-stabilized entity (which applies to the Toffoli gate example described below), we have:

$${P}_{{d}_{{A}_{1}}^{′} , {d}_{{A}_{2}}^{′} , {d}_{B}^{′} , {d}_{{A}_{1}} , {d}_{{A}_{2}} , {d}_{B}} = Tr ( {J}_{B , {d}_{B}^{′}} {ρ}_{B , {d}_{{A}_{1}}^{′} , {d}_{{A}_{2}}^{′}}^{( {d}_{{A}_{1}} , {d}_{{A}_{2}} , {d}_{B} )} ( T ) )$$

where the superscript

$$( {d}_{{A}_{1}} , {d}_{{A}_{2}} , {d}_{B} )$$

$$in$$

$${ρ}_{B , {d}_{{A}_{1}}^{′} , {d}_{{A}_{2}}^{′}}^{( {d}_{{A}_{1}} , {d}_{{A}_{2}} , {d}_{B} )} ( T )$$

again denotes that the initial state used for calculating this coefficient is ρ(t=0)=S_{A}_{₁}_{,d}_{_{A1}}⁰⊗S_{A}_{₂}_{,d}_{_{A2}}⁰⊗S_{B,d}_{_{B}}⁰ for that particular indice d_{A}_{₁}, d_{A}_{₂}, d_{B}.

Generalizing this to an open quantum system comprising q stabilized quantum entities generally denoted by A_{q} and p non-stabilized quantum entities generally denoted by Bₚ, we have:

$${P}_{( {d}_{{A}_{1}}^{′} , … , {d}_{{A}_{q}}^{′} , {d}_{{B}_{1}}^{′} , … , {d}_{{B}_{q}}^{′} ) , ( {d}_{{A}_{1}} , … , {d}_{{A}_{q}} , {d}_{{B}_{1}} , … , {d}_{{B}_{q}} )} = Tr ( [ {⊗}_{i = 1}^{p} {J}_{{B}_{i} , {d}_{{B}_{i}}^{′}} ] {ρ}_{( {B}_{1} , … , {B}_{p} ) , ( {d}_{{A}_{1}}^{′} , … , {d}_{{A}_{q}}^{′} )}^{( {d}_{{A}_{1}} , … , {d}_{{A}_{q}} , {d}_{{B}_{1}} , … , {d}_{{B}_{q}} )} ( T ) )$$

where the superscript (d_{A}_{₁}, . . . , d_{A}_{_{q}}, d_{B}_{₁}, . . . , d_{B}_{ₚ}) in

$${ρ}_{( {B}_{1} , … , {B}_{p} ) , ( {d}_{{A}_{1}}^{′} , … , {d}_{{A}_{q}}^{′} )}^{( {d}_{{A}_{1}} , … , {d}_{{A}_{q}} , {d}_{{B}_{1}} , … , {d}_{{B}_{q}} )}$$

again denotes that the initial state used for calculating this coefficient is ρ(t=0)=⊗ₘ S_{m,d}_{ₘ}⁰, where m=A_{q}, Bₚ. Finally, in an operation 1670, the processor 5 derives an approximated final state ρ_{f} of the density operator ρ by applying the propagator P to the initial state ρ(0) of the density operator ρ of the open quantum system. In other words:

ρ_{f}=P·ρ₀

### Leakage

ρ=Σ_{d}_{_{A}} S_{A,d}_{_{A}}⁰ ρ_{B,d}_{_{A}}BAI_{c}ρtTr(I_{c}ρ)I_{c}=(|C_{α}⁺ [symbol] [symbol] Cₐ⁺|+|C_{α}⁻ [symbol] [symbol] C_{α}⁻|≈\sqrt{2}S₁l The above simulation method can be used to perform a first order computation of the leakage, which is defined as the population outside the code space. For instance, for the bipartite example with a composite state

$$ρ = {\sum }_{{d}_{A}} {S}_{A , {d}_{A}}^{0} {ρ}_{B , {d}_{A}} {BAI}_{c} ρ tTr ( {I}_{c} ρ ) {I}_{c} = ( \vert {C}_{α}^{+} 〉 〈 {C}_{α}^{+} \vert + \vert {C}_{α}^{-} 〉 〈 {C}_{α}^{-} \vert \approx \sqrt{2} {S}_{1} l$$

where one subsystem is not actively stabilized, one cannot in general define the leakage on the full system but only on the stabilized subsystem. However, the present Inventors have recognized that if there is an explicit code space for all the subsystems, then we can still compute the leakage at first order as follows. We can define to be the projector on the code space of our system such that the population of the state at a given time inside the code space is. For instance, in the context of a cat qubit. For any state written at first order, the leakage is given by:

$$l ( t ) = 1 - Tr ( {I}_{c} ρ ) = 1 - {\sum }_{d = 1}^{{d}_{0}} {x}_{d , t} {c}_{d}$$

where c_{d}=Tr(I_{c}(S_{d}⁰+S_{d}¹)). For a bipartite system, the code space can be written as I_{c,A}⊗I_{c,B}, such that at first order the leakage can be expressed as

$$l = {\sum }_{{d}_{A}} {c}_{dA} Tr ( {I}_{c , B} {ρ}_{B , {d}_{A}} )$$

where c_{dA}=Tr(I_{c,A}(S_{A,dA}⁰+S_{A,dA}¹)) and S_{A,dA}¹ is S_{d}^{r} described above for the stabilized quantum entity A with d=dA and r=1.

Thus, in an operation 1680, the processor 5 derives a leakage l.

### Simulation of CNOT

The CNOT gate allows to entangle two qubits called “control” and “target” and is used in particular in the quantum circuit of the repetition code in order to extract the parity of two adjacent data qubits thanks to an auxiliary qubit called “ancilla” by carrying out two successive CNOTs. The CNOT gate can be written as:

$$CNOT = \frac{1}{2} ( {I}_{a} + {Z}_{a} ) {I}_{b} + \frac{1}{2} ( {I}_{a} - {Z}_{a} ) {X}_{b} ,$$

wherein I_{a,b} and Z_{a,b} are the Pauli operators acting on the cat-qubit code space respectively for the first “control” and second “target” cat-qubits, and X_{b} is the Pauli operator acting on the cat-qubit code space of the target cat-qubit.

A particular implementation of a CNOT when using cat-qubits has only the control qubit being actively stabilized via two-photon dissipation and the dynamics of the gate is realized via the addition of a so-called feed-forward Hamiltonian. This Hamiltonian makes the target qubit rotate in its phase plane conditionally to the state of the control qubit in qubit computational state |1 [symbol] ˜|−α [symbol] .

The master equation of the CNOT gate is composed of a stabilization on the control cat-qubit A modelled by [symbol] _{0,A}(ρ)=κ₂D_{α}²_{-α}²(ρ) and perturbations [symbol] ₁(ρ)=−i[H₁, ρ]+κ₁(Dₐ(ρ)+D_{b}(ρ)) composed of the feed-forward Hamiltonian H₁=π/4αT(a+a^{†}−2|α|)(b^{†}b−2|α|²) applied for time T being the duration of the CNOT gate to perform a π rotation of the target cat-qubit B conditioned on the state of the control being in |−α [symbol] . Here, a, b are respectively the photon annihilation operators on the A and B cat-qubits (respectively the control and target), κ₂Dₐ_{²}_{-α}_{²}(ρ) is the dissipator which stabilizes the A cat-qubit, and κ₁(Dₐ(ρ)+D_{b}(ρ)) describes the single-photon loss on both A and B qubits.

As will be appreciated by the skilled person in the field of cat-qubits, the usual computational code-space for the cat-qubit defined by cat-qubit defined by a may be |1 [symbol] ˜|−α [symbol] , |0 [symbol] ˜|α [symbol] , |+ [symbol] ˜|C_{α}_{⁺} [symbol] , and |− [symbol] ˜|C_{α}_{^{−}} [symbol] . However, as will be appreciated, it may be convenient for purposes of numerical computation efficiency to choose the orthonormal basis of the decoherence-free space D_{0,A} of the stabilized control qubit S_{A,d}_{_{A}}⁰ as S_{A,1}⁰=(|C_{α}⁺ [symbol] [symbol] C_{α}⁺|+|C_{α}_{^{−}} [symbol] [symbol] C_{α}_{^{−}}|)/\sqrt{2}, S_{A,2}⁰=(|C_{α}+ [symbol] [symbol] C_{α}_{⁺}|−|C_{α}⁻ [symbol] [symbol] C_{α}_{^{−|)/\sqrt{2}, S}}_{A,3}⁰=(i|C_{α}⁺ [symbol] [symbol] C_{α}⁻|−i|C_{α}⁻ [symbol] [symbol] C_{α}⁺|)/\sqrt{2}, S_{A,4}⁰=(|C_{α}⁺ [symbol] [symbol] C_{α}⁻|+|C_{α}⁻ [symbol] [symbol] ^{C}_{α}⁺|)/\sqrt{2} (of course, other orthonormal basis vectors can be equally defined, indeed such as the states defining the usual computational code-space).

In this particular example then, recalling

$${K}_{1} ( ρ ) = - i Δ t [ H , ρ ] + Δ t ( {\sum }_{υ} ( {L}_{υ} ρ {L}_{υ}^{†} - \frac{1}{2} ( {L}_{υ}^{†} {L}_{υ} ρ + ρ {L}_{υ}^{†} {L}_{υ} ) ) ) ,$$

by expanding the single-photon loss dissipators κ₁(Dₐ(ρ)+D_{b}(ρ)) and the Hamiltonian part −i[H₁,ρ] and comparing with K₁(ρ)=Σ_{μ}⊗ᵣ L_{r,μ}¹ρᵣR_{r,μ}¹, where ρ=⊗ᵣ ρᵣ and r∈ [symbol] A, B [symbol] , the coefficients may be given as follows:

$${L}_{A , 1}^{1} = a , {L}_{A , 2}^{1} = I , {L}_{A , 3}^{1} = - \frac{1}{2} {aa}^{†} , {R}_{A , 1}^{1} = {a}^{†} , {R}_{A , 2}^{1} = - \frac{1}{2} {aa}^{†} , {R}_{A , 3}^{1} = I , {L}_{B , i}^{1} = {R}_{B , i}^{1} = I for i ∈ 〚 1 , 2 , 3 〛 , {L}_{A , i}^{1} = {R}_{A , i}^{1} = I for i ∈ 〚 4 , 5 , 6 〛 , {L}_{B , 4}^{I} = b , {L}_{B , 5}^{1} = I , {L}_{B , 6}^{1} = - \frac{1}{2} {bb}^{†} , {R}_{B , 4}^{1} = {b}^{†} , {R}_{B , 5}^{1} = - \frac{1}{2} {bb}^{†} , {R}_{B , 6}^{1} = I , {L}_{A , 7}^{1} = - iπ / 4 α T ( a + {a}^{†} - 2 \vert α \vert ) , {L}_{B , 7}^{1} = ( {b}^{†} b - {\vert α \vert}^{2} ) , {R}_{A , 8}^{1} = i π / 4 α T ( a + {a}^{†} - 2 \vert α \vert ) , {R}_{B , 8}^{1} = ( {b}^{†} b - {\vert α \vert}^{2} ) , {R}_{A , 7}^{1} = {R}_{B , 7}^{1} = {L}_{A , 8}^{1} = {L}_{B , 8}^{1} = I .$$

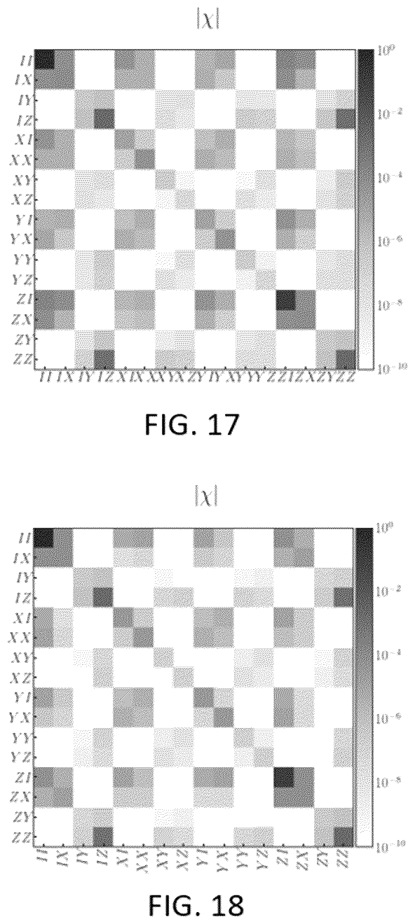

The time-discretization via Kraus map of the Lindblad master equation as described above can be applied, and in FIGS. 17-21 the time step is chosen to satisfy

$${κ}_{2} {\vert α \vert}^{2} Δ t = \frac{1}{100} .$$

Furthermore, as for the previously described simulations (and for the following), the simulation parameters are

$$T = \frac{1}{{κ}_{2}}$$

and κ₁=κ₂/100.

FIG. 17 shows the modulus of the χ matrix obtained after simulating the {ρᵢ}_{1≤i≤16} using the Schrödinger picture for |α|²=4 and a truncature of N(α)=max(20, [α²+20α]) where [ . . . ] denotes the integer part. The χ matrix is obtained in the same manner as described above for e.g. FIGS. 3-9.

FIG. 18 shows the modulus of the χ matrix obtained after simulating the {ρᵢ}_{1≤i≤16} using the proposed simulation method in the hybrid Schrödinger-Heisenberg picture for the same parameters as in FIG. 17. The comparison of both figures shows that the proposed simulation method succeeds in computing correctly the final states of density matrices for this set of experimental parameters. The simulation needed for the CNOT gate according to this method may take from a few minutes for |α|²=1 to 2.5 hours for |α|²=16, whereas it may take well over 100 hours with the Schrödinger picture simulation.

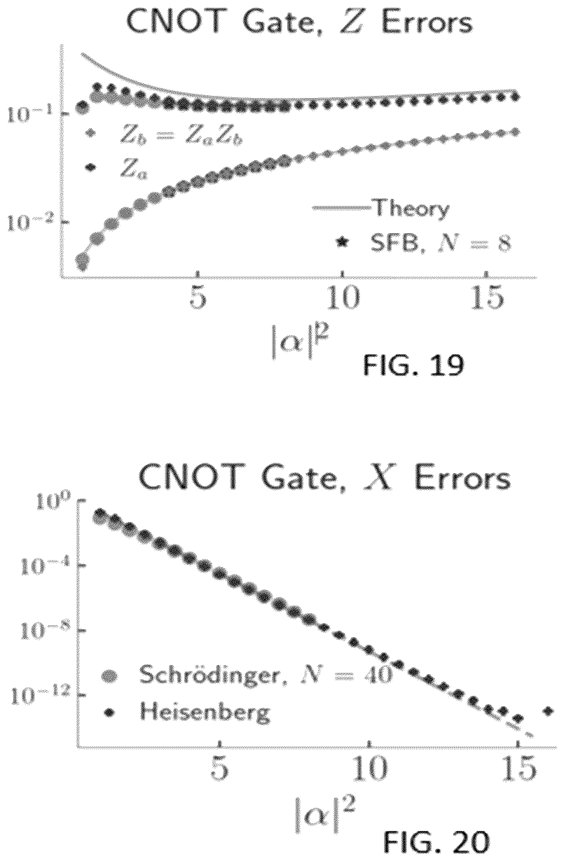

FIG. 19 shows the different phase-flip error probabilities: the evolution of the coefficient χ_{(Z}_{_{b}}_{,Z}_{ₐ}_{Z}_{_{b}}₎ represented by grey crosses, and χ_{(Z}_{ₐ}_{,Z}_{ₐ}₎ represented by black crosses using the proposed simulation method.

The same coefficients computed with the Schrödinger picture are shown as grey circles. The Schrödinger picture would require higher truncatures to go above 8 photons and is thus not simulated here.

The analytical formula for the Zₐ, Z_{b} and ZₐZ_{b} errors obtained via second-order adiabatic elimination are shown as grey lines.

$${p}_{{Z}_{a}} = {\vert α \vert}^{2} {κ}_{1} T + 0.62 \frac{1}{{\vert α \vert}^{2} {κ}_{2} T}$$

$${p}_{{Z}_{b}} = {p}_{{Z}_{a} {Z}_{b}} = 0.5 {\vert α \vert}^{2} {κ}_{1} T$$

FIG. 20 shows the evolution of the sum of the coefficients of χ that include bitflips: one or more of the errors Xₐ, Yₐ, X_{b} and Y_{b}. Those errors are represented as black crosses and exponentially decreasing with the mean photon number |α|². The same coefficients computed with the Schrödinger picture are shown as grey circles. The exponential suppression of bit-flips is shown as the dashed line with an exponential coefficient of 2.204±0.009.

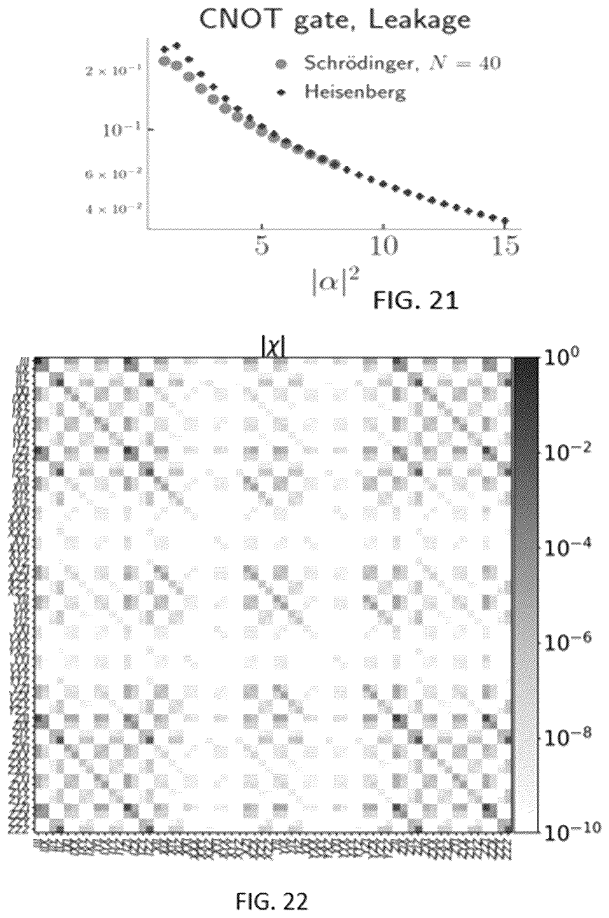

FIG. 21 shows the final leakage against |α|² for a CNOT gate bitflips computed at first order by using the above-described simulation method. Since the target qubit is not stabilized, it will concentrate most of the leakage of the full system, since the hybrid method according to the invention effectively uses Schrödinger picture for the target qubit, the leakage is obtained in good agreement at first order.

### Toffoli (CCNOT) Gate

The Toffoli gate, also known as the controlled-controlled-not “CCNOT” gate allows to entangle two control qubits with a target qubit, and is a key ingredient in many quantum algorithms, such as quantum error correction, the quantum Fourier transform, the quantum phase estimation algorithm, and the quantum approximate optimization algorithm.

A particular implementation of a Toffoli gate when using cat-qubits has active stabilization of the first two control qubits whilst coupling all three qubits such that the non-stabilized target qubit is flipped if and only if the two control qubits are in the qubit computational state |1 [symbol] ˜|−α [symbol] . The Toffoli gate can be written as: Toffoli=|−α [symbol] [symbol] −α|⊗|−α [symbol] [symbol] −α|⊗X+|̅−̅α̅ [symbol] [symbol] −̅α̅|̅⊗̅|̅−̅α̅ [symbol] [symbol] −̅α̅|̅⊗I_{c}, where X and I_{c} are the Pauli operators of the third cat-qubit (denoted by C below).

On both control cat-qubits denoted here by A and B, the two-photon driven stabilization is applied such that [symbol] ₀(ρ)=κ₂Dₐ_{²}_{-α}_{²}(ρ)+κ₂D_{b}_{²}_{-α}_{²}(ρ), whereas the perturbations are [symbol] ₁(ρ)=−i[H₁,ρ]+κ₁(Dₐ(ρ)+D_{b}(ρ)+D_{b}(ρ)), composed of the three-mode coupling Hamiltonian H₁=−π/8α²T((a−|α|)(b−|α|)+h·c)(c^{†}c−|α|²) applied for time T being the duration of the Toffoli gate to perform a It rotation of the target cat-qubit C conditioned on the state of the control qubits A and B being in |−α [symbol] |−α [symbol] . Here, a, b, c are respectively the photon annihilation operators on the A, B, and C cat-qubits, and κ₁(Dₐ(ρ)+D_{b}(ρ)+D_{c}(ρ)) describes the single-photon loss on the A, B, and C cat-qubits. Similar to the CNOT above, it may be convenient for purposes of numerical computation efficiency to choose the orthonormal basis of the decoherence-free space D_{0,q} of for the stabilized control qubits (q=A, B) S_{q,d}_{_{q}}⁰ as S_{q,1}⁰=(C|_{α}_{⁺}^{q} [symbol] [symbol] C_{α}_{⁺}^{q}|+|C_{α}_{^{−}}^{q} [symbol] [symbol] C_{α}_{^{−}}^{q}|)/\sqrt{2}, S_{q,2}⁰=(|C_{α}_{⁺}^{q} [symbol] [symbol] C_{α}_{⁺}^{q}|−|C_{α}_{^{−}}^{q} [symbol] [symbol] C_{α}_{^{−}}^{q}|)/\sqrt{2}, S_{q,3}⁰=(i|C_{α}_{⁺}^{q} [symbol] [symbol] C_{α}_{^{−}}^{q}|−i|C_{α}_{^{−}}^{q} [symbol] [symbol] C_{α}_{⁺}^{q}|)/\sqrt{2}, S_{q,4}⁰=(|C_{α}_{⁺}^{q} [symbol] [symbol] C_{α}_{^{−}}^{q}|+|C_{α}_{^{−}}^{q} [symbol] [symbol] C_{α}_{⁺}^{q}|)/\sqrt{2}.

In this particular example then, recalling

$${K}_{1} ( ρ ) = - i Δ t [ H , ρ ] + Δ t ( {Σ}_{υ} ( {L}_{υ} ρ {L}_{υ}^{†} - \frac{1}{2} ( {L}_{υ}^{†} {L}_{υ} ρ + ρ {L}_{υ}^{†} {L}_{υ} ) ) ) ,$$

by expanding the single-photon loss dissipators κ₁(Dₐ(ρ)+D_{b}(ρ)+D_{c}(ρ)) and the Hamiltonian part −i[H₁, ρ] and comparing with K₁(ρ)=Σ_{μ}⊗ᵣ L_{r,μ}¹ρᵣR_{r,μ}¹, where ρ=⊗ᵣ ρᵣ and r∈ [symbol] A, B [symbol] , the coefficients may be given as follows:

$${L}_{A , 1}^{1} = a , {L}_{A , 2}^{1} = I , {L}_{A , 3}^{1} = - \frac{1}{2} {aa}^{†} , {R}_{A , 1}^{1} = {a}^{†} , {R}_{A , 2}^{1} = - \frac{1}{2} {aa}^{†} , {R}_{A , 3}^{1} = I , {L}_{B , i}^{1} = {R}_{C , i}^{1} = I for i ∈ 〚 1 , 2 , 3 〛 , {L}_{k , i}^{1} = {R}_{k , i}^{1} = I for k = a and i ∈ 〚 4 , 5 , 6 〛 , {L}_{B , 4}^{I} = b , {L}_{B , 5}^{1} = I , {L}_{B , 6}^{1} = - \frac{1}{2} {bb}^{†} , {R}_{B , 4}^{1} = {b}^{†} , {R}_{B , 5}^{1} = - \frac{1}{2} {bb}^{†} , {R}_{B , 6}^{1} = I , {L}_{A , 7}^{1} = i π / 8 {α}^{2} T ( a - \vert α \vert ) , {L}_{B , 7}^{1} = {b}^{†} - \vert α \vert , {L}_{C , 7}^{1} = {c}^{†} c - {\vert α \vert}^{2} , {R}_{A , 8}^{1} = - i π / 8 {α}^{2} T ( a - \vert α \vert ) , {R}_{B , 8}^{1} = {b}^{†} - \vert α \vert , {R}_{C , 8}^{1} = {c}^{†} c - {\vert α \vert}^{2} , {L}_{A , 9}^{1} = i π / 8 {α}^{2} T ( {a}^{†} - \vert α \vert ) , {L}_{B , 9}^{1} = b - \vert α \vert , {L}_{C , 9}^{1} = {c}^{†} c - {\vert α \vert}^{2} , {R}_{A , 10}^{1} = - i π / 8 {α}^{2} T ( {a}^{†} - \vert α \vert ) , {R}_{B , 10}^{1} = b - \vert α \vert , {R}_{C , 10}^{1} = {c}^{†} c - {\vert α \vert}^{2} , and {R}_{A , 7}^{1} = {R}_{B , 7}^{1} = {L}_{A , 8}^{1} = {L}_{B , 8}^{1} = {L}_{C , 8}^{1} = {R}_{A , 9}^{1} = {R}_{B , 9}^{1} = {R}_{C , 9}^{1} = {L}_{A , 10}^{1} = {L}_{B , 10}^{1} = {L}_{C , 10}^{1} = I .$$

The time-discretization via Kraus map of the Lindblad master equation as described above can be applied, and the time step is again chosen to satisfy

$${κ}_{2} {\vert α \vert}^{2} Δ t = \frac{1}{100} .$$

The simulation parameters are as above

$$T = \frac{1}{{κ}_{2}}$$

and κ₁=κ₂/100.

FIG. 22 shows the modulus of the χ matrix obtained after simulating the {ρᵢ}_{1≤i≤16} using the proposed simulation method in the hybrid Schrödinger-Heisenberg picture for the same parameters. Here the size of the full Hilbert space composed of the three cat-qubits is too big to allow for a simulation in the Schrödinger picture.

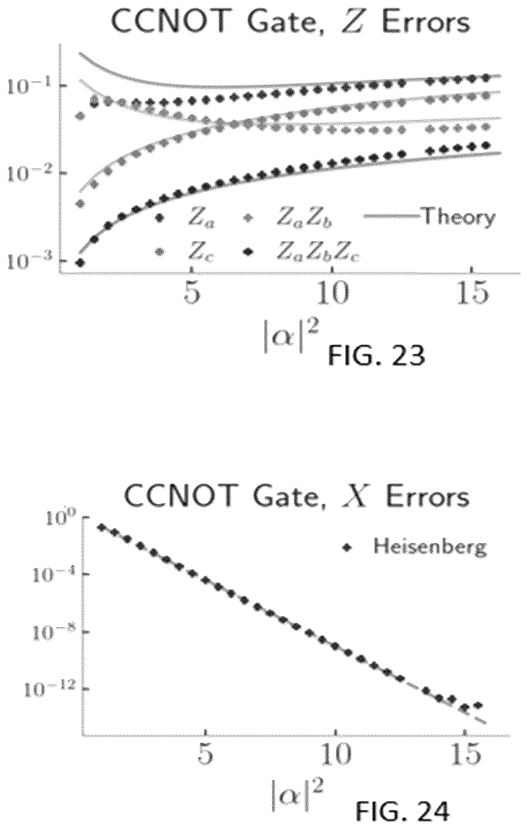

FIG. 23 shows the different phase-flip error probabilities obtained using the above simulation method: the evolution of the coefficients χ denoting the probabilities due to phase-flip p_{Z}_{ₐ}=p_{Z}_{_{b}} as the upper dark grey crosses, p_{Z}_{_{c}} as the lighter grey crosses which show an increasing trend with increasing |α|², p_{Z}_{ₐ}_{Z}_{_{b}} as the lighter grey crosses which show a decreasing trend with increasing |α|², and p_{Z}_{ₐ}_{Z}_{_{b}}_{Z}_{_{c}} as the lower black crosses.

The analytical formula for the Zₐ, Z_{b} and ZₐZ_{b} errors obtained via second-order adiabatic elimination are shown as grey lines.

$${p}_{{Z}_{a}} = {p}_{{Z}_{b}} = {\vert α \vert}^{2} {κ}_{1} T + \frac{{π}^{2}}{32 {\vert α \vert}^{2} {κ}_{2} T}$$

$${p}_{{Z}_{c}} = \frac{5}{8} {\vert α \vert}^{2} {κ}_{1} T$$

$${p}_{{Z}_{a} {Z}_{b}} = \frac{1}{4} {\vert α \vert}^{2} {κ}_{1} T + \frac{{π}^{2}}{64 {\vert α \vert}^{2} {κ}_{2} T}$$

$${p}_{{Z}_{a} {Z}_{c}} = {p}_{{Z}_{b} {Z}_{c}} = {p}_{{Z}_{a} {Z}_{b} {Z}_{c}} = \frac{1}{8} {\vert α \vert}^{2} {κ}_{1} T$$

FIG. 24 shows the evolution of the sum of the coefficients of x that include bitflips: one or more of the errors Xₐ, Yₐ, X_{b}, Y_{b}, X_{c} and Y_{c}. Those errors are represented as black crosses and exponentially decreasing with the mean photon number |α|². The exponential suppression of bit-flips is shown as the dashed line with an exponential coefficient of 2.131±0.005.

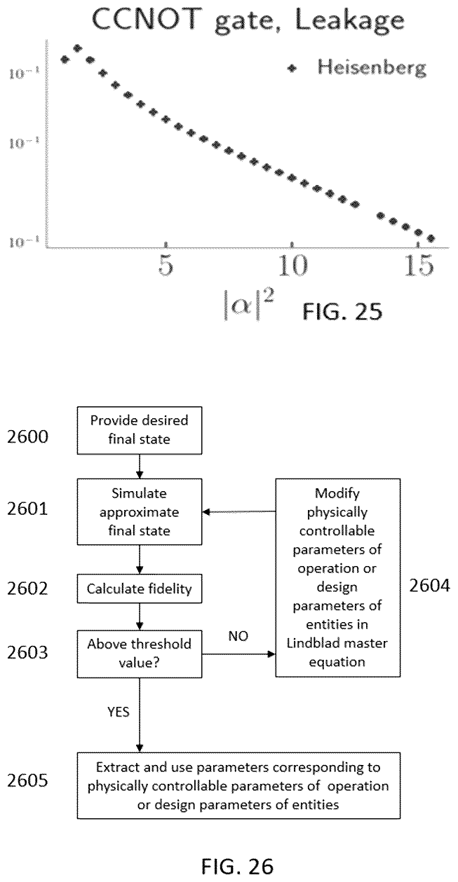

FIG. 25 shows the final leakage against |α|² for a Toffoli gate bitflips computed at first order by using the above-described simulation method. Similar to the CNOT gate, since the target qubit is not stabilized, it will concentrate most of the leakage of the full system, since the hybrid method according to the invention effectively uses Schrödinger picture for the target qubit, the leakage is obtained in good agreement at first order.

As will be appreciated, the methods or devices of either the first or second aspects may be used to guide the choice of experimental parameters to be used in an operation on an open quantum system formed from quantum states (e.g. comprising only stabilized quantum entities, or both stabilized and non-stabilized quantum entities). For instance, a desired operation may be to start from a known initial state ρ(0) of the open quantum system and subsequently evolve the system under a physically (e.g. experimentally) controlled interaction to a desired (and thus also known) final state of the density operator ρ. The Lindblad master equation defining the dynamics, received as inputs in the simulation, may model the experimentally controlled interaction. More particularly, there are a certain set of parameters entering the Lindblad master equation which correspond to physically controllable parameters of the operation. Thus, a first choice of the Lindblad master equation may be input to derive an approximated final state of the density operator. Said approximated (i.e. simulated) final state may be compared with the desired final state. If the fidelity between the approximated final state and the desired final state is below a certain threshold (i.e. indicating that the approximated final state does not suitably match up with the desired final state), then a second choice of the Lindblad master equation may be input to derive a second approximated final state of the density operator, which is subsequently compared with the desired final state. This method may be iterated until the fidelity between the approximated final state and the desired final state is above a certain threshold. The choice of the Lindblad master equation which results in the approximated final state yielding the acceptable fidelity (i.e. above the certain threshold) dictates the choice of experimental parameters to be used. That is, the parameters of the Lindblad master equation yielding the acceptable fidelity are extracted, and an operation on an open quantum system is physically performed using the extracted parameters.

In a similar manner, the simulation method can be used to design an open quantum system for subsequent physical fabrication. For instance, a desired operation may be to start from a known initial state ρ(0) of the open quantum system and subsequently evolve the system under a known interaction to a desired (and thus also known) final state of the density operator ρ. The Lindblad master equation defining the dynamics, received as inputs in the simulation, may model the desired interaction and the physically controllable parameters of the plurality of quantum entities. Thus, a first choice of the Lindblad master equation may be input to derive an approximated final state of the density operator. Said approximated (i.e. simulated) final state may be compared with the desired final state. If the fidelity between the approximated final state and the desired final state is below a certain threshold (i.e. indicating that the approximated final state does not suitably match up with the desired final state), then a second choice of the Lindblad master equation, with modified parameters corresponding to physically controllable parameters of the plurality quantum entities, may be input to derive a second approximated final state of the density operator, which is subsequently compared with the desired final state. This method may be iterated until the fidelity between the approximated final state and the desired final state is above a certain threshold. The choice of the Lindblad master equation which results in the approximated final state yielding the acceptable fidelity (i.e. above the certain threshold) dictates the choice of physically controllable parameters of the plurality quantum entities to be used in the design of the open quantum system. That is, the parameters of the Lindblad master equation yielding the acceptable fidelity are extracted, and the plurality quantum entities are designed so as to have the extracted parameters.

This is shown generally in FIG. 26. At step 2600, a desired final state is provided: Δt step 2601, an approximate final state is simulated using the simulation methods described herein (i.e. for an initial operation for optimization to be performed on quantum entities having known physical parameters or for a known operation to be performed on quantum entities having initial physical parameters for optimization). Δt step 2602, a fidelity between the desired final state and the simulated approximate final state is calculated, which is compared with a threshold value at step 2603. If the fidelity is below the threshold value, then the physically controllable parameters of operation or design parameters of the quantum entities are modified in Lindblad master equation and the simulation step 2601 is performed again, and the subsequent fidelity is calculated again in step 2602 and compared with the threshold value in step 2603. The steps 2601-2604 are repeated until a calculated fidelity is above the threshold value, in which case in step 2605 the parameters of the final iteration, corresponding to physically controllable parameters of the operation or physical design parameters of the quantum entities; are extracted and used.

The fidelity may be given as the overlap between the approximated final state and desired final state. The threshold may be between 0.7 (70%) and 1 (100%). For instance, the threshold may be chosen such that the fidelity between the approximated final state and the desired final state is above 0.8, preferably above 0.9, and most preferably above 0.99.

Modifying parameters between successive iterations of choices of Lindblad master equations may use any known optimization algorithm, such as gradient descent.

A particular example of the method of performing an operation on an open quantum system may include preparing a desired Fock (photon number) state in one or more resonators via application of particular electromagnetic pulse sequences to the resonator(s) for a period of time, during which the resonator(s) are subject to various individual decay channels such as single-photon loss to the environment or coupling to phononic or charge modes of the open system. In the case of multiple resonators, other channels may exist such as coupling between the resonators themselves. The known initial state may be the vacuum state (no photons in the resonator(s)). The simulation method may be iterated until

Another of the method of performing an operation on an open quantum system example may include performing a quantum gate on or between one or more qubits as described above. For instance, a Z-gate may be performed on a single qubit, a ZZ-gate or CNOT gate may be performed between two qubits, or a ZZZ-gate or Toffoli gate may be performed between three qubits. The initial state is the known state of the one or more qubits prior to application of the gate. The gates may be performed via application of particular electromagnetic pulse sequences to the qubit(s) for a period of time, during which the qubits(s) are subject to various individual decay channels such as single-photon loss to the environment or coupling to phononic or charge modes of the open system. In the case of multiple qubits, other interaction channels may exist such as coupling between the qubits themselves which are in particular necessary for performing the CNOT or Toffoli gates.

1. A device (1) for simulating an open quantum system including one or more quantum entities, the open quantum system having a Hilbert space H and the one or more quantum entities each having a respective Hilbert space H_{q}, such that H=⊗_{q=1}ⁿ H_{q}, where n is the number of quantum entities and ⊗ denotes the tensor product, the one or more quantum entities each having a respective decoherence-free space D_{0,q} which are exponential attractors and define together a decoherence-free space Do of the open quantum system with D₀=⊗_{q=1}ⁿ D_{0,q}, each decoherence-free space D_{0,q} having a respective orthonormal Hermitian basis {S_{q,d}_{_{q}}⁰, d_{q}∈ [symbol] 1, d_{0,q} [symbol] }, where S_{q,d}_{_{q}}⁰ is the d_{q}-th Hermitian of the orthonormal Hermitian basis of the decoherence-free space D_{0,q} of the q-th quantum entity and d_{0,q} is the dimension of the decoherence-free space D_{0,q} of the q-th quantum entity, said device (1) comprising: a memory (3) arranged to store data representing the time evolution of a Lindblad master equation defining the dynamics of a density operator ρ of the open quantum system, said dynamics including at least a sum of quantum entity specific local nominal dynamics, and a processor (5) arranged to apply an explicit method to said data for generating a discrete-time expression of the Lindblad master equation, splitting said discrete-time expression of the Lindblad master equation into a local nominal dynamics portion and a perturbation portion K₁ with an amplitude of said perturbation portion being at least five times smaller than an amplitude of said local nominal dynamics portion, and to further apply a trace-preserving and completely-positive linear Kraus map formulation to said local nominal dynamics portion such that the Kraus map K₀ of said local nominal dynamics portion is derived from the respective Kraus maps K_{0,q} of said quantum entity specific local nominal dynamics with K₀=⊗_{q=1}ⁿ K_{0,q}, such that ρₖ₊₁=K₀(ρₖ)+K₁(ρₖ), where ρₖ is the k-th time value of the time-discrete density operator,
said processor (5) being further arranged to determine a finite set of local operators L_{q,μ}¹ and R_{q,μ}¹ on the Hilbert space H_{q} such that, for any operator W on the Hilbert space H verifying W=⊗_{q=1}ⁿ W_{q}, W_{q} being a local operator on the Hilbert space H_{q}: K₁(W)=Σ_{μ}⊗_{q=1}ⁿ L_{q,μ}¹W_{q}R_{q,μ}¹,
said processor (5) being further arranged to calculate invariant operators
$${J}_{q , {d}_{q}} = {lim}_{k \to + ∞} {[ {K}_{0 , q}^{*} ]}^{k} ( {S}_{q , {d}_{q}}^{0} )$$
of each quantum entity, where K_{0,q}^{*} is the conjugate transpose of the local nominal dynamics portion K_{0,q} of the q-th quantum entity, said processor (5) being further arranged to determine a second-order approximation of matrices F(k) modeling the time evolution of the time-discrete density operator of the open quantum system by computing:
$${F}^{0} ( k ) = I$$
$${F}_{( {d}_{1}^{′} , … , {d}_{n}^{′} ) , ( {d}_{1} , … , {d}_{n} )}^{1} ( k ) = {\sum }_{μ} {\prod }_{q = 1}^{n} Tr ( {J}_{μ , q , {d}_{q}^{′}}^{1} ( k ) {S}_{q , {d}_{q}}^{0} )$$
$${F}_{( {d}_{1}^{′} , … , {d}_{n}^{′} ) , ( {d}_{1} , … , {d}_{n} )}^{2} ( k ) = {\sum }_{i = 0}^{+ ∞} ( {\sum }_{μ , {μ}^{′}} {\prod }_{q = 1}^{n} Tr ( {{J}_{{μ}^{′} , q , {d}_{q}^{′}}^{1} ( k ) [ {K}_{0 , q} ]}^{i} ( {S}_{μ , q , {d}_{q}}^{1} ( k ) ) ) - {\prod }_{q = 1}^{n} {\sum }_{{d}_{q}^{″}} Tr ( {J}_{{μ}^{′} , q , {d}_{q}^{′}}^{1} ( k ) {S}_{q , {d}_{q}^{″}}^{0} ) Tr ( {J}_{μ , q , {d}_{q}^{″}}^{1} ( k ) {S}_{q , {d}_{q}}^{0} ) )$$
$$with :$$
$${J}_{μ , q , {d}_{q}^{′}}^{1} ( k ) = {R}_{q , μ}^{1} ( k ) {J}_{q , {d}_{q}^{′}} {L}_{q , μ}^{1} ( k )$$
$${S}_{μ , q , {d}_{q}}^{1} ( k ) = {L}_{q , μ}^{1} ( k ) {S}_{q , {d}_{q}}^{0} {R}_{q , {d}_{q}}^{1} ( k )$$
where: I is the identity matrix on the Hilbert space H, F⁰(k) is a zero-order part of the matrix F(k), F_{(d}_{₁}_{′, . . . , d}_{ₙ}_{′),(d}_{₁}_{, . . . , d}_{ₙ}₎¹(k) is a coefficient of a first-order part F¹(k) of the matrix F(k), F_{(d}_{₁}_{′, . . . , d}_{ₙ}_{′),(d}_{₁}_{, . . . , d}_{ₙ}₎²(k) is a coefficient of a second-order part F²(k) of the matrix F(k), and F(k)=F⁰(k)+F¹(k)+F²(k),
said processor (5) being further arranged to determine a propagator P as a time product of the matrices F(k) for approximating a final state ρ_{f} of the density operator ρ based on an initial state ρ₀ of said density operator ρ,
the device (1) being arranged to receive as inputs a Lindblad master equation defining the dynamics of the density operator ρ of an open quantum system including one or more quantum entities to be simulated, along with the respective decoherence-free spaces D_{0,q} of said one or more quantum entities and an initial state ρ₀ of said density operator ρ, to execute said processor (5) with said inputs and derive an approximated final state ρ_{f} of the density operator ρ.

2. The device (1) of claim 1, wherein the processor (5) is arranged to apply an explicit Euler scheme as the explicit method.

3. The device (1) of claim 1, wherein the processor (5) is arranged to apply the Kraus map formulation using the following Kraus map:
$${K}_{0} ( ρ ) = U ( \overline{M} U ρ {U}^{†} {\overline{M}}^{†} + Δ t ( {\sum }_{υ} {\overline{L}}_{υ} U ρ {U}^{†} {\overline{L}}_{υ}^{†} ) ) {U}^{†}$$
$$with :$$
$$U = {e}^{- i Δ tH / 2}$$
$$\overline{M} = {MS}^{- \frac{1}{2}}$$
$${\overline{L}}_{υ} = {L}_{υ} {S}^{- \frac{1}{2}}$$
$$where :$$
$$M = I - {\sum }_{υ} \frac{Δ t}{2} {L}_{υ}^{†} {L}_{υ}$$
$$and$$
$$S = {M}^{†} M + Δ t {\sum }_{υ} {L}_{υ}^{†} {L}_{υ} ,$$
and where: Δt is the time step of the explicit method, L_{υ} is a υ-th Lindblad operator and His a Hamiltonian of the Lindblad master equation.

4. The device (1) of claim 1, wherein the perturbation K₁ is time independent and the processor (5) is arranged to determine the propagator
$$P = {e}^{T \frac{F}{Δ t}} ,$$
where Δt is the time step of the explicit method and T is a time quantity over which the Lindblad master equation rules the open quantum system.

5. The device (1) of claim 1, wherein the perturbation K₁ is time dependent and the processor (5) is arranged to determine the propagator as a time-ordered product P=Πₖ₌₀^{Λ} F(T−Σⱼ₌₀^{k} Δtⱼ), where Δtₖ is the time step of the explicit method corresponding to the k-th time value of the time-discrete density operator, T is a time quantity over which the Lindblad master equation rules the open quantum system, Λ is the number of time step Δtₖ over the time quantity T, and Δt₀ is equal to 0 by convention.

6. The device (1) of claim 1, wherein said device (1) is arranged to receive as inputs a Lindblad master equation defining the dynamics of the density operator ρ of an open quantum system including only one quantum entity to be simulated, and wherein the processor (5) is arranged to determine a Q-order approximation of the matrix modeling the time evolution of the time-discrete density operator of the open quantum system, Q being an integer greater than two, by implementing the following recurrence process:
$${F}_{{d}^{′} , d}^{r} = Tr ( {J}_{{d}^{′}} {K}_{1} ( {S}_{d}^{r - 1} ) )$$
$$with :$$
$${S}_{d}^{r} = {lim}_{i \to + ∞} {[ {K}_{0} + {W}_{d}^{r} ]}^{i} ( 0 )$$
$${W}_{d}^{r} = {K}_{1} ( {S}_{d}^{r - 1} ) - {\sum }_{s = 1}^{r} {\sum }_{{d}^{′} = 1}^{{d}_{0}} {F}_{{d}^{′} , d}^{s} {S}_{{d}^{′}}^{r - s}$$
where: d₀ is the dimension of the decoherence-free space D₀ of the open quantum system, and D_{d′,d}^{r} is a coefficient of a r-order part FT of the matrix F, and F=Σᵣ₌₀^{q} F^{r}.

7. The device (1) of claim 1, wherein said device (1) is arranged to receive as inputs a Lindblad master equation defining the dynamics of the density operator ρ of an open quantum system that is a quantum logic gate.

8. The device (1) of claim 7, wherein said device (1) is arranged to receive as inputs a Lindblad master equation defining the dynamics of the density operator ρ of an open quantum system that is a Z-gate, a ZZ-gate, a ZZZ-gate, a CNOT-gate or a Toffoli-gate.

9. A method for simulating an open quantum system including one or more quantum entities, the open quantum system having a Hilbert space H and the one or more quantum entities each having a respective Hilbert space H_{q}, such that H=⊗_{q=1}ⁿ H_{q}, where n is the number of quantum entities and ⊗ denotes the tensor product, the one or more quantum entities each having a respective decoherence-free space D_{0,q} which are exponential attractors and define together a decoherence-free space Do of the open quantum system with D₀=⊗_{q=1}ⁿ D_{0,q}, each decoherence-free space D_{0,q} having a respective orthonormal Hermitian basis {S_{q,d}_{_{q}}⁰, d_{q}∈ [symbol] 1, d_{0,q} [symbol] }, where S_{q,d}_{_{q}}⁰ is the d_{q}-th Hermitian of the orthonormal Hermitian basis of the decoherence-free space D_{0,q} of the q-th quantum entity and d_{0,q} is the dimension of the decoherence-free space D_{0,q} of the q-th quantum entity, said method being implemented by the device (1) of one of the preceding claims and comprising the following operations:
receiving (200) as inputs a Lindblad master equation defining the dynamics of a density operator ρ of an open quantum system including one or more quantum entities to be simulated, said dynamics including at least a sum of quantum entity specific local nominal dynamics, along with the respective decoherence-free spaces D_{0,q} of said one or more quantum entities and an initial state ρ₀ of said density operator ρ,
applying (210) an explicit method to said Lindblad master equation for generating a discrete-time expression thereof, splitting said discrete-time expression of the Lindblad master equation into a local nominal dynamics portion and a perturbation portion K₁ with an amplitude of said perturbation portion being at least five times smaller than an amplitude of said local nominal dynamics portion,
applying (220) a trace-preserving and completely-positive linear Kraus map formulation to said local nominal dynamics portion such that the Kraus map K₀ of said local nominal dynamics portion is derived from the respective Kraus maps K_{0,q} of said quantum entity specific local nominal dynamics with K₀=⊗_{q=1}ⁿ K_{0,q}, such that ρₖ₊₁=K₀(ρₖ)+K₁(ρₖ), where ρₖ is the k-th time value of the time-discrete density operator,
determining (230) a finite set of local operators L_{q,μ}¹ and R_{q,μ}¹ on the Hilbert space H_{q} such that, for any operator W on the Hilbert space H verifying W=⊗_{q=1}ⁿ W_{q}, W_{q} being a local operator on the Hilbert space H_{q}: K₁(W)=Σ_{μ}⊗_{q=1}ⁿ L_{q,μ}¹W_{q}R_{q,μ}¹,
calculating (240) invariant operators
$${J}_{q , {d}_{q}} = {lim}_{k \to + ∞} {[ {K}_{0 , q}^{*} ]}^{k} ( {S}_{q , {d}_{q}}^{0} )$$
of each quantum entity, where K_{0,q}^{*} is the conjugate transpose of the local nominal dynamics portion K_{0,q} of the q-th quantum entity,
determining (250) a second-order approximation of matrices F(k) modeling the time evolution of the time-discrete density operator of the open quantum system by computing:
$${F}^{0} ( k ) = I$$
$${F}_{( {d}_{1}^{′} , … , {d}_{n}^{′} ) , ( {d}_{1} , … , {d}_{n} )}^{1} ( k ) = {\sum }_{μ} {\prod }_{q = 1}^{n} Tr ( {J}_{μ , q , {d}_{q}^{′}}^{1} ( k ) {S}_{q , {d}_{q}}^{0} )$$
$${F}_{( {d}_{1}^{′} , … , {d}_{n}^{′} ) , ( {d}_{1} , … , {d}_{n} )}^{2} ( k ) = {\sum }_{i = 0}^{+ ∞} ( {\sum }_{μ , {μ}^{′}} {\prod }_{q = 1}^{n} Tr ( {{J}_{{μ}^{′} , q , {d}_{q}^{′}}^{1} ( k ) [ {K}_{0 , q} ]}^{k} ( {S}_{μ , q , {d}_{q}}^{1} ( k ) ) ) - {\prod }_{q = 1}^{n} {\sum }_{{d}_{q}^{″}} Tr ( {J}_{{μ}^{′} , q , {d}_{q}^{′}}^{1} ( k ) {S}_{q , {d}_{q}^{″}}^{0} ) Tr ( {J}_{μ , q , {d}_{q}^{″}}^{1} ( k ) {S}_{q , {d}_{q}}^{0} ) )$$
$$with :$$
$${J}_{μ , q , {d}_{q}^{′}}^{1} ( k ) = {R}_{q , μ}^{1} ( k ) {J}_{q , {d}_{q}^{′}} {L}_{q , μ}^{1} ( k )$$
$${S}_{μ , q , {d}_{q}}^{1} ( k ) = {L}_{q , μ}^{1} ( k ) {S}_{q , {d}_{q}}^{0} {R}_{q , {d}_{q}}^{1} ( k )$$
where: I is the identity matrix on the Hilbert space H, F⁰(k) is a zero-order part of the matrix F(k), F_{(d}_{₁}_{′, . . . , d}_{ₙ}_{′),(d}_{₁}_{, . . . , d}_{ₙ}₎¹(k) is a coefficient of a first-order part F¹(k) of the matrix F(k), F_{(d}_{₁}_{′, . . . , d}_{ₙ}_{′),(d}_{₁}_{, . . . , d}_{ₙ}₎²(k) is a coefficient of a second-order part F²(k) of the matrix F(k), and F(k)=F⁰(k)+F¹(k)+F²(k),
determining (260) a propagator P as a time product of the matrices F(k), and
deriving (270) an approximated final state ρ_{f} of the density operator ρ by applying said propagator P to the initial state ρ₀ of said density operator ρ of the open quantum system.

10. A computer program comprising instructions whose execution, by a processor (5), results in the implementation of the method of claim 9.

11. A computer-readable storage medium comprising the computer program of claim 10 stored thereon.

12. A computer-implemented method carried out by a conventional computer for simulating an open quantum system including a plurality of quantum entities, the plurality of quantum entities including:
(i) one or more first quantum entities each having a respective Hilbert space H_{A}_{_{q}}, where A_{q} denotes the q-th first quantum entity, and each being stabilized around a respective decoherence-free space D_{0,A}_{_{q}} which is an exponential attractor, each decoherence-free space D_{0,A}_{_{q}} having a respective orthonormal Hermitian basis {S_{A}_{_{q}}_{,d}_{_{Aq}}⁰, d_{A}_{_{q}}∈ [symbol] 1, d_{0,A}_{_{q}} [symbol] }, where S_{A}_{_{q}}_{,d}_{_{Aq}}⁰ is the d_{A}_{_{q}}-th Hermitian operator of the orthonormal Hermitian basis of the decoherence-free space D_{0,A}_{_{q}} of the q-th first quantum entity and d_{0,A}_{_{q}} is the dimension of the decoherence-free space D_{0,A}_{_{q}} of the q-th first quantum entity; and
(ii) one or more second quantum entities each having a respective Hilbert space H_{B}_{ₚ}, where Bₚ denotes the p-th second quantum entity, wherein each second quantum entity has an unstabilized component during a time period T such that a respective decoherence-free space cannot be defined for each second quantum entity during time period T;
wherein the open quantum system has a Hilbert space H such that H=(⊗_{A}_{_{q}} H_{A}_{_{q}})⊗(⊗_{B}_{ₚ} H_{B}_{ₚ}) where ⊗ denotes the tensor product;
the method comprising the following operations:
receiving (1600), as inputs:
(i) a Lindblad master equation defining the dynamics, at time 0<t<T, of a density operator ρ of the open quantum system to be simulated including one or more first quantum entities and one or more second quantum entities, wherein said dynamics includes first quantum entity specific local nominal dynamics Z_{A}_{_{q}} [symbol] _{0,A}_{_{q}}(ρ) where [symbol] _{0,A}_{_{q}} is the local nominal dynamics of the q-th first quantum entity;
(ii) the respective decoherence-free spaces D_{0,A}_{_{q}} of the one or more first quantum entities;
(iii) an initial state ρ(0) of said density operator ρ; and
(iv) time period T during which each second quantum entity has an unstabilized component;
applying (1610) an explicit method to said Lindblad master equation for generating a discrete-time expression thereof, splitting said discrete-time expression of the Lindblad master equation into a local nominal dynamics portion of the one or more first quantum entities and a perturbation portion K₁ with an amplitude of said perturbation portion being at least five times smaller than an amplitude of said local nominal dynamics portion;
applying (1620) a trace-preserving and completely-positive linear Kraus map formulation to said local nominal dynamics portion such that the Kraus map K₀ of said local nominal dynamics portion is derived from the respective Kraus maps K_{0,A}_{_{q}} of said first quantum entity specific local nominal dynamics with K₀=⊗_{A}_{_{q}} K_{0,A}_{_{q}}, such that ρ(k+1)=K₀(ρ(k))+K₁(ρ(k)), where ρ(k) is the k-th time value of the time-discrete density operator;
determining (1630) a finite set of local operators L_{m,μ}¹(k) and R_{m,μ}¹(k) on the Hilbert space Hₘ where m=A_{q}, Bₚ such that, for any operator W on the Hilbert space H verifying W=⊗ₘ Wₘ, Wₘ being a local operator on the Hilbert space Hₘ: K₁(W)=Σ_{μ}⊗ₘ L_{m,μ}¹WₘR_{m,μ}¹, where μ is finite,
calculating (1640) invariant operators
$${J}_{{A}_{q} , {d}_{{A}_{q}}} = {lim}_{k \to + ∞} {[ {K}_{0 , {A}_{q}}^{*} ]}^{k} ( {S}_{{A}_{q} , {d}_{{A}_{q}}}^{0} )$$
of each first quantum entity, where K_{0,A}_{_{q}}^{*} is the conjugate transpose of the local nominal dynamics portion K_{0,A}_{_{q}} of the q-th first quantum entity,
determining (1650) a second-order equation of the time-discrete dynamics of the contributions of the d_{A}_{_{q}}′-th Hermitian operator of the decoherence-free space D_{0,A}_{_{q}}_{′} of the q-th first quantum entity on the p-th second quantum entity ρ_{(B}_{₁}_{, . . . , B}_{ₚ}_{),(d}_{_{A1}}_{′, . . . , d}_{_{Aq}}_{′)}, by computing:
$$\frac{d}{dt} {ρ}_{( {B}_{1} , … , {B}_{p} ) , ( {d}_{{A}_{1}}^{′} , … , {d}_{{A}_{q}}^{′} )} = {\sum }_{μ , {d}_{{A}_{1}} , … , {d}_{{A}_{q}}} {\prod }_{i = 1}^{q} \{ {\overline{F}}_{{d}_{{A}_{i}}^{′} , {d}_{{A}_{i}} , μ}^{1} ( k ) [ {⊗}_{j = 1}^{p} {L}_{{B}_{j , μ}}^{1} ( k ) ] {ρ}_{( {B}_{1} , … , {B}_{p} ) , ( {d}_{{A}_{1}} , … , {d}_{{A}_{q}} )} [ {⊗}_{l = 1}^{p} {R}_{{B}_{l , μ}}^{1} ( k ) ] \} + {\sum }_{{d}_{{A}_{1}} , … , {d}_{{A}_{q}} , μ , {μ}^{′}} {\prod }_{i = 1}^{q} \{ {\overline{F}}_{{d}_{{A}_{i}}^{′} , {d}_{{A}_{i}} , μ , {μ}^{′}}^{2} ( k ) [ {⊗}_{j = 1}^{p} {L}_{{B}_{j , {μ}^{′}}}^{1} ( k ) ] [ {⊗}_{l = 1}^{p} {L}_{{B}_{l , μ}}^{1} ( k ) ] {ρ}_{( {B}_{1} , … , {B}_{p} ) , ( {d}_{{A}_{1}} , … , {d}_{{A}_{q}} )} [ {⊗}_{j = 1}^{p} {R}_{{B}_{j , μ}}^{1} ( k ) ] [ {⊗}_{l = 1}^{p} {R}_{{B}_{l , μ}}^{1} ( k ) ] \}$$
$$with :$$
$${\overline{F}}_{{d}_{{A}_{i}}^{′} , {d}_{{A}_{i}} , μ}^{1} ( k ) = ( \frac{1}{Δ t} ) Tr ( {J}_{{A}_{i} , {d}_{{A}_{i}}^{′}} {L}_{{A}_{i , μ}}^{1} ( k ) {S}_{{A}_{i} , {d}_{{A}_{i}}}^{0} {R}_{{A}_{i} , μ}^{1} ( k ) ) ,$$
$$and$$
$${\overline{F}}_{{d}_{{A}_{i}}^{′} , {d}_{{A}_{i}} , μ , {μ}^{′}}^{2} ( k ) = ( \frac{1}{Δ t} ) Tr \{ {J}_{{A}_{i} , {dA}_{i}^{′} , {μ}^{′}}^{1} ( k ) {\sum }_{j = 0} {[ {K}_{0 , {A}_{i}} ]}^{j} ( {S}_{{A}_{i} , {dA}_{i} , μ}^{0} ( k ) - {\sum }_{{d}_{{A}_{i}}^{″}} Tr ( {J}_{{A}_{i} , {d}_{{A}_{i}}^{″}} {S}_{{A}_{i} , {d}_{{A}_{i}} , μ}^{0} ( k ) ) {S}_{{A}_{i} , {d}_{{A}_{i}}^{″}} \} ,$$
$$where$$
$${J}_{{A}_{i} , {d}_{{A}_{i}}^{′} , {μ}^{′}}^{1} ( k ) = {R}_{{A}_{i} , {μ}^{′}}^{1} ( k ) {J}_{{A}_{i} , {d}_{{A}_{i}}^{′}}^{1} {L}_{{A}_{i} , {μ}^{′}}^{1} ( k )$$
$$and$$
$${S}_{{A}_{i} , {d}_{{A}_{i}} , μ}^{0} ( k ) = {L}_{{A}_{i} , u}^{1} ( k ) {S}_{{A}_{i} , {d}_{{A}_{i}}}^{0} {R}_{{A}_{i} , {d}_{{A}_{i}}}^{1} ( k ) ,$$
where Δt is the time step of the explicit method, where the sum over index j is truncated at a threshold such that the difference between the penultimate and final summed terms is smaller than 10⁻⁸, and where Tr( ) denotes the trace;
determining (1660) a propagator P by numerically integrating
$$\frac{d}{dt} {ρ}_{( {B}_{1} , … , {B}_{p} ) , ( {d}_{{A}_{1}}^{′} , … , {d}_{{A}_{q}}^{′} )}$$
over the time period T; and
deriving (1670) an approximated final state of the density operator ρ by applying said propagator P to the initial state ρ(0) of said density operator ρ of the open quantum system.

13. The computer-implemented method of claim 12, wherein, when t=0 and when t≥T, each second quantum entity is stabilized around a respective decoherence-free space D_{0,B}_{ₚ} which is an exponential attractor, each decoherence-free space D_{0,B}_{ₚ} having a respective orthonormal Hermitian basis
$$\{ {S}_{{B}_{p} , {d}_{{B}_{p}}}^{0} , {d}_{{B}_{p}} ∈ 〚 1 , {d}_{0 , {B}_{P}} 〛 \} ,$$
$$where$$
$${S}_{{B}_{p} , {d}_{{B}_{p}}}^{0}$$
is the d_{B}_{ₚ}-th Hermitian operator of the orthonormal Hermitian basis of the decoherence-free space D_{0,B}_{ₚ} of the p-th second quantum entity and d_{0,B}_{ₚ} is the dimension of the decoherence-free space D_{0,B}_{ₚ} of the p-th second quantum entity; wherein the method further comprises:
receiving, as inputs:
(v) a second Lindblad master equation defining the dynamics, at time t=0 and t≥T, of the density operator ρ of the open quantum system to be simulated, wherein said dynamics includes quantum entity specific local nominal dynamics Σ_{A}_{_{q}}_{,B}_{ₚ}{ [symbol] _{0,A}_{_{q}}(ρ)+ [symbol] _{0,B}_{ₚ}(ρ)} where [symbol] _{0,B}_{ₚ} is the local nominal dynamics of the p-th second quantum entity; and
(vi) the respective decoherence-free spaces D_{0,B}_{ₚ} of the one or more second quantum entities;
applying an explicit method to said second Lindblad master equation for generating a second discrete-time expression thereof, splitting said second discrete-time expression of the second Lindblad master equation into a second local nominal dynamics portion of the plurality of quantum entities and a second perturbation portion K₁⁽²⁾ with an amplitude of said second perturbation portion being at least five times than an amplitude of said second local nominal dynamics portion;
applying a trace-preserving and completely-positive linear Kraus map formulation to said second local nominal dynamics portion such that the Kraus map K₀⁽²⁾ of said second local nominal dynamics portion is derived from the respective Kraus maps K_{0,m}⁽²⁾ of said quantum entity specific local nominal dynamics with K₀⁽²⁾=⊗ₘ K_{0,m}⁽²⁾, where m=A_{q}, Bₚ, such that ρ(k+1)=K₀⁽²⁾(ρ(k))+K₁⁽²⁾(ρ(k)), where ρ(k) is the k-th time value of the time-discrete density operator;
calculating invariant operators
$${J}_{{B}_{p} , {d}_{{B}_{p}}} = {lim}_{k \to + ∞} {[ {K}_{0 , {B}_{p}}^{( 2 ) *} ]}^{k} ( {S}_{{B}_{p ,} {d}_{{B}_{p}}}^{0} )$$
of each second quantum entity, where K_{0,B}_{ₚ}^{(2)*} is the conjugate transpose of the local nominal dynamics portion K_{0,B}_{ₚ}⁽²⁾ of the p-th second quantum entity; and
wherein determining (1660) propagator P comprises calculating each propagator coefficient contributing to propagator P, for a particular d_{A}_{₁}, . . . , d_{A}_{_{q}}, d_{B}_{₁}, . . . , d_{B}_{ₚ}, using:
$${P}_{( {d}_{{A}_{1}}^{′} , … , {d}_{{A}_{q}}^{′} , {d}_{{B}_{1}}^{′} , … , {d}_{{B}_{p}}^{′} ) , ( {d}_{{A}_{1}} , … , {d}_{{A}_{q}} , {d}_{{B}_{1}} , … , {d}_{{B}_{p}} )} = Tr ( [ {⊗}_{i = 1}^{p} {J}_{{B}_{i} , {d}_{{B}_{i}}^{′}} ] {ρ}_{( {B}_{1} , … , {B}_{p} ) , ( {d}_{{A}_{1}}^{′} , ... , {d}_{{A}_{q}}^{′} )}^{( {d}_{{A}_{1}} , … , {d}_{{A}_{q}} , {d}_{{B}_{1}} , … , {d}_{{B}_{p}} )} ( T ) )$$
$$wherein$$
$${ρ}_{( {B}_{1} , … , {B}_{p} ) , ( {d}_{{A}_{1}}^{′} , ... , {d}_{{A}_{q}}^{′} )}^{( {d}_{{A}_{1}} , … , {d}_{{A}_{q}} , {d}_{{B}_{1}} , … , {d}_{{B}_{p}} )} ( T )$$
is computed by numerically integrating
$$\frac{d}{dt} {ρ}_{( {B}_{1} , … , {B}_{p} ) , ( {d}_{{A}_{1}}^{′} , … , {d}_{{A}_{q}}^{′} )}$$
from an initial state ρ_{(B}_{₁}_{, . . . , B}_{ₚ}_{),(d}_{_{A1}}_{′, . . . , d}_{_{Aq}}_{′)}(0)=⊗ₘ S_{m,d}_{ₘ}⁰ where m=A_{q}, Bₚ for the particular d_{A}_{₁}, . . . , d_{A}_{_{q}}, d_{B}_{₁}, . . . , d_{B}_{ₚ}.

14. The computer-implemented method of claim 12, wherein the Kraus map formulation is applied by using the following Kraus map:
$${K}_{0} ( ρ ) = U ( \overline{M} U ρ {U}^{†} {\overline{M}}^{†} + Δ t ( {\sum }_{υ} {\overline{L}}_{υ} U ρ {U}^{†} {\overline{L}}_{υ}^{†} ) ) {U}^{†}$$
$$with :$$
$$U = {e}^{- i Δ tH / 2}$$
$$\overline{M} = {MS}^{- \frac{1}{2}}$$
$${\overline{L}}_{υ} = {L}_{υ} {S}^{- \frac{1}{2}}$$
$$where :$$
$$M = I - {\sum }_{υ} \frac{Δ t}{2} {L}_{υ}^{†} {L}_{υ} ,$$
$$S = {M}^{†} M + Δ t {\sum }_{υ} {L}_{υ}^{†} {L}_{υ} ,$$
I is the identity matrix, L_{υ} is a ν-th Lindblad operator of the Lindblad master equation and H is a Hamiltonian of the Lindblad master equation.

15. The computer-implemented method of claim 12, wherein each of the one or more first quantum entities is a cat qubit stabilized by two-photon driven dissipation, and wherein each of the one or more second quantum entities is a cat qubit which: (i) is stabilized by two-photon driven dissipation when t=0 and when t≥T, and (ii) is not stabilized by two-photon driven dissipation during time 0<t<T.

16. The computer-implemented method of claim 12, the method comprising receiving, as inputs, a Lindblad master equation defining the dynamics of the density operator ρ of an open quantum system that is:
(i) a CNOT-gate between a control qubit and a target qubit, wherein the control qubit is one of said one or more first quantum entities and the target qubit is one of said one or more second quantum entities; and/or
(ii) a Toffoli-gate between two control qubits and a target qubit, wherein the control qubits are of said one or more first quantum entities and the target qubit is one of said one or more second quantum entities.

17. The computer-implemented method of claim 12, wherein the index j is truncated at a threshold such that the difference between the between the penultimate and final summed terms is at machine precision of the conventional computer.

18. A computer program or computer-readable data carrier comprising instructions which, when executed by a conventional computer, causes the conventional computer to carry of the method of claim 12.

19. A method of physically performing an operation on an open quantum system including a plurality of quantum entities, the plurality of quantum entities including:
(I) one or more first quantum entities each being stabilized around a respective decoherence-free space; and
(II) one or more second quantum entities, wherein each second quantum entity has an unstabilized component during a time period T of the operation such that a respective decoherence-free space cannot be defined for each second quantum entity during time period T;
the method comprising providing a desired final state of a density operator ρ of the open quantum system after an operation to be performed on a known initial state of the open quantum system for time period T, and wherein the method further comprises:
(i) using the method of any of claim 12 to provide an approximated final state of the density operator, wherein said initial state of said density operator ρ models the known initial state of the open quantum system and wherein said Lindblad master equation defining the dynamics models the evolution of the system under the operation;
(ii) calculating a fidelity between the approximated final state and the desired final state;
(iii) comparing the calculated fidelity to a threshold value;
(iv) performing:
(a) if the fidelity is above the threshold value, extraction of the parameters of said Lindblad master equation corresponding to physically controllable parameters of the operation; or
(b) if the fidelity is below the threshold value, repetition of steps (i)-(iii) with a modified Lindblad master equation with modified parameters corresponding to physically controllable parameters of the operation until the calculated fidelity is above the threshold value, and extracting the modified parameters of the modified Lindblad master equation resulting in the calculated fidelity being above the threshold value; and
(v) physically performing the operation on the open quantum system using the extracted parameters.

20. A method of designing an open quantum system including a plurality of quantum entities, the plurality of quantum entities including:
(I) one or more first quantum entities each being stabilized around a respective decoherence-free space; and
(II) one or more second quantum entities, wherein each second quantum entity has an unstabilized component during a time period T such that a respective decoherence-free space cannot be defined for each second quantum entity during time period T;
the method comprising providing a desired final state of a density operator ρ of the open quantum system after a known operation is to be performed on a known initial state of the open quantum system for time period T, the method further comprising:
(i) using the method of the method of any of claim 12 to provide an approximated final state of the density operator, wherein said initial state of said density operator ρ models the known initial state of the open quantum system and wherein said Lindblad master equation defining the dynamics models the evolution of the system under the known operation;
(ii) calculating a fidelity between the approximated final state and the desired final state;
(iii) comparing the calculated fidelity to a threshold value;
(iv) performing:
(a) if the fidelity is above the threshold value, extraction of the parameters of said Lindblad master equation corresponding to physically controllable parameters of the plurality quantum entities; or
(b) if the fidelity is below the threshold value, repetition of steps (i)-(iii) with a modified Lindblad master equation with modified parameters corresponding to physically controllable parameters of the plurality of quantum entities until the calculated fidelity is above the threshold value, and extracting the modified parameters of the plurality of quantum entities of the modified Lindblad master equation resulting the calculated fidelity being above the threshold value; and
(v) designing the plurality of quantum entities to have the extracted parameters.
